(19) United States
(12) Patent Application Publication
(10) Pub. No.: US 2014/0098883 A1
(43) Pub. Date: Apr. 10, 2014

(54) METHOD AND APPARATUS FOR VIDEO CODING

(71) Applicant: NOKIA CORPORATION, ESPOO (FI)

(72) Inventors: Miska Matias Hannuksela, Tampere (FI); Dmytro Rusanovskyy, Lempäälä (FI)

(73) Assignee: NOKIA CORPORATION, ESPOO (FI)

(21) Appl. No.: 14/048,650

(22) Filed: Oct. 8, 2013

Related U.S. Application Data
(60) Provisional application No. 61/711,527, filed on Oct. 9, 2012.

(51) Int. Cl. H04N 7/36; H04N 7/26

(52) U.S. Cl. CPC H04N 19/00587; H04N 19/0089
USPC 375/240.16; 375/240.12

(57) ABSTRACT

There are disclosed various methods, apparatuses and computer program products for video encoding and decoding. In some embodiments information on a sampling grid of a current view component and information on a sampling grid of a reference view component is obtained and is used to select one or more resampling filter parameters for filtering at least a part of the reference view component to be used in one or more of inter-view prediction and view synthesis prediction of the current view component. In some embodiments the difference between the vertical sampling grid position of an interpolated reference view component and the vertical sampling grid position of the current view component is used to compensate a motion vector offset to be used in inter-view prediction of the current view component.

### TECHNICAL FIELD

The present application relates generally to an apparatus, a method and a computer program for video coding and decoding.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A video coding system may comprise an encoder that transforms an input video into a compressed representation suited for storage/transmission and a decoder that can uncompress the compressed video representation back into a viewable form. The encoder may discard some information in the original video sequence in order to represent the video in a more compact form, for example, to enable the storage/transmission of the video information at a lower bitrate than otherwise might be needed.

Scalable video coding refers to a coding structure where one bitstream can contain multiple representations of the content at different bitrates, resolutions, frame rates and/or other types of scalability. A scalable bitstream may consist of a base layer providing the lowest quality video available and one or more enhancement layers that enhance the video quality when received and decoded together with the lower layers. In order to improve coding efficiency for the enhancement layers, the coded representation of that layer may depend on the lower layers. Each layer together with all its dependent layers is one representation of the video signal at a certain spatial resolution, temporal resolution, quality level, and/or operation point of other types of scalability.

Various technologies for providing three-dimensional (3D) video content are currently investigated and developed. Especially, intense studies have been focused on various multiview applications wherein a viewer is able to see only one pair of stereo video from a specific viewpoint and another pair of stereo video from a different viewpoint. One of the most feasible approaches for such multiview applications has turned out to be such wherein only a limited number of input views, e.g. a mono or a stereo video plus some supplementary data, is provided to a decoder side and all required views are then rendered (i.e. synthesized) locally by the decoder to be displayed on a display.

In the encoding of 3D video content, video compression systems, such as Advanced Video Coding standard H.264/AVC or the Multiview Video Coding MVC extension of H.264/AVC can be used.

### SUMMARY

Some embodiments provide a method for encoding and decoding video information. In some embodiments a resampling filter may be selected on the basis of a vertical sampling grid position of a reference view component and a vertical sampling grid position of a current view component. The current view component which is being encoded/decoded and uses the reference view component for inter-view prediction and/or view synthesis prediction. In some embodiments, a resampling filter may be selected on the basis of a vertical sampling grid position of an interpolated reference view component and a vertical sampling grid position of a current view component.

Various aspects of examples of the invention are provided in the detailed description.

According to a first aspect of the present invention, there is provided a method comprising:

obtaining information on a sampling grid of a current view component; obtaining information on a sampling grid of a reference view component;

using the obtained information to select one or more resampling filter parameters for filtering at least a part of the reference view component to be used in one or more of inter-view prediction and view synthesis prediction of the current view component.

According to a second aspect there is provided a method comprising:

obtaining information on a vertical sampling grid position of a reference view component;

obtaining information on a vertical sampling grid position of the current view component;

determining the difference between the vertical sampling grid position of the reference view component and the vertical sampling grid position of the current view component;

using the difference to compensate a motion vector offset to be used in one or more of inter-view prediction and view synthesis prediction of the current view component.

According to a third aspect there is provided an apparatus comprising at least one processor and at least one memory including computer program code, the at least one memory and the computer program code configured to, with the at least one processor, cause the apparatus to:

obtain information on a sampling grid of a current view component;

obtain information on a sampling grid of a reference view component;

use the obtained information to select one or more resampling filter parameters for filtering at least a part of the reference view component to be used in one or more of inter-view prediction and view synthesis prediction of the current view component.

According to a fourth aspect there is provided an apparatus comprising at least one processor and at least one memory including computer program code, the at least one memory and the computer program code configured to, with the at least one processor, cause the apparatus to:

obtain information on a vertical sampling grid position of a reference view component;

obtain information on a vertical sampling grid position of the current view component;

determine the difference between the vertical sampling grid position of the reference view component and the vertical sampling grid position of the current view component;

use the difference to compensate a motion vector offset to be used in one or more of inter-view prediction and view synthesis prediction of the current view component.

According to a fifth aspect there is provided a computer program product including one or more sequences of one or more instructions which, when executed by one or more processors, cause an apparatus to at least perform the following:

obtain information on a sampling grid of a current view component;

obtain information on a sampling grid of a reference view component;

use the obtained information to select one or more resampling filter parameters for filtering at least a part of the reference view component to be used in one or more of inter-view prediction and view synthesis prediction of the current view component.

According to a sixth aspect there is provided a computer program product including one or more sequences of one or more instructions which, when executed by one or more processors, cause an apparatus to at least perform the following:

obtain information on a vertical sampling grid position of a reference view component;

obtain information on a vertical sampling grid position of the current view component;

determine the difference between the vertical sampling grid position of the reference view component and the vertical sampling grid position of the current view component;

use the difference to compensate a motion vector offset to be used in one or more of inter-view prediction and view synthesis prediction of the current view component.

According to a seventh aspect there is provided an apparatus comprising:

means for obtaining information on a sampling grid of a current view component;

means for obtaining information on a sampling grid of a reference view component;

means for using the obtained information to select one or more resampling filter parameters for filtering at least a part of the reference view component to be used in one or more of inter-view prediction and view synthesis prediction of the current view component.

According to an eighth aspect there is provided a method comprising:

means for obtaining information on a vertical sampling grid position of a reference view component;

means for obtaining information on a vertical sampling grid position of the current view component;

means for determining the difference between the vertical sampling grid position of the reference view component and the vertical sampling grid position of the current view component;

means for using the difference to compensate a motion vector offset to be used in one or more of inter-view prediction and view synthesis prediction of the current view component.

According to a ninth aspect there is provided a method comprising:

obtaining information on a sampling grid of a current view component;

obtaining information on a sampling grid of a reference view component;

using the obtained information to select one or more resampling filter parameters for filtering at least a part of the reference view component to be used in one or more of inter-view prediction and view synthesis prediction of the current view component.

According to a tenth aspect there is provided a method comprising:

obtaining information on a difference between the vertical sampling grid position of a reference view component and the vertical sampling grid position of the current view component; and

using the difference to compensate a motion vector offset to be used in one or more of inter-view prediction and view synthesis prediction of the current view component.

According to an eleventh aspect there is provided an apparatus comprising at least one processor and at least one memory including computer program code, the at least one memory and the computer program code configured to, with the at least one processor, cause the apparatus to:

obtain information on a sampling grid of a current view component;

obtain information on a sampling grid of a reference view component;

use the obtained information to select one or more resampling filter parameters for filtering at least a part of the reference view component to be used in one or more of inter-view prediction and view synthesis prediction of the current view component.

According to a twelfth aspect there is provided an apparatus comprising at least one processor and at least one memory including computer program code, the at least one memory and the computer program code configured to, with the at least one processor, cause the apparatus to:

obtain information on a difference between the vertical sampling grid position of a reference view component and the vertical sampling grid position of the current view component;

use the difference to compensate a motion vector offset to be used in one or more of inter-view prediction and view synthesis prediction of the current view component.

According to a thirteenth aspect there is provided a computer program product including one or more sequences of one or more instructions which, when executed by one or more processors, cause an apparatus to at least perform the following:

obtain information on a sampling grid of a current view component;

obtain information on a sampling grid of a reference view component;

use the obtained information to select one or more resampling filter parameters for filtering at least a part of the reference view component to be used in one or more of inter-view prediction and view synthesis prediction of the current view component.

According to a fourteenth aspect there is provided a computer program product including one or more sequences of one or more instructions which, when executed by one or more processors, cause an apparatus to at least perform the following:

obtain information on a difference between the vertical sampling grid position of a reference view component and the vertical sampling grid position of the current view component;

use the difference to compensate a motion vector offset to be used in one or more of inter-view prediction and view synthesis prediction of the current view component.

According to a fifteenth aspect there is provided an apparatus comprising:

means for obtaining information on a sampling grid of a current view component;

means for obtaining information on a sampling grid of a reference view component;

means for using the obtained information to select one or more resampling filter parameters for filtering at least a part of the reference view component to be used in one or more of inter-view prediction and view synthesis prediction of the current view component.

According to a sixteenth aspect there is provided a method comprising:

means for obtaining information on a difference between the vertical sampling grid position of a reference view component and the vertical sampling grid position of the current view component;

means for using the difference to compensate a motion vector offset to be used in one or more of inter-view prediction and view synthesis prediction of the current view component.

### BRIEF DESCRIPTION OF THE DRAWINGS

For a more complete understanding of example embodiments of the present invention, reference is now made to the following descriptions taken in connection with the accompanying drawings in which:

FIG. 1 shows schematically an electronic device employing some embodiments of the invention;

FIG. 2 shows schematically a user equipment suitable for employing some embodiments of the invention;

FIG. 3 further shows schematically electronic devices employing embodiments of the invention connected using wireless and wired network connections;

FIG. 4a shows schematically an embodiment of the invention as incorporated within an encoder;

FIG. 4b shows schematically an embodiment of an inter predictor according to some embodiments of the invention;

FIG. 5 shows a simplified model of a DIBR-based 3DV system;

FIG. 6 shows a simplified 2D model of a stereoscopic camera setup;

FIG. 7 shows an example of definition and coding order of access units;

FIG. 8 shows a high level flow chart of an embodiment of an encoder capable of encoding texture views and depth views;

FIG. 9 shows a high level flow chart of an embodiment of a decoder capable of decoding texture views and depth views;

FIG. 10 shows an example processing flow for depth map coding within an encoder;

FIG. 11 shows an example of coding of two depth map views with in-loop implementation of an encoder;

FIG. 12 shows an example of joint multiview video and depth coding of anchor pictures;

FIG. 13 shows an example of joint multiview video and depth coding of non-anchor pictures;

FIG. 14 depicts a flow chart of an example method for direction separated motion vector prediction;

FIG. 15a shows spatial neighborhood of the currently coded block serving as the candidates for intra prediction;

FIG. 15b shows temporal neighborhood of the currently coded block serving as the candidates for inter prediction;

FIG. 16a depicts a flow chart of an example method of depth-based motion competition for a skip mode in P slices;

FIG. 16b depicts a flow chart of an example method of depth-based motion competition for a direct mode in B slices;

FIG. 17 illustrates an example of a backward view synthesis scheme;

FIGS. 18a to 18d illustrate some examples of a sampling grid

FIG. 19 shows various types of asymmetric stereoscopic video coding methods.

### DETAILED DESCRIPTION OF SOME EXAMPLE EMBODIMENTS

In the following, several embodiments of the invention will be described in the context of one video coding arrangement. It is to be noted, however, that the invention is not limited to this particular arrangement. In fact, the different embodiments have applications widely in any environment where improvement of reference picture handling is required. For example, the invention may be applicable to video coding systems like streaming systems, DVD players, digital television receivers, personal video recorders, systems and computer programs on personal computers, handheld computers and communication devices, as well as network elements such as transcoders and cloud computing arrangements where video data is handled.

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

There is a currently ongoing standardization project of High Efficiency Video Coding (HEVC) by the Joint Collaborative Team—Video Coding (JCT-VC) of VCEG and MPEG.

Some key definitions, bitstream and coding structures, and concepts of H.264/AVC and HEVC are described in this section as an example of a video encoder, decoder, encoding method, decoding method, and a bitstream structure, wherein the embodiments may be implemented. Some of the key definitions, bitstream and coding structures, and concepts of H.264/AVC are the same as in a draft HEVC standard—hence, they are described below jointly. The aspects of the invention are not limited to H.264/AVC or HEVC, but rather the description is given for one possible basis on top of which the invention may be partly or fully realized.

When describing H.264/AVC and HEVC as well as in example embodiments, common notation for arithmetic operators, logical operators, relational operators, bit-wise operators, assignment operators, and range notation e.g. as specified in H.264/AVC or a draft HEVC may be used. Furthermore, common mathematical functions e.g. as specified in H.264/AVC or a draft HEVC may be used and a common order of precedence and execution order (from left to right or from right to left) of operators e.g. as specified in H.264/AVC or a draft HEVC may be used.

When describing H.264/AVC and HEVC as well as in example embodiments, the following descriptors may be used to specify the parsing process of each syntax element.
b(8): byte having any pattern of bit string (8 bits).
se(v): signed integer Exp-Golomb-coded syntax element with the left bit first.
u(n): unsigned integer using n bits. When n is “v” in the syntax table, the number of bits varies in a manner dependent on the value of other syntax elements. The parsing process for this descriptor is specified by n next bits from the bitstream interpreted as a binary representation of an unsigned integer with the most significant bit written first.
ue(v): unsigned integer Exp-Golomb-coded syntax element with the left bit first.

An Exp-Golomb bit string may be converted to a code number (codeNum) for example using the following table:

| Bit string | codeNum |
|---|---|
| 1 | 0 |
| 0 1 0 | 1 |
| 0 1 1 | 2 |
| 0 0 1 0 0 | 3 |
| 0 0 1 0 1 | 4 |
| 0 0 1 1 0 | 5 |
| 0 0 1 1 1 | 6 |
| 0 0 0 1 0 0 0 | 7 |
| 0 0 0 1 0 0 1 | 8 |
| 0 0 0 1 0 1 0 | 9 |
| . . . | . . . |

A code number corresponding to an Exp-Golomb bit string may be converted to se(v) for example using the following table:

| codeNum | syntax element value |
|---|---|
| 0 | 0 |
| 1 | 1 |
| 2 | −1 |
| 3 | 2 |
| 4 | −2 |
| 5 | 3 |
| 6 | −3 |
| . . . | . . . |

When describing H.264/AVC and HEVC as well as in example embodiments, syntax structures, semantics of syntax elements, and decoding process may be specified as follows. Syntax elements in the bitstream are represented in bold type. Each syntax element is described by its name (all lower case letters with underscore characters), optionally its one or two syntax categories, and one or two descriptors for its method of coded representation. The decoding process behaves according to the value of the syntax element and to the values of previously decoded syntax elements. When a value of a syntax element is used in the syntax tables or the text, it appears in regular (i.e., not bold) type. In some cases the syntax tables may use the values of other variables derived from syntax elements values. Such variables appear in the syntax tables, or text, named by a mixture of lower case and upper case letter and without any underscore characters. Variables starting with an upper case letter are derived for the decoding of the current syntax structure and all depending syntax structures. Variables starting with an upper case letter may be used in the decoding process for later syntax structures without mentioning the originating syntax structure of the variable. Variables starting with a lower case letter are only used within the context in which they are derived. In some cases, “mnemonic” names for syntax element values or variable values are used interchangeably with their numerical values. Sometimes “mnemonic” names are used without any associated numerical values. The association of values and names is specified in the text. The names are constructed from one or more groups of letters separated by an underscore character. Each group starts with an upper case letter and may contain more upper case letters.

When describing H.264/AVC and HEVC as well as in example embodiments, a syntax structure may be specified using the following. A group of statements enclosed in curly brackets is a compound statement and is treated functionally as a single statement. A “while” structure specifies a test of whether a condition is true, and if true, specifies evaluation of a statement (or compound statement) repeatedly until the condition is no longer true. A “do . . . while” structure specifies evaluation of a statement once, followed by a test of whether a condition is true, and if true, specifies repeated evaluation of the statement until the condition is no longer true. An “if . . . else” structure specifies a test of whether a condition is true, and if the condition is true, specifies evaluation of a primary statement, otherwise, specifies evaluation of an alternative statement. The “else” part of the structure and the associated alternative statement is omitted if no alternative statement evaluation is needed. A “for” structure specifies evaluation of an initial statement, followed by a test of a condition, and if the condition is true, specifies repeated evaluation of a primary statement followed by a subsequent statement until the condition is no longer true.

Similarly to many earlier video coding standards, the bitstream syntax and semantics as well as the decoding process for error-free bitstreams are specified in H.264/AVC and HEVC. The encoding process is not specified, but encoders must generate conforming bitstreams. Bitstream and decoder conformance can be verified with the Hypothetical Reference Decoder (HRD). The standards contain coding tools that help in coping with transmission errors and losses, but the use of the tools in encoding is optional and no decoding process has been specified for erroneous bitstreams.

The elementary unit for the input to an H.264/AVC or HEVC encoder and the output of an H.264/AVC or HEVC decoder, respectively, is a picture. In H.264/AVC and HEVC, a picture may either be a frame or a field. A frame comprises a matrix of luma samples and corresponding chroma samples. A field is a set of alternate sample rows of a frame and may be used as encoder input, when the source signal is interlaced. Chroma pictures may be subsampled when compared to luma pictures. For example, in the 4:2:0 sampling pattern the spatial resolution of chroma pictures is half of that of the luma picture along both coordinate axes.

In H.264/AVC, a macroblock is a 16×16 block of luma samples and the corresponding blocks of chroma samples. For example, in the 4:2:0 sampling pattern, a macroblock contains one 8×8 block of chroma samples per each chroma component. In H.264/AVC, a picture is partitioned to one or more slice groups, and a slice group contains one or more slices. In H.264/AVC, a slice consists of an integer number of macroblocks ordered consecutively in the raster scan within a particular slice group.

During the course of HEVC standardization the terminology for example on picture partitioning units has evolved. In the next paragraphs, some non-limiting examples of HEVC terminology are provided.

In one draft version of the HEVC standard, video pictures are divided into coding units (CU) covering the area of the picture. A CU consists of one or more prediction units (PU) defining the prediction process for the samples within the CU and one or more transform units (TU) defining the prediction error coding process for the samples in the CU. Typically, a CU consists of a square block of samples with a size selectable from a predefined set of possible CU sizes. A CU with the maximum allowed size is typically named as LCU (largest coding unit) and the video picture is divided into non-overlapping LCUs. An LCU can be further split into a combination of smaller CUs, e.g. by recursively splitting the LCU and resultant CUs. Each resulting CU typically has at least one PU and at least one TU associated with it. Each PU and TU can further be split into smaller PUs and TUs in order to increase granularity of the prediction and prediction error coding processes, respectively. The PU splitting can be realized by splitting the CU into four equal size square PUs or splitting the CU into two rectangle PUs vertically or horizontally in a symmetric or asymmetric way. The division of the image into CUs, and division of CUs into PUs and TUs is typically signalled in the bitstream allowing the decoder to reproduce the intended structure of these units.

In a draft HEVC standard, a picture can be partitioned in tiles, which are rectangular and contain an integer number of LCUs. In a draft HEVC standard, the partitioning to tiles forms a regular grid, where heights and widths of tiles differ from each other by one LCU at the maximum. In a draft HEVC, a slice consists of an integer number of CUs. The CUs are scanned in the raster scan order of LCUs within tiles or within a picture, if tiles are not in use. Within an LCU, the CUs have a specific scan order.

In a Working Draft (WD) 5 of HEVC, some key definitions and concepts for picture partitioning are defined as follows. A partitioning is defined as the division of a set into subsets such that each element of the set is in exactly one of the subsets.

A basic coding unit in a HEVC WD5 is a treeblock. A treeblock is an N×N block of luma samples and two corresponding blocks of chroma samples of a picture that has three sample arrays, or an N×N block of samples of a monochrome picture or a picture that is coded using three separate colour planes. A treeblock may be partitioned for different coding and decoding processes. A treeblock partition is a block of luma samples and two corresponding blocks of chroma samples resulting from a partitioning of a treeblock for a picture that has three sample arrays or a block of luma samples resulting from a partitioning of a treeblock for a monochrome picture or a picture that is coded using three separate colour planes. Each treeblock is assigned a partition signalling to identify the block sizes for intra or inter prediction and for transform coding. The partitioning is a recursive quadtree partitioning. The root of the quadtree is associated with the treeblock. The quadtree is split until a leaf is reached, which is referred to as the coding node. The coding node is the root node of two trees, the prediction tree and the transform tree. The prediction tree specifies the position and size of prediction blocks. The prediction tree and associated prediction data are referred to as a prediction unit. The transform tree specifies the position and size of transform blocks. The transform tree and associated transform data are referred to as a transform unit. The splitting information for luma and chroma is identical for the prediction tree and may or may not be identical for the transform tree. The coding node and the associated prediction and transform units form together a coding unit.

In a HEVC WD5, pictures are divided into slices and tiles. A slice may be a sequence of treeblocks but (when referring to a so-called fine granular slice) may also have its boundary within a treeblock at a location where a transform unit and prediction unit coincide. Treeblocks within a slice are coded and decoded in a raster scan order. For the primary coded picture, the division of each picture into slices is a partitioning.

In a HEVC WD5, a tile is defined as an integer number of treeblocks co-occurring in one column and one row, ordered consecutively in the raster scan within the tile. For the primary coded picture, the division of each picture into tiles is a partitioning. Tiles are ordered consecutively in the raster scan within the picture. Although a slice contains treeblocks that are consecutive in the raster scan within a tile, these treeblocks are not necessarily consecutive in the raster scan within the picture. Slices and tiles need not contain the same sequence of treeblocks. A tile may comprise treeblocks contained in more than one slice. Similarly, a slice may comprise treeblocks contained in several tiles.

A distinction between coding units and coding treeblocks may be defined for example as follows. A slice may be defined as a sequence of one or more coding tree units (CTU) in raster-scan order within a tile or within a picture if tiles are not in use. Each CTU may comprise one luma coding treeblock (CTB) and possibly (depending on the chroma format being used) two chroma CTBs.

In H.264/AVC and HEVC, in-picture prediction may be disabled across slice boundaries. Thus, slices can be regarded as a way to split a coded picture into independently decodable pieces, and slices are therefore often regarded as elementary units for transmission. In many cases, encoders may indicate in the bitstream which types of in-picture prediction are turned off across slice boundaries, and the decoder operation takes this information into account for example when concluding which prediction sources are available. For example, samples from a neighboring macroblock or CU may be regarded as unavailable for intra prediction, if the neighboring macroblock or CU resides in a different slice.

A syntax element may be defined as an element of data represented in the bitstream. A syntax structure may be defined as zero or more syntax elements present together in the bitstream in a specified order.

The elementary unit for the output of an H.264/AVC or HEVC encoder and the input of an H.264/AVC or HEVC decoder, respectively, is a Network Abstraction Layer (NAL) unit. For transport over packet-oriented networks or storage into structured files, NAL units may be encapsulated into packets or similar structures. A bytestream format has been specified in H.264/AVC and HEVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to, for example, enable straightforward gateway operation between packet- and stream-oriented systems, start code emulation prevention may always be performed regardless of whether the bytestream format is in use or not. A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

NAL units consist of a header and payload. In H.264/AVC and HEVC, the NAL unit header indicates the type of the NAL unit and whether a coded slice contained in the NAL unit is a part of a reference picture or a non-reference picture.

H.264/AVC NAL unit header includes a 2-bit nal_ref_idc syntax element, which when equal to 0 indicates that a coded slice contained in the NAL unit is a part of a non-reference picture and when greater than 0 indicates that a coded slice contained in the NAL unit is a part of a reference picture. A draft HEVC standard includes a 1-bit nal_ref_idc syntax element, also known as nal_ref_flag, which when equal to 0 indicates that a coded slice contained in the NAL unit is a part of a non-reference picture and when equal to 1 indicates that a coded slice contained in the NAL unit is a part of a reference picture. The header for SVC and MVC NAL units may additionally contain various indications related to the scalability and multiview hierarchy.

In a draft HEVC standard, a two-byte NAL unit header is used for all specified NAL unit types. The first byte of the NAL unit header contains one reserved bit, a one-bit indication nal_ref_flag primarily indicating whether the picture carried in this access unit is a reference picture or a non-reference picture, and a six-bit NAL unit type indication. The second byte of the NAL unit header includes a three-bit temporal_id indication for temporal level and a five-bit reserved field (called reserved_one_{—}5 bits) required to have a value equal to 1 in a draft HEVC standard. The temporal_id syntax element may be regarded as a temporal identifier for the NAL unit and TemporalId variable may be defined to be equal to the value of temporal_id. The five-bit reserved field is expected to be used by extensions such as a future scalable and 3D video extension. Without loss of generality, in some example embodiments a variable LayerId is derived from the value of reserved_one_{—}5 bits for example as follows:

LayerId=reserved_one_{—}5 bits−1.

In a later draft HEVC standard, a two-byte NAL unit header is used for all specified NAL unit types. The NAL unit header contains one reserved bit, a six-bit NAL unit type indication, a six-bit reserved field (called reserved zero_{—}6 bits) and a three-bit temporal_id_plus1 indication for temporal level. The temporal_id_plus 1 syntax element may be regarded as a temporal identifier for the NAL unit, and a zero-based TemporalId variable may be derived as follows: TemporalId=temporal_id_plus1−1. TemporalId equal to 0 corresponds to the lowest temporal level. The value of temporal_id_plus 1 is required to be non-zero in order to avoid start code emulation involving the two NAL unit header bytes. Without loss of generality, in some example embodiments a variable LayerId is derived from the value of reserved_zero_{—}6 bits for example as follows: LayerId=reserved_zero_{—}6 bits.

It is expected that reserved_one_{—}5 bits, reserved_zero_{—}6 bits and/or similar syntax elements in NAL unit header would carry information on the scalability hierarchy. For example, the LayerId value derived from reserved_one_{—}5 bits, reserved_zero_{—}6 bits and/or similar syntax elements may be mapped to values of variables or syntax elements describing different scalability dimensions, such as quality_id or similar, dependency_id or similar, any other type of layer identifier, view order index or similar, view identifier, an indication whether the NAL unit concerns depth or texture i.e. depth_flag or similar, or an identifier similar to priority_id of SVC indicating a valid sub-bitstream extraction if all NAL units greater than a specific identifier value are removed from the bitstream. reserved_one_{—}5 bits, reserved_zero_{—}6 bits and/or similar syntax elements may be partitioned into one or more syntax elements indicating scalability properties. For example, a certain number of bits among reserved_one_{—}5 bits, reserved_zero_{—}6 bits and/or similar syntax elements may be used for dependency_id or similar, while another certain number of bits among reserved_one_{—}5 bits, reserved_zero_{—}6 bits and/or similar syntax elements may be used for quality_id or similar. Alternatively, a mapping of LayerId values or similar to values of variables or syntax elements describing different scalability dimensions may be provided for example in a Video Parameter Set, a Sequence Parameter Set or another syntax structure.

NAL units can be categorized into Video Coding Layer (VCL) NAL units and non-VCL NAL units. VCL NAL units are typically coded slice NAL units. In H.264/AVC, coded slice NAL units contain syntax elements representing one or more coded macroblocks, each of which corresponds to a block of samples in the uncompressed picture. In a draft HEVC standard, coded slice NAL units contain syntax elements representing one or more CU.

In H.264/AVC a coded slice NAL unit can be indicated to be a coded slice in an Instantaneous Decoding Refresh (IDR) picture or coded slice in a non-IDR picture.

In a draft HEVC standard, a coded slice NAL unit can be indicated to be one of the following types.

| | Name of | Content of NAL unit and RBSP |
|---|---|---|
| nal_unit_type | nal_unit_type | syntax structure |
| 1, 2 | TRAIL_R, | Coded slice of a non-TSA, |
| | TRAIL_N | non-STSA trailing picture |
| | | slice_layer_rbsp( ) |
| 3, 4 | TSA_R, | Coded slice of a TSA picture |
| | TSA_N | slice_layer_rbsp( ) |
| 5, 6 | STSA_R, | Coded slice of an STSA picture |
| | STSA_N | slice_layer_rbsp( ) |
| 7, 8, 9 | BLA_W_TFD | Coded slice of a BLA picture |
| | BLA_W_DLP | slice_layer_rbsp( ) |
| | BLA_N_LP | |
| 10, 11 | IDR_W_LP | Coded slice of an IDR picture |
| | IDR_N_LP | slice_layer_rbsp( ) |
| 12 | CRA_NUT | Coded slice of a CRA picture |
| | | slice_layer_rbsp( ) |
| 13 | DLP_NUT | Coded slice of a DLP picture |
| | | slice_layer_rbsp( ) |
| 14 | TFD_NUT | Coded slice of a TFD picture |
| | | slice_layer_rbsp( ) |

In a draft HEVC standard, abbreviations for picture types may be defined as follows: Broken Link Access (BLA), Clean Random Access (CRA), Decodable Leading Picture (DLP), Instantaneous Decoding Refresh (IDR), Random Access Point (RAP), Step-wise Temporal Sub-layer Access (STSA), Tagged For Discard (TFD), Temporal Sub-layer Access (TSA). A BLA picture having nal_unit_type equal to BLA_W_TFD is allowed to have associated TFD pictures present in the bitstream. A BLA picture having nal_unit_type equal to BLA_W_DLP does not have associated TFD pictures present in the bitstream, but may have associated DLP pictures in the bitstream. A BLA picture having nal_unit_type equal to BLA_N_LP does not have associated leading pictures present in the bitstream. An IDR picture having nal_unit_type equal to IDR_N_LP does not have associated leading pictures present in the bitstream. An IDR picture having nal_unit_type equal to IDR_W_LP does not have associated TFD pictures present in the bitstream, but may have associated DLP pictures in the bitstream. When the value of nal_unit_type is equal to TRAIL_N, TSA_N or STSA_N, the decoded picture is not used as a reference for any other picture of the same temporal sub-layer. That is, in a draft HEVC standard, when the value of nal_unit_type is equal to TRAIL_N, TSA_N or STSA_N, the decoded picture is not included in any of RefPicSetStCurrBefore, RefPicSetStCurrAfter and RefPicSetLtCurr of any picture with the same value of TemporalId. A coded picture with nal_unit_type equal to TRAIL_N, TSA_N or STSA_N may be discarded without affecting the decodability of other pictures with the same value of TemporalId. In the table above, RAP pictures are those having nal_unit_type within the range of 7 to 12, inclusive. Each picture, other than the first picture in the bitstream, is considered to be associated with the previous RAP picture in decoding order. A leading picture may be defined as a picture that precedes the associated RAP picture in output order. Any picture that is a leading picture has nal_unit_type equal to DLP_NUT or TFD_NUT. A trailing picture may be defined as a picture that follows the associated RAP picture in output order. Any picture that is a trailing picture does not have nal_unit_type equal to DLP_NUT or TFD_NUT. Any picture that is a leading picture may be constrained to precede, in decoding order, all trailing pictures that are associated with the same RAP picture. No TFD pictures are present in the bitstream that are associated with a BLA picture having nal_unit_type equal to BLA_W_DLP or BLA_N_LP. No DLP pictures are present in the bitstream that are associated with a BLA picture having nal_unit_type equal to BLA_N_LP or that are associated with an IDR picture having nal_unit_type equal to IDR_N_LP. Any TFD picture associated with a CRA or BLA picture may be constrained to precede any DLP picture associated with the CRA or BLA picture in output order. Any TFD picture associated with a CRA picture may be constrained to follow, in output order, any other RAP picture that precedes the CRA picture in decoding order.

Another means of describing picture types of a draft HEVC standard is provided next. As illustrated in Error! Reference source not found.Error! Reference source not found.the table below, picture types can be classified into the following groups in HEVC: a) random access point (RAP) pictures, b) leading pictures, c) sub-layer access pictures, and d) pictures that do not fall into the three mentioned groups. The picture types and their sub-types as described in the table below are identified by the NAL unit type in HEVC. RAP picture types include IDR picture, BLA picture, and CRA picture, and can further be characterized based on the leading pictures associated with them as indicated in the table below.

a) Random access point pictures

| | | |
|---|---|---|
| IDR | Instantaneous | without associated leading pictures |
| | decoding refresh | may have associated leading pictures |
| BLA | Broken link | without associated leading pictures |
| | access | may have associated DLP pictures but |
| | | without associated TFD pictures |
| | | may have associated DLP and TFD |
| | | pictures |
| CRA | Clean random | may have associated leading pictures |
| | access | |

b) Leading pictures

| | |
|---|---|
| DLP | Decodable leading picture |
| TFD | Tagged for discard |

c) Temporal sub-layer access pictures

| | | |
|---|---|---|
| TSA | Temporal sub- | not used for reference in the same |
| | layer access | sub-layer |
| | | may be used for reference in the same |
| | | sub-layer |
| STSA | Step-wise | not used for reference in the same |
| | temporal sub- | sub-layer |
| | layer access | may be used for reference in the same |
| | | sub-layer |

d) Picture that is not RAP, leading or temporal sub-layer access picture

not used for reference in the same
sub-layer
may be used for reference in the same
sub-layer

CRA pictures in HEVC allows pictures that follow the CRA picture in decoding order but precede it in output order to use pictures decoded before the CRA picture as a reference and still allow similar clean random access functionality as an IDR picture. Pictures that follow a CRA picture in both decoding and output order are decodable if random access is performed at the CRA picture, and hence clean random access is achieved.

Leading pictures of a CRA picture that do not refer to any picture preceding the CRA picture in decoding order can be correctly decoded when the decoding starts from the CRA picture and are therefore DLP pictures. In contrast, a TFD picture cannot be correctly decoded when decoding starts from a CRA picture associated with the TFD picture (while the TFD picture could be correctly decoded if the decoding had started from a RAP picture before the current CRA picture). Hence, TFD pictures associated with a CRA may be discarded when the decoding starts from the CRA picture.

When a part of a bitstream starting from a CRA picture is included in another bitstream, the TFD pictures associated with the CRA picture cannot be decoded, because some of their reference pictures are not present in the combined bitstream. To make such splicing operation straightforward, the NAL unit type of the CRA picture can be changed to indicate that it is a BLA picture. The TFD pictures associated with a BLA picture may not be correctly decodable hence should not be output/displayed. The TFD pictures associated with a BLA picture may be omitted from decoding.

In HEVC there are two picture types, the TSA and STSA picture types, that can be used to indicate temporal sub-layer switching points. If temporal sub-layers with TemporalId up to N had been decoded until the TSA or STSA picture (exclusive) and the TSA or STSA picture has TemporalId equal to N+1, the TSA or STSA picture enables decoding of all subsequent pictures (in decoding order) having TemporalId equal to N+1. The TSA picture type may impose restrictions on the TSA picture itself and all pictures in the same sub-layer that follow the TSA picture in decoding order. None of these pictures is allowed to use inter prediction from any picture in the same sub-layer that precedes the TSA picture in decoding order. The TSA definition may further impose restrictions on the pictures in higher sub-layers that follow the TSA picture in decoding order. None of these pictures is allowed to refer a picture that precedes the TSA picture in decoding order if that picture belongs to the same or higher sub-layer as the TSA picture. TSA pictures have TemporalId greater than 0. The STSA is similar to the TSA picture but does not impose restrictions on the pictures in higher sub-layers that follow the STSA picture in decoding order and hence enable up-switching only onto the sub-layer where the STSA picture resides.

A non-VCL NAL unit may be for example one of the following types: a sequence parameter set, a picture parameter set, a supplemental enhancement information (SEI) NAL unit, an access unit delimiter, an end of sequence NAL unit, an end of stream NAL unit, or a filler data NAL unit. Parameter sets may be needed for the reconstruction of decoded pictures, whereas many of the other non-VCL NAL units are not necessary for the reconstruction of decoded sample values.

Parameters that remain unchanged through a coded video sequence may be included in a sequence parameter set. In addition to the parameters that may be needed by the decoding process, the sequence parameter set may optionally contain video usability information (VUI), which includes parameters that may be important for buffering, picture output timing, rendering, and resource reservation. There are three NAL units specified in H.264/AVC to carry sequence parameter sets: the sequence parameter set NAL unit (having NAL unit type equal to 7) containing all the data for H.264/AVC VCL NAL units in the sequence, the sequence parameter set extension NAL unit containing the data for auxiliary coded pictures, and the subset sequence parameter set for MVC and SVC VCL NAL units. The syntax structure included in the sequence parameter set NAL unit of H.264/AVC (having NAL unit type equal to 7) may be referred to as sequence parameter set data, seq_parameter_set_data, or base SPS data. For example, profile, level, the picture size and the chroma sampling format may be included in the base SPS data. A picture parameter set contains such parameters that are likely to be unchanged in several coded pictures.

In a draft HEVC, there is also another type of a parameter set, here referred to as an Adaptation Parameter Set (APS), which includes parameters that are likely to be unchanged in several coded slices but may change for example for each picture or each few pictures. In a draft HEVC, the APS syntax structure includes parameters or syntax elements related to quantization matrices (QM), adaptive sample offset (SAO), adaptive loop filtering (ALF), and deblocking filtering. In a draft HEVC, an APS is a NAL unit and coded without reference or prediction from any other NAL unit. An identifier, referred to as aps_id syntax element, is included in APS NAL unit, and included and used in the slice header to refer to a particular APS.

A draft HEVC standard also includes yet another type of a parameter set, called a video parameter set (VPS), which was proposed for example in document JCTVC-H0388 (http://phenix.int-evry.fr/jct/doc_end_user/documents/8_San %20Jose/wg11LICTVC-H0388-v4.zip). A video parameter set RBSP may include parameters that can be referred to by one or more sequence parameter set RBSPs.

The relationship and hierarchy between VPS, SPS, and PPS may be described as follows. VPS resides one level above SPS in the parameter set hierarchy and in the context of scalability and/or 3DV. VPS may include parameters that are common for all slices across all (scalability or view) layers in the entire coded video sequence. SPS includes the parameters that are common for all slices in a particular (scalability or view) layer in the entire coded video sequence, and may be shared by multiple (scalability or view) layers. PPS includes the parameters that are common for all slices in a particular layer representation (the representation of one scalability or view layer in one access unit) and are likely to be shared by all slices in multiple layer representations.

VPS may provide information about the dependency relationships of the layers in a bitstream, as well as many other information that are applicable to all slices across all (scalability or view) layers in the entire coded video sequence. In a scalable extension of HEVC, VPS may for example include a mapping of the LayerId value derived from the NAL unit header to one or more scalability dimension values, for example correspond to dependency_id, quality_id, view_id, and depth_flag for the layer defined similarly to SVC and MVC. VPS may include profile and level information for one or more layers as well as the profile and/or level for one or more temporal sub-layers (consisting of VCL NAL units at and below certain TemporalId values) of a layer representation.

H.264/AVC and HEVC syntax allows many instances of parameter sets, and each instance is identified with a unique identifier. In order to limit the memory usage needed for parameter sets, the value range for parameter set identifiers has been limited. In H.264/AVC and a draft HEVC standard, each slice header includes the identifier of the picture parameter set that is active for the decoding of the picture that contains the slice, and each picture parameter set contains the identifier of the active sequence parameter set. In a HEVC standard, a slice header additionally contains an APS identifier. Consequently, the transmission of picture and sequence parameter sets does not have to be accurately synchronized with the transmission of slices. Instead, it is sufficient that the active sequence and picture parameter sets are received at any moment before they are referenced, which allows transmission of parameter sets “out-of-band” using a more reliable transmission mechanism compared to the protocols used for the slice data. For example, parameter sets can be included as a parameter in the session description for Real-time Transport Protocol (RTP) sessions. If parameter sets are transmitted in-band, they can be repeated to improve error robustness.

A parameter set may be activated by a reference from a slice or from another active parameter set or in some cases from another syntax structure such as a buffering period SEI message. In the following, non-limiting examples of activation of parameter sets in a draft HEVC standard are given.

Each adaptation parameter set RB SP is initially considered not active at the start of the operation of the decoding process. At most one adaptation parameter set RBSP is considered active at any given moment during the operation of the decoding process, and the activation of any particular adaptation parameter set RBSP results in the deactivation of the previously-active adaptation parameter set RBSP (if any).

When an adaptation parameter set RBSP (with a particular value of aps_id) is not active and it is referred to by a coded slice NAL unit (using that value of aps_id), it is activated. This adaptation parameter set RBSP is called the active adaptation parameter set RBSP until it is deactivated by the activation of another adaptation parameter set RBSP. An adaptation parameter set RBSP, with that particular value of aps_id, is available to the decoding process prior to its activation, included in at least one access unit with temporal_id equal to or less than the temporal_id of the adaptation parameter set NAL unit, unless the adaptation parameter set is provided through external means.

Each picture parameter set RBSP is initially considered not active at the start of the operation of the decoding process. At most one picture parameter set RBSP is considered active at any given moment during the operation of the decoding process, and the activation of any particular picture parameter set RBSP results in the deactivation of the previously-active picture parameter set RBSP (if any).

When a picture parameter set RBSP (with a particular value of pic_parameter_set_id) is not active and it is referred to by a coded slice NAL unit or coded slice data partition A NAL unit (using that value of pic_parameter_set_id), it is activated. This picture parameter set RBSP is called the active picture parameter set RBSP until it is deactivated by the activation of another picture parameter set RBSP. A picture parameter set RBSP, with that particular value of pic_parameter_set_id, is available to the decoding process prior to its activation, included in at least one access unit with temporal_id equal to or less than the temporal_id of the picture parameter set NAL unit, unless the picture parameter set is provided through external means.

Each sequence parameter set RBSP is initially considered not active at the start of the operation of the decoding process. At most one sequence parameter set RBSP is considered active at any given moment during the operation of the decoding process, and the activation of any particular sequence parameter set RBSP results in the deactivation of the previously-active sequence parameter set RBSP (if any).

When a sequence parameter set RBSP (with a particular value of seq_parameter_set_id) is not already active and it is referred to by activation of a picture parameter set RBSP (using that value of seq_parameter_set_id) or is referred to by an SEI NAL unit containing a buffering period SEI message (using that value of seq_parameter_set_id), it is activated. This sequence parameter set RBSP is called the active sequence parameter set RBSP until it is deactivated by the activation of another sequence parameter set RBSP. A sequence parameter set RBSP, with that particular value of seq_parameter_set_id is available to the decoding process prior to its activation, included in at least one access unit with temporal_id equal to 0, unless the sequence parameter set is provided through external means. An activated sequence parameter set RBSP remains active for the entire coded video sequence.

Each video parameter set RBSP is initially considered not active at the start of the operation of the decoding process. At most one video parameter set RBSP is considered active at any given moment during the operation of the decoding process, and the activation of any particular video parameter set RBSP results in the deactivation of the previously-active video parameter set RBSP (if any).

When a video parameter set RB SP (with a particular value of video_parameter_set_id) is not already active and it is referred to by activation of a sequence parameter set RBSP (using that value of video_parameter_set_id), it is activated. This video parameter set RBSP is called the active video parameter set RBSP until it is deactivated by the activation of another video parameter set RBSP. A video parameter set RBSP, with that particular value of video_parameter_set_id is available to the decoding process prior to its activation, included in at least one access unit with temporal_id equal to 0, unless the video parameter set is provided through external means. An activated video parameter set RBSP remains active for the entire coded video sequence.

During operation of the decoding process in a draft HEVC standard, the values of parameters of the active video parameter set, the active sequence parameter set, the active picture parameter set RBSP and the active adaptation parameter set RBSP are considered in effect. For interpretation of SEI messages, the values of the active video parameter set, the active sequence parameter set, the active picture parameter set RBSP and the active adaptation parameter set RBSP for the operation of the decoding process for the VCL NAL units of the coded picture in the same access unit are considered in effect unless otherwise specified in the SEI message semantics.

A SEI NAL unit may contain one or more SEI messages, which are not required for the decoding of output pictures but may assist in related processes, such as picture output timing, rendering, error detection, error concealment, and resource reservation. Several SEI messages are specified in H.264/AVC and HEVC, and the user data SEI messages enable organizations and companies to specify SEI messages for their own use. H.264/AVC and HEVC contain the syntax and semantics for the specified SEI messages but no process for handling the messages in the recipient is defined. Consequently, encoders are required to follow the H.264/AVC standard or the HEVC standard when they create SEI messages, and decoders conforming to the H.264/AVC standard or the HEVC standard, respectively, are not required to process SEI messages for output order conformance. One of the reasons to include the syntax and semantics of SEI messages in H.264/AVC and HEVC is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

A coded picture is a coded representation of a picture. A coded picture in H.264/AVC comprises the VCL NAL units that are required for the decoding of the picture. In H.264/AVC, a coded picture can be a primary coded picture or a redundant coded picture. A primary coded picture is used in the decoding process of valid bitstreams, whereas a redundant coded picture is a redundant representation that should only be decoded when the primary coded picture cannot be successfully decoded. In a draft HEVC, no redundant coded picture has been specified.

In H.264/AVC and HEVC, an access unit comprises a primary coded picture and those NAL units that are associated with it. In H.264/AVC, the appearance order of NAL units within an access unit is constrained as follows. An optional access unit delimiter NAL unit may indicate the start of an access unit. It is followed by zero or more SEI NAL units. The coded slices of the primary coded picture appear next. In H.264/AVC, the coded slice of the primary coded picture may be followed by coded slices for zero or more redundant coded pictures. A redundant coded picture is a coded representation of a picture or a part of a picture. A redundant coded picture may be decoded if the primary coded picture is not received by the decoder for example due to a loss in transmission or a corruption in physical storage medium.

In H.264/AVC, an access unit may also include an auxiliary coded picture, which is a picture that supplements the primary coded picture and may be used for example in the display process. An auxiliary coded picture may for example be used as an alpha channel or alpha plane specifying the transparency level of the samples in the decoded pictures. An alpha channel or plane may be used in a layered composition or rendering system, where the output picture is formed by overlaying pictures being at least partly transparent on top of each other. An auxiliary coded picture has the same syntactic and semantic restrictions as a monochrome redundant coded picture. In H.264/AVC, an auxiliary coded picture contains the same number of macroblocks as the primary coded picture.

In H.264/AVC, a coded video sequence is defined to be a sequence of consecutive access units in decoding order from an IDR access unit, inclusive, to the next IDR access unit, exclusive, or to the end of the bitstream, whichever appears earlier. In a draft HEVC standard, a coded video sequence is defined to be a sequence of access units that consists, in decoding order, of a CRA access unit that is the first access unit in the bitstream, an IDR access unit or a BLA access unit, followed by zero or more non-IDR and non-BLA access units including all subsequent access units up to but not including any subsequent IDR or BLA access unit.

A group of pictures (GOP) and its characteristics may be defined as follows. A GOP can be decoded regardless of whether any previous pictures were decoded. An open GOP is such a group of pictures in which pictures preceding the initial intra picture in output order might not be correctly decodable when the decoding starts from the initial intra picture of the open GOP. In other words, pictures of an open GOP may refer (in inter prediction) to pictures belonging to a previous GOP. An H.264/AVC decoder can recognize an intra picture starting an open GOP from the recovery point SEI message in an H.264/AVC bitstream. An HEVC decoder can recognize an intra picture starting an open GOP, because a specific NAL unit type, CRA NAL unit type, is used for its coded slices. A closed GOP is such a group of pictures in which all pictures can be correctly decoded when the decoding starts from the initial intra picture of the closed GOP. In other words, no picture in a closed GOP refers to any pictures in previous GOPs. In H.264/AVC and HEVC, a closed GOP starts from an IDR access unit. In HEVC a closed GOP may also start from a BLA_W_DLP or a BLA_N_LP picture. As a result, closed GOP structure has more error resilience potential in comparison to the open GOP structure, however at the cost of possible reduction in the compression efficiency. Open GOP coding structure is potentially more efficient in the compression, due to a larger flexibility in selection of reference pictures.

A Structure of Pictures (SOP) may be defined as one or more coded pictures consecutive in decoding order, in which the first coded picture in decoding order is a reference picture at the lowest temporal sub-layer and no coded picture except potentially the first coded picture in decoding order is a RAP picture. The relative decoding order of the pictures is illustrated by the numerals inside the pictures. Any picture in the previous SOP has a smaller decoding order than any picture in the current SOP and any picture in the next SOP has a larger decoding order than any picture in the current SOP. The term group of pictures (GOP) may sometimes be used interchangeably with the term SOP and having the same semantics as the semantics of SOP rather than the semantics of closed or open GOP as described above.

The bitstream syntax of H.264/AVC and HEVC indicates whether a particular picture is a reference picture for inter prediction of any other picture. Pictures of any coding type (I, P, B) can be reference pictures or non-reference pictures in H.264/AVC and HEVC. In H.264/AVC, the NAL unit header indicates the type of the NAL unit and whether a coded slice contained in the NAL unit is a part of a reference picture or a non-reference picture.

Many hybrid video codecs, including H.264/AVC and HEVC, encode video information in two phases. In the first phase, pixel or sample values in a certain picture area or “block” are predicted. These pixel or sample values can be predicted, for example, by motion compensation mechanisms, which involve finding and indicating an area in one of the previously encoded video frames that corresponds closely to the block being coded. Additionally, pixel or sample values can be predicted by spatial mechanisms which involve finding and indicating a spatial region relationship.

Prediction approaches using image information from a previously coded image can also be called as inter prediction methods which may also be referred to as temporal prediction and motion compensation. Prediction approaches using image information within the same image can also be called as intra prediction methods.

The second phase is one of coding the error between the predicted block of pixels or samples and the original block of pixels or samples. This may be accomplished by transforming the difference in pixel or sample values using a specified transform. This transform may be a Discrete Cosine Transform (DCT) or a variant thereof. After transforming the difference, the transformed difference is quantized and entropy encoded.

By varying the fidelity of the quantization process, the encoder can control the balance between the accuracy of the pixel or sample representation (i.e. the visual quality of the picture) and the size of the resulting encoded video representation (i.e. the file size or transmission bit rate).

The decoder reconstructs the output video by applying a prediction mechanism similar to that used by the encoder in order to form a predicted representation of the pixel or sample blocks (using the motion or spatial information created by the encoder and stored in the compressed representation of the image) and prediction error decoding (the inverse operation of the prediction error coding to recover the quantized prediction error signal in the spatial domain).

After applying pixel or sample prediction and error decoding processes the decoder combines the prediction and the prediction error signals (the pixel or sample values) to form the output video frame.

The decoder (and encoder) may also apply additional filtering processes in order to improve the quality of the output video before passing it for display and/or storing as a prediction reference for the forthcoming pictures in the video sequence.

In many video codecs, including H.264/AVC and HEVC, motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or pictures). H.264/AVC and HEVC, as many other video compression standards, divide a picture into a mesh of rectangles, for each of which a similar block in one of the reference pictures is indicated for inter prediction. The location of the prediction block is coded as a motion vector that indicates the position of the prediction block relative to the block being coded.

Inter prediction process may be characterized for example using one or more of the following factors.

The Accuracy of Motion Vector Representation.

For example, motion vectors may be of quarter-pixel accuracy, half-pixel accuracy or full-pixel accuracy and sample values in fractional-pixel positions may be obtained using a finite impulse response (FIR) filter.

Block Partitioning for Inter Prediction.

Many coding standards, including H.264/AVC and HEVC, allow selection of the size and shape of the block for which a motion vector is applied for motion-compensated prediction in the encoder, and indicating the selected size and shape in the bitstream so that decoders can reproduce the motion-compensated prediction done in the encoder.

Number of Reference Pictures for Inter Prediction.

The sources of inter prediction are previously decoded pictures. Many coding standards, including H.264/AVC and HEVC, enable storage of multiple reference pictures for inter prediction and selection of the used reference picture on a block basis. For example, reference pictures may be selected on macroblock or macroblock partition basis in H.264/AVC and on PU or CU basis in HEVC. Many coding standards, such as H.264/AVC and HEVC, include syntax structures in the bitstream that enable decoders to create one or more reference picture lists. A reference picture index to a reference picture list may be used to indicate which one of the multiple reference pictures is used for inter prediction for a particular block. A reference picture index may be coded by an encoder into the bitstream is some inter coding modes or it may be derived (by an encoder and a decoder) for example using neighboring blocks in some other inter coding modes.

Motion Vector Prediction.

In order to represent motion vectors efficiently in bitstreams, motion vectors may be coded differentially with respect to a block-specific predicted motion vector. In many video codecs, the predicted motion vectors are created in a predefined way, for example by calculating the median of the encoded or decoded motion vectors of the adjacent blocks. Another way to create motion vector predictions is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index is typically predicted from adjacent blocks and/or co-located blocks in temporal reference picture. Differential coding of motion vectors is typically disabled across slice boundaries.

Multi-Hypothesis Motion-Compensated Prediction.

H.264/AVC and HEVC enable the use of a single prediction block in P slices (herein referred to as uni-predictive slices) or a linear combination of two motion-compensated prediction blocks for bi-predictive slices, which are also referred to as B slices. Individual blocks in B slices may be bi-predicted, uni-predicted, or intra-predicted, and individual blocks in P slices may be uni-predicted or intra-predicted. The reference pictures for a bi-predictive picture may not be limited to be the subsequent picture and the previous picture in output order, but rather any reference pictures may be used. In many coding standards, such as H.264/AVC and HEVC, one reference picture list, referred to as reference picture list 0, is constructed for P slices, and two reference picture lists, list 0 and list 1, are constructed for B slices. For B slices, when prediction in forward direction may refer to prediction from a reference picture in reference picture list 0, and prediction in backward direction may refer to prediction from a reference picture in reference picture list 1, even though the reference pictures for prediction may have any decoding or output order relation to each other or to the current picture.

Weighted Prediction.

Many coding standards use a prediction weight of 1 for prediction blocks of inter (P) pictures and 0.5 for each prediction block of a B picture (resulting into averaging). H.264/AVC allows weighted prediction for both P and B slices. In implicit weighted prediction, the weights are proportional to picture order counts, while in explicit weighted prediction, prediction weights are explicitly indicated.

In many video codecs, the prediction residual after motion compensation is first transformed with a transform kernel (like DCT) and then coded. The reason for this is that often there still exists some correlation among the residual and transform can in many cases help reduce this correlation and provide more efficient coding.

In a draft HEVC, each PU has prediction information associated with it defining what kind of a prediction is to be applied for the pixels within that PU (e.g. motion vector information for inter predicted PUs and intra prediction directionality information for intra predicted PUs). Similarly each TU is associated with information describing the prediction error decoding process for the samples within the TU (including e.g. DCT coefficient information). It may be signalled at CU level whether prediction error coding is applied or not for each CU. In the case there is no prediction error residual associated with the CU, it can be considered there are no TUs for the CU.

In some coding formats and codecs, a distinction is made between so-called short-term and long-term reference pictures. This distinction may affect some decoding processes such as motion vector scaling in the temporal direct mode or implicit weighted prediction. If both of the reference pictures used for the temporal direct mode are short-term reference pictures, the motion vector used in the prediction may be scaled according to the picture order count (POC) difference between the current picture and each of the reference pictures. However, if at least one reference picture for the temporal direct mode is a long-term reference picture, default scaling of the motion vector may be used, for example scaling the motion to half may be used. Similarly, if a short-term reference picture is used for implicit weighted prediction, the prediction weight may be scaled according to the POC difference between the POC of the current picture and the POC of the reference picture. However, if a long-term reference picture is used for implicit weighted prediction, a default prediction weight may be used, such as 0.5 in implicit weighted prediction for bi-predicted blocks.

Some video coding formats, such as H.264/AVC, include the frame_num syntax element, which is used for various decoding processes related to multiple reference pictures. In H.264/AVC, the value of frame_num for IDR pictures is 0. The value of frame_num for non-IDR pictures is equal to the frame_num of the previous reference picture in decoding order incremented by 1 (in modulo arithmetic, i.e., the value of frame_num wrap over to 0 after a maximum value of frame_num).

H.264/AVC and HEVC include a concept of picture order count (POC). A value of POC is derived for each picture and is non-decreasing with increasing picture position in output order. POC therefore indicates the output order of pictures. POC may be used in the decoding process for example for implicit scaling of motion vectors in the temporal direct mode of bi-predictive slices, for implicitly derived weights in weighted prediction, and for reference picture list initialization. Furthermore, POC may be used in the verification of output order conformance. In H.264/AVC, POC is specified relative to the previous IDR picture or a picture containing a memory management control operation marking all pictures as “unused for reference”.

H.264/AVC specifies the process for decoded reference picture marking in order to control the memory consumption in the decoder. The maximum number of reference pictures used for inter prediction, referred to as M, is determined in the sequence parameter set. When a reference picture is decoded, it is marked as “used for reference”. If the decoding of the reference picture caused more than M pictures marked as “used for reference”, at least one picture is marked as “unused for reference”. There are two types of operation for decoded reference picture marking: adaptive memory control and sliding window. The operation mode for decoded reference picture marking is selected on picture basis. The adaptive memory control enables explicit signaling which pictures are marked as “unused for reference” and may also assign long-term indices to short-term reference pictures. The adaptive memory control may require the presence of memory management control operation (MMCO) parameters in the bitstream. MMCO parameters may be included in a decoded reference picture marking syntax structure. If the sliding window operation mode is in use and there are M pictures marked as “used for reference”, the short-term reference picture that was the first decoded picture among those short-term reference pictures that are marked as “used for reference” is marked as “unused for reference”. In other words, the sliding window operation mode results into first-in-first-out buffering operation among short-term reference pictures.

One of the memory management control operations in H.264/AVC causes all reference pictures except for the current picture to be marked as “unused for reference”. An instantaneous decoding refresh (IDR) picture contains only intra-coded slices and causes a similar “reset” of reference pictures.

In a draft HEVC standard, reference picture marking syntax structures and related decoding processes are not used, but instead a reference picture set (RPS) syntax structure and decoding process are used instead for a similar purpose. A reference picture set valid or active for a picture includes all the reference pictures used as reference for the picture and all the reference pictures that are kept marked as “used for reference” for any subsequent pictures in decoding order. There are six subsets of the reference picture set, which are referred to as namely RefPicSetStCurr0, RefPicSetStCurr1, RefPicSetStFoll0, RefPicSetStFoll1, RefPicSetLtCurr, and RefPicSetLtFoll. The notation of the six subsets is as follows. “Curr” refers to reference pictures that are included in the reference picture lists of the current picture and hence may be used as inter prediction reference for the current picture. “Foll” refers to reference pictures that are not included in the reference picture lists of the current picture but may be used in subsequent pictures in decoding order as reference pictures. “St” refers to short-term reference pictures, which may generally be identified through a certain number of least significant bits of their POC value. “Lt” refers to long-term reference pictures, which are specifically identified and generally have a greater difference of POC values relative to the current picture than what can be represented by the mentioned certain number of least significant bits. “0” refers to those reference pictures that have a smaller POC value than that of the current picture. “1” refers to those reference pictures that have a greater POC value than that of the current picture. RefPicSetStCurr0, RefPicSetStCurr1, RefPicSetStFoll0 and RefPicSetStFoll1 are collectively referred to as the short-term subset of the reference picture set. RefPicSetLtCurr and RefPicSetLtFoll are collectively referred to as the long-term subset of the reference picture set.

In a draft HEVC standard, a reference picture set may be specified in a sequence parameter set and taken into use in the slice header through an index to the reference picture set. A reference picture set may also be specified in a slice header. A long-term subset of a reference picture set is generally specified only in a slice header, while the short-term subsets of the same reference picture set may be specified in the picture parameter set or slice header. A reference picture set may be coded independently or may be predicted from another reference picture set (known as inter-RPS prediction). When a reference picture set is independently coded, the syntax structure includes up to three loops iterating over different types of reference pictures; short-term reference pictures with lower POC value than the current picture, short-term reference pictures with higher POC value than the current picture and long-term reference pictures. Each loop entry specifies a picture to be marked as “used for reference”. In general, the picture is specified with a differential POC value. The inter-RPS prediction exploits the fact that the reference picture set of the current picture can be predicted from the reference picture set of a previously decoded picture. This is because all the reference pictures of the current picture are either reference pictures of the previous picture or the previously decoded picture itself. It is only necessary to indicate which of these pictures should be reference pictures and be used for the prediction of the current picture. In both types of reference picture set coding, a flag (used_by_curr_pic_X_flag) is additionally sent for each reference picture indicating whether the reference picture is used for reference by the current picture (included in a *Curr list) or not (included in a *Foll list). Pictures that are included in the reference picture set used by the current slice are marked as “used for reference”, and pictures that are not in the reference picture set used by the current slice are marked as “unused for reference”. If the current picture is an IDR picture, RefPicSetStCurr0, RefPicSetStCurr1, RefPicSetStFoll0, RefPicSetStFoll1, RefPicSetLtCurr, and RefPicSetLtFoll are all set to empty.

A Decoded Picture Buffer (DPB) may be used in the encoder and/or in the decoder. There are two reasons to buffer decoded pictures, for references in inter prediction and for reordering decoded pictures into output order. As H.264/AVC and HEVC provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output.

In many coding modes of H.264/AVC and HEVC, the reference picture for inter prediction is indicated with an index to a reference picture list. The index may be coded with variable length coding, which usually causes a smaller index to have a shorter value for the corresponding syntax element. In H.264/AVC and HEVC, two reference picture lists (reference picture list 0 and reference picture list 1) are generated for each bi-predictive (B) slice, and one reference picture list (reference picture list 0) is formed for each inter-coded (P) slice. In addition, for a B slice in a draft HEVC standard, a combined list (List C) is constructed after the final reference picture lists (List 0 and List 1) have been constructed. The combined list may be used for uni-prediction (also known as uni-directional prediction) within B slices.

A reference picture list, such as reference picture list 0 and reference picture list 1, is typically constructed in two steps: First, an initial reference picture list is generated. The initial reference picture list may be generated for example on the basis of frame_num, POC, temporal_id, or information on the prediction hierarchy such as GOP structure, or any combination thereof. Second, the initial reference picture list may be reordered by reference picture list reordering (RPLR) commands, also known as reference picture list modification syntax structure, which may be contained in slice headers. The RPLR commands indicate the pictures that are ordered to the beginning of the respective reference picture list. This second step may also be referred to as the reference picture list modification process, and the RPLR commands may be included in a reference picture list modification syntax structure. If reference picture sets are used, the reference picture list 0 may be initialized to contain RefPicSetStCurr0 first, followed by RefPicSetStCurr1, followed by RefPicSetLtCurr. Reference picture list 1 may be initialized to contain RefPicSetStCurr1 first, followed by RefPicSetStCurr0. The initial reference picture lists may be modified through the reference picture list modification syntax structure, where pictures in the initial reference picture lists may be identified through an entry index to the list.

The combined list in a draft HEVC standard may be constructed as follows. If the modification flag for the combined list is zero, the combined list is constructed by an implicit mechanism; otherwise it is constructed by reference picture combination commands included in the bitstream. In the implicit mechanism, reference pictures in List C are mapped to reference pictures from List 0 and List 1 in an interleaved fashion starting from the first entry of List 0, followed by the first entry of List 1 and so forth. Any reference picture that has already been mapped in List C is not mapped again. In the explicit mechanism, the number of entries in List C is signaled, followed by the mapping from an entry in List 0 or List 1 to each entry of List C. In addition, when List 0 and List 1 are identical the encoder has the option of setting the ref pic_list_combination_flag to 0 to indicate that no reference pictures from List 1 are mapped, and that List C is equivalent to List 0.

Many high efficiency video codecs such as a draft HEVC codec employ an additional motion information coding/decoding mechanism, often called merging/merge mode/process/mechanism, where all the motion information of a block/PU is predicted and used without any modification/correction. The aforementioned motion information for a PU may comprise 1) The information whether ‘the PU is uni-predicted using only reference picture list0’ or ‘the PU is uni-predicted using only reference picture list 1’ or ‘the PU is bi-predicted using both reference picture list0 and list 1′; 2) Motion vector value corresponding to the reference picture list0; 3) Reference picture index in the reference picture list0; 4) Motion vector value corresponding to the reference picture list 1; and 5) Reference picture index in the reference picture list 1. Similarly, predicting the motion information is carried out using the motion information of adjacent blocks and/or co-located blocks in temporal reference pictures. A list, often called as a merge list, may be constructed by including motion prediction candidates associated with available adjacent/co-located blocks and the index of selected motion prediction candidate in the list is signalled and the motion information of the selected candidate is copied to the motion information of the current PU. When the merge mechanism is employed for a whole CU and the prediction signal for the CU is used as the reconstruction signal, i.e. prediction residual is not processed, this type of coding/decoding the CU is typically named as skip mode or merge based skip mode. In addition to the skip mode, the merge mechanism may also be employed for individual PUs (not necessarily the whole CU as in skip mode) and in this case, prediction residual may be utilized to improve prediction quality. This type of prediction mode is typically named as an inter-merge mode.

There may be a reference picture lists combination syntax structure, created into the bitstream by an encoder and decoded from the bitstream by a decoder, which indicates the contents of a combined reference picture list. The syntax structure may indicate that the reference picture list 0 and the reference picture list 1 are combined to be an additional reference picture lists combination used for the prediction units being uni-directional predicted. The syntax structure may include a flag which, when equal to a certain value, indicates that the reference picture list 0 and the reference picture list 1 are identical thus the reference picture list 0 is used as the reference picture lists combination. The syntax structure may include a list of entries, each specifying a reference picture list (list 0 or list 1) and a reference index to the specified list, where an entry specifies a reference picture to be included in the combined reference picture list.

A syntax structure for decoded reference picture marking may exist in a video coding system. For example, when the decoding of the picture has been completed, the decoded reference picture marking syntax structure, if present, may be used to adaptively mark pictures as “unused for reference” or “used for long-term reference”. If the decoded reference picture marking syntax structure is not present and the number of pictures marked as “used for reference” can no longer increase, a sliding window reference picture marking may be used, which basically marks the earliest (in decoding order) decoded reference picture as unused for reference.

Scalable video coding refers to a coding structure where one bitstream can contain multiple representations of the content at different bitrates, resolutions and/or frame rates. In these cases the receiver can extract the desired representation depending on its characteristics (e.g. resolution that matches best with the resolution of the display of the device). Alternatively, a server or a network element can extract the portions of the bitstream to be transmitted to the receiver depending on e.g. the network characteristics or processing capabilities of the receiver.

A scalable bitstream may consist of a base layer providing the lowest quality video available and one or more enhancement layers that enhance the video quality when received and decoded together with the lower layers. An enhancement layer may enhance the temporal resolution (i.e., the frame rate), the spatial resolution, or simply the quality of the video content represented by another layer or part thereof. In order to improve coding efficiency for the enhancement layers, the coded representation of that layer may depend on the lower layers. For example, the motion and mode information of the enhancement layer can be predicted from lower layers. Similarly the pixel data of the lower layers can be used to create prediction for the enhancement layer(s).

Each scalable layer together with all its dependent layers is one representation of the video signal at a certain spatial resolution, temporal resolution and quality level. In this document, we refer to a scalable layer together with all of its dependent layers as a “scalable layer representation”. The portion of a scalable bitstream corresponding to a scalable layer representation can be extracted and decoded to produce a representation of the original signal at certain fidelity.

In some cases, data in an enhancement layer can be truncated after a certain location, or even at arbitrary positions, where each truncation position may include additional data representing increasingly enhanced visual quality. Such scalability is referred to as fine-grained (granularity) scalability (FGS). FGS was included in some draft versions of the SVC standard, but it was eventually excluded from the final SVC standard. FGS is subsequently discussed in the context of some draft versions of the SVC standard. The scalability provided by those enhancement layers that cannot be truncated is referred to as coarse-grained (granularity) scalability (CGS). It collectively includes the traditional quality (SNR) scalability and spatial scalability. The SVC standard supports the so-called medium-grained scalability (MGS), where quality enhancement pictures are coded similarly to SNR scalable layer pictures but indicated by high-level syntax elements similarly to FGS layer pictures, by having the quality_id syntax element greater than 0.

SVC uses an inter-layer prediction mechanism, wherein certain information can be predicted from layers other than the currently reconstructed layer or the next lower layer. Information that could be inter-layer predicted includes intra texture, motion and residual data. Inter-layer motion prediction includes the prediction of block coding mode, header information, etc., wherein motion from the lower layer may be used for prediction of the higher layer. In case of intra coding, a prediction from surrounding macroblocks or from co-located macroblocks of lower layers is possible. These prediction techniques do not employ information from earlier coded access units and hence, are referred to as intra prediction techniques. Furthermore, residual data from lower layers can also be employed for prediction of the current layer.

SVC specifies a concept known as single-loop decoding. It is enabled by using a constrained intra texture prediction mode, whereby the inter-layer intra texture prediction can be applied to macroblocks (MBs) for which the corresponding block of the base layer is located inside intra-MBs. At the same time, those intra-MBs in the base layer use constrained intra-prediction (e.g., having the syntax element “constrained_intra_pred_flag” equal to 1). In single-loop decoding, the decoder performs motion compensation and full picture reconstruction only for the scalable layer desired for playback (called the “desired layer” or the “target layer”), thereby greatly reducing decoding complexity. All of the layers other than the desired layer do not need to be fully decoded because all or part of the data of the MBs not used for inter-layer prediction (be it inter-layer intra texture prediction, inter-layer motion prediction or inter-layer residual prediction) is not needed for reconstruction of the desired layer. A single decoding loop is needed for decoding of most pictures, while a second decoding loop is selectively applied to reconstruct the base representations, which are needed as prediction references but not for output or display, and are reconstructed only for the so called key pictures (for which “store_ref_base_pic_flag” is equal to 1).

The scalability structure in the SVC draft is characterized by three syntax elements: “temporal_id,” “dependency_id” and “quality_id.” The syntax element “temporal_id” is used to indicate the temporal scalability hierarchy or, indirectly, the frame rate. A scalable layer representation comprising pictures of a smaller maximum “temporal_id” value has a smaller frame rate than a scalable layer representation comprising pictures of a greater maximum “temporal_id”. A given temporal layer typically depends on the lower temporal layers (i.e., the temporal layers with smaller “temporal_id” values) but does not depend on any higher temporal layer. The syntax element “dependency_id” is used to indicate the CGS inter-layer coding dependency hierarchy (which, as mentioned earlier, includes both SNR and spatial scalability). At any temporal level location, a picture of a smaller “dependency_id” value may be used for inter-layer prediction for coding of a picture with a greater “dependency_id” value. The syntax element “quality_id” is used to indicate the quality level hierarchy of a FGS or MGS layer. At any temporal location, and with an identical “dependency_id” value, a picture with “quality_id” equal to QL uses the picture with “quality_id” equal to QL-1 for inter-layer prediction. A coded slice with “quality_id” larger than 0 may be coded as either a truncatable FGS slice or a non-truncatable MGS slice.

For simplicity, all the data units (e.g., Network Abstraction Layer units or NAL units in the SVC context) in one access unit having identical value of “dependency_id” are referred to as a dependency unit or a dependency representation. Within one dependency unit, all the data units having identical value of “quality_id” are referred to as a quality unit or layer representation.

A base representation, also known as a decoded base picture, is a decoded picture resulting from decoding the Video Coding Layer (VCL) NAL units of a dependency unit having “quality_id” equal to 0 and for which the “store_ref_base_pic_flag” is set equal to 1. An enhancement representation, also referred to as a decoded picture, results from the regular decoding process in which all the layer representations that are present for the highest dependency representation are decoded.

As mentioned earlier, CGS includes both spatial scalability and SNR scalability. Spatial scalability is initially designed to support representations of video with different resolutions. For each time instance, VCL NAL units are coded in the same access unit and these VCL NAL units can correspond to different resolutions. During the decoding, a low resolution VCL NAL unit provides the motion field and residual which can be optionally inherited by the final decoding and reconstruction of the high resolution picture. When compared to older video compression standards, SVC's spatial scalability has been generalized to enable the base layer to be a cropped and zoomed version of the enhancement layer.

MGS quality layers are indicated with “quality_id” similarly as FGS quality layers. For each dependency unit (with the same “dependency_id”), there is a layer with “quality_id” equal to 0 and there can be other layers with “quality_id” greater than 0. These layers with “quality_id” greater than 0 are either MGS layers or FGS layers, depending on whether the slices are coded as truncatable slices.

In the basic form of FGS enhancement layers, only inter-layer prediction is used. Therefore, FGS enhancement layers can be truncated freely without causing any error propagation in the decoded sequence. However, the basic form of FGS suffers from low compression efficiency. This issue arises because only low-quality pictures are used for inter prediction references. It has therefore been proposed that FGS-enhanced pictures be used as inter prediction references. However, this may cause encoding-decoding mismatch, also referred to as drift, when some FGS data are discarded.

One feature of a draft SVC standard is that the FGS NAL units can be freely dropped or truncated, and a feature of the SVCV standard is that MGS NAL units can be freely dropped (but cannot be truncated) without affecting the conformance of the bitstream. As discussed above, when those FGS or MGS data have been used for inter prediction reference during encoding, dropping or truncation of the data would result in a mismatch between the decoded pictures in the decoder side and in the encoder side. This mismatch is also referred to as drift.

To control drift due to the dropping or truncation of FGS or MGS data, SVC applied the following solution: In a certain dependency unit, a base representation (by decoding only the CGS picture with “quality_id” equal to 0 and all the dependent-on lower layer data) is stored in the decoded picture buffer. When encoding a subsequent dependency unit with the same value of “dependency_id,” all of the NAL units, including FGS or MGS NAL units, use the base representation for inter prediction reference. Consequently, all drift due to dropping or truncation of FGS or MGS NAL units in an earlier access unit is stopped at this access unit. For other dependency units with the same value of “dependency_id,” all of the NAL units use the decoded pictures for inter prediction reference, for high coding efficiency.

Each NAL unit includes in the NAL unit header a syntax element “use_ref_base_pic_flag.” When the value of this element is equal to 1, decoding of the NAL unit uses the base representations of the reference pictures during the inter prediction process. The syntax element “store_ref_base_pic_flag” specifies whether (when equal to 1) or not (when equal to 0) to store the base representation of the current picture for future pictures to use for inter prediction.

NAL units with “quality_id” greater than 0 do not contain syntax elements related to reference picture lists construction and weighted prediction, i.e., the syntax elements “num_refactive_{—}1×_minus1” (x=0 or 1), the reference picture list reordering syntax table, and the weighted prediction syntax table are not present. Consequently, the MGS or FGS layers have to inherit these syntax elements from the NAL units with “quality_id” equal to 0 of the same dependency unit when needed.

In SVC, a reference picture list consists of either only base representations (when “use_ref_base_pic_flag” is equal to 1) or only decoded pictures not marked as “base representation” (when “use_ref_base_pic_flag” is equal to 0), but never both at the same time.

In an H.264/AVC bit stream, coded pictures in one coded video sequence uses the same sequence parameter set, and at any time instance during the decoding process, only one sequence parameter set is active. In SVC, coded pictures from different scalable layers may use different sequence parameter sets. If different sequence parameter sets are used, then, at any time instant during the decoding process, there may be more than one active sequence picture parameter set. In the SVC specification, the one for the top layer is denoted as the active sequence picture parameter set, while the rest are referred to as layer active sequence picture parameter sets. Any given active sequence parameter set remains unchanged throughout a coded video sequence in the layer in which the active sequence parameter set is referred to.

A scalable nesting SEI message has been specified in SVC. The scalable nesting SEI message provides a mechanism for associating SEI messages with subsets of a bitstream, such as indicated dependency representations or other scalable layers. A scalable nesting SEI message contains one or more SEI messages that are not scalable nesting SEI messages themselves. An SEI message contained in a scalable nesting SEI message is referred to as a nested SEI message. An SEI message not contained in a scalable nesting SEI message is referred to as a non-nested SEI message.

A scalable video encoder for quality scalability (also known as Signal-to-Noise or SNR) and/or spatial scalability may be implemented as follows. For a base layer, a conventional non-scalable video encoder and decoder may be used. The reconstructed/decoded pictures of the base layer are included in the reference picture buffer and/or reference picture lists for an enhancement layer. In case of spatial scalability, the reconstructed/decoded base-layer picture may be upsampled prior to its insertion into the reference picture lists for an enhancement-layer picture. The base layer decoded pictures may be inserted into a reference picture list(s) for coding/decoding of an enhancement layer picture similarly to the decoded reference pictures of the enhancement layer. Consequently, the encoder may choose a base-layer reference picture as an inter prediction reference and indicate its use with a reference picture index in the coded bitstream. The decoder decodes from the bitstream, for example from a reference picture index, that a base-layer picture is used as an inter prediction reference for the enhancement layer. When a decoded base-layer picture is used as the prediction reference for an enhancement layer, it is referred to as an inter-layer reference picture.

While the previous paragraph described a scalable video codec with two scalability layers with an enhancement layer and a base layer, it needs to be understood that the description can be generalized to any two layers in a scalability hierarchy with more than two layers. In this case, a second enhancement layer may depend on a first enhancement layer in encoding and/or decoding processes, and the first enhancement layer may therefore be regarded as the base layer for the encoding and/or decoding of the second enhancement layer. Furthermore, it needs to be understood that there may be inter-layer reference pictures from more than one layer in a reference picture buffer or reference picture lists of an enhancement layer, and each of these inter-layer reference pictures may be considered to reside in a base layer or a reference layer for the enhancement layer being encoded and/or decoded.

Frame packing refers to a method where more than one frame is packed into a single frame at the encoder side as a pre-processing step for encoding and then the frame-packed frames are encoded with a conventional 2D video coding scheme. The output frames produced by the decoder therefore contain constituent frames of that correspond to the input frames spatially packed into one frame in the encoder side. Frame packing may be used for stereoscopic video, where a pair of frames, one corresponding to the left eye/camera/view and the other corresponding to the right eye/camera/view, is packed into a single frame. Frame packing may also or alternatively be used for depth or disparity enhanced video, where one of the constituent frames represents depth or disparity information corresponding to another constituent frame containing the regular color information (luma and chroma information). The use of frame-packing may be signaled in the video bitstream, for example using the frame packing arrangement SEI message of H.264/AVC or similar. The use of frame-packing may also or alternatively be indicated over video interfaces, such as High-Definition Multimedia Interface (HDMI). The use of frame-packing may also or alternatively be indicated and/or negotiated using various capability exchange and mode negotiation protocols, such as Session Description Protocol (SDP). The decoder or renderer may extract the constituent frames from the decoded frames according to the indicated frame packing arrangement type.

In general, frame packing may for example be applied such a manner that a frame may contain constituent frames of more than two views and/or some or all constituent frames may have unequal spatial extents and/or constituent frames may be depth view components. For example, pictures of frame-packed video may contain a video-plus-depth representation, i.e. a texture frame and a depth frame, for example in a side-by-side frame packing arrangement.

Characteristics, coding properties, and alike that apply only to a subset of constituent frames in frame-packed video may be indicated for example through a specific nesting SEI message. Such a nesting SEI message may indicate which constituent frames it applies to and include one or more SEI messages that apply to the indicated constituent frames. For example, a motion-constrained tile set SEI message may indicate a set of tile indexes or addresses alike within an indicated or inferred group of pictures, such as within the coded video sequence, that form an isolated-region picture group.

As indicated earlier, MVC is an extension of H.264/AVC. Many of the definitions, concepts, syntax structures, semantics, and decoding processes of H.264/AVC apply also to MVC as such or with certain generalizations or constraints. Some definitions, concepts, syntax structures, semantics, and decoding processes of MVC are described in the following.

An access unit in MVC is defined to be a set of NAL units that are consecutive in decoding order and contain exactly one primary coded picture consisting of one or more view components. In addition to the primary coded picture, an access unit may also contain one or more redundant coded pictures, one auxiliary coded picture, or other NAL units not containing slices or slice data partitions of a coded picture. The decoding of an access unit results in one decoded picture consisting of one or more decoded view components, when decoding errors, bitstream errors or other errors which may affect the decoding do not occur. In other words, an access unit in MVC contains the view components of the views for one output time instance.

A view component in MVC is referred to as a coded representation of a view in a single access unit.

Inter-view prediction may be used in MVC and refers to prediction of a view component from decoded samples of different view components of the same access unit. In MVC, inter-view prediction is realized similarly to inter prediction. For example, inter-view reference pictures are placed in the same reference picture list(s) as reference pictures for inter prediction, and a reference index as well as a motion vector are coded or inferred similarly for inter-view and inter reference pictures.

An anchor picture is a coded picture in which all slices may reference only slices within the same access unit, i.e., inter-view prediction may be used, but no inter prediction is used, and all following coded pictures in output order do not use inter prediction from any picture prior to the coded picture in decoding order. Inter-view prediction may be used for IDR view components that are part of a non-base view. A base view in MVC is a view that has the minimum value of view order index in a coded video sequence. The base view can be decoded independently of other views and does not use inter-view prediction. The base view can be decoded by H.264/AVC decoders supporting only the single-view profiles, such as the Baseline Profile or the High Profile of H.264/AVC.

In the MVC standard, many of the sub-processes of the MVC decoding process use the respective sub-processes of the H.264/AVC standard by replacing term “picture”, “frame”, and “field” in the sub-process specification of the H.264/AVC standard by “view component”, “frame view component”, and “field view component”, respectively. Likewise, terms “picture”, “frame”, and “field” are often used in the following to mean “view component”, “frame view component”, and “field view component”, respectively.

As mentioned earlier, non-base views of MVC bitstreams may refer to a subset sequence parameter set NAL unit. A subset sequence parameter set for MVC includes a base SPS data structure and an sequence parameter set MVC extension data structure. In MVC, coded pictures from different views may use different sequence parameter sets. An SPS in MVC (specifically the sequence parameter set MVC extension part of the SPS in MVC) can contain the view dependency information for inter-view prediction. This may be used for example by signaling-aware media gateways to construct the view dependency tree.

In the context of multiview video coding, view order index may be defined as an index that indicates the decoding or bitstream order of view components in an access unit. In MVC, the inter-view dependency relationships are indicated in a sequence parameter set MVC extension, which is included in a sequence parameter set. According to the MVC standard, all sequence parameter set MVC extensions that are referred to by a coded video sequence are required to be identical. The following excerpt of the sequence parameter set MVC extension provides further details on the way inter-view dependency relationships are indicated in MVC.

| | | | De- |
|---|---|---|---|
| | | | scrip- |
| seq_parameter_set_mvc_extension( ) { | | C | tor |
| | num_views_minus1 | 0 | ue(v) |
| | for( i = 0; i <= num_views_minus1; i++ ) | | |

| | | |
|---|---|---|
| view_id[ i ] | 0 | ue(v) |

for( i = 1; i <= num_views_minus1; i++ ) {

| | | |
|---|---|---|
| num_anchor_refs_l0[ i ] | 0 | ue(v) |
| for( j = 0; j < num_anchor_refs_l0[ i ]; j++ ) | | |

| | | |
|---|---|---|
| anchor_ref_l0[ i ][ j ] | 0 | ue(v) |

| | | |
|---|---|---|
| num_anchor_refs_l1[ i ] | 0 | ue(v) |
| for( j = 0; j < num_anchor_refs_l1[ i ]; j++ ) | | |

| | | |
|---|---|---|
| anchor_ref_l1[ i ][ j ] | 0 | ue(v) |

}
for( i = 1; i <= num_views_minus1; i++ ) {

| | | |
|---|---|---|
| num_non_anchor_refs_l0[ i ] | 0 | ue(v) |
| for( j = 0; j < num_non_anchor_refs_l0[ i ]; j++ ) | | |

| | | |
|---|---|---|
| non_anchor_ref_l0[ i ][ j ] | 0 | ue(v) |

| | | |
|---|---|---|
| num_non_anchor_refs_l1[ i ] | 0 | ue(v) |
| for( j = 0; j < num_non_anchor_refs_l1[ i ]; j++ ) | | |

| | | |
|---|---|---|
| non_anchor_ref_l1[ i ][ j ] | 0 | ue(v) |

}
. . .

In MVC decoding process, the variable VOIdx may represent the view order index of the view identified by view_id (which may be obtained from the MVC NAL unit header of the coded slice being decoded) and may be set equal to the value of i for which the syntax element view_id[i] included in the referred subset sequence parameter set is equal to view_id.

The semantics of the sequence parameter set MVC extension may be specified as follows. num_views_minus1 plus 1 specifies the maximum number of coded views in the coded video sequence. The actual number of views in the coded video sequence may be less than num_views_minus1 plus 1. view_id[i] specifies the view_id of the view with VOIdx equal to i. num_anchor_refs_l0[i] specifies the number of view components for inter-view prediction in the initial reference picture list RefPicList0 in decoding anchor view components with VOIdx equal to i. anchor_ref_l0[i][j] specifies the view_id of the j-th view component for inter-view prediction in the initial reference picture list RefPicList0 in decoding anchor view components with VOIdx equal to i. num_anchor_refs_l1[i] specifies the number of view components for inter-view prediction in the initial reference picture list RefPicList1 in decoding anchor view components with VOIdx equal to i. anchor_ref_l1[i][j] specifies the view_id of the j-th view component for inter-view prediction in the initial reference picture list RefPicList1 in decoding an anchor view component with VOIdx equal to i. num_non_anchor_refs_l0[i] specifies the number of view components for inter-view prediction in the initial reference picture list RefPicList0 in decoding non-anchor view components with VOIdx equal to i. non_anchor_ref_l0[i][j] specifies the view_id of the j-th view component for inter-view prediction in the initial reference picture list RefPicList0 in decoding non-anchor view components with VOIdx equal to i. num_non_anchor_refs_l1[i] specifies the number of view components for inter-view prediction in the initial reference picture list RefPicList 1 in decoding non-anchor view components with VOIdx equal to i. non_anchor_ref_l1[i][j] specifies the view_id of the j-th view component for inter-view prediction in the initial reference picture list RefPicList1 in decoding non-anchor view components with VOIdx equal to i. For any particular view with view_id equal to vId1 and VOIdx equal to vOIdx1 and another view with view_id equal to vId2 and VOIdx equal to vOIdx2, when vId2 is equal to the value of one of non_anchor_ref_l0[vOIdx1][j] for all j in the range of 0 to num_non_anchor_refs_l0[vOIdx1], exclusive, or one of non_anchor_ref_l1[vOIdx1][j] for all j in the range of 0 to num_non_anchor_refs_l1[vOIdx1], exclusive, vId2 is also required to be equal to the value of one of anchor_ref_l0[vOIdx1][j] for all j in the range of 0 to num_anchor_refs_l0[vOIdx1], exclusive, or one of anchor_ref_l1[vOIdx1][j] for all j in the range of 0 to num_anchor_refs_l1[vOIdx1], exclusive. The inter-view dependency for non-anchor view components is a subset of that for anchor view components.

In MVC, an operation point may be defined as follows: An operation point is identified by a temporal_id value representing the target temporal level and a set of view_id values representing the target output views. One operation point is associated with a bitstream subset, which consists of the target output views and all other views the target output views depend on, that is derived using the sub-bitstream extraction process with tIdTarget equal to the temporal_id value and viewIdTargetList consisting of the set of view_id values as inputs. More than one operation point may be associated with the same bitstream subset. When “an operation point is decoded”, a bitstream subset corresponding to the operation point may be decoded and subsequently the target output views may be output.

One branch of research for obtaining compression improvement in stereoscopic video is known as asymmetric stereoscopic video coding. Asymmetric stereoscopic video coding may be considered to be based on the assumption that the Human Visual System (HVS) fuses the stereoscopic image pair such that the perceived quality is close to that of the higher quality view. Thus, compression improvement is obtained by providing a quality difference between the two coded views.

Asymmetry between the two views can be achieved, for example, by one or more of the following methods:
1. Mixed-resolution (MR) stereoscopic video coding, also referred to as resolution-asymmetric stereoscopic video coding. For example, one of the views is low-pass filtered and hence has a smaller amount of spatial details or a lower spatial resolution. Furthermore, the low-pass filtered view is usually sampled with a coarser sampling grid, i.e., represented by fewer pixels.
2. Cross-asymmetric mixed-resolution stereoscopic video coding. One or more images of a first view are captured or resampled in such a manner that its extents along one direction (height or width) are smaller than the extents along the same direction (height or width, respectively) of one or more images of the other view, while extents along the other direction are captured or resampled to be greater than the extents along the same direction of one or more images of the other view. In other words, let us denote width and height of the left (first) view as w1 and h1, and width and height of the right (second) view as w2 and h2, resulting in the extents of an image in the left view to be (w1×h1) and the extents of an image in the right view to be (w2×h2). Then, in cross-asymmetric mixed-resolution stereoscopic video, the images of left and right view are captured or resampled in such a manner that either (w1<w2 and h1>h2) or (w1>w2 and h1<h2). The images captured or resampled according to this constraint may then be compressed, decompressed, and resampled after decompression in such a manner that the resampled images after decompression have equal resolution.
3. Mixed-resolution chroma sampling. The chroma pictures of one view are represented by fewer samples than the respective chroma pictures of the other view.
4. Asymmetric sample-domain quantization. The sample values of the two views are quantized with a different step size. For example, the luma samples of one view may be represented with the range of 0 to 255 (i.e., 8 bits per sample) while the range may be scaled to the range of 0 to 159 for the second view. Thanks to fewer quantization steps, the second view can be compressed with a higher ratio compared to the first view. Different quantization step sizes may be used for luma and chroma samples. As a special case of asymmetric sample-domain quantization, one can refer to bit-depth-asymmetric stereoscopic video when the number of quantization steps in each view matches a power of two.
5. Asymmetric transform-domain quantization. The transform coefficients of the two views are quantized with a different step size. As a result, one of the views has a lower fidelity and may be subject to a greater amount of visible coding artifacts, such as blocking and ringing.
6. A combination of different encoding techniques above.

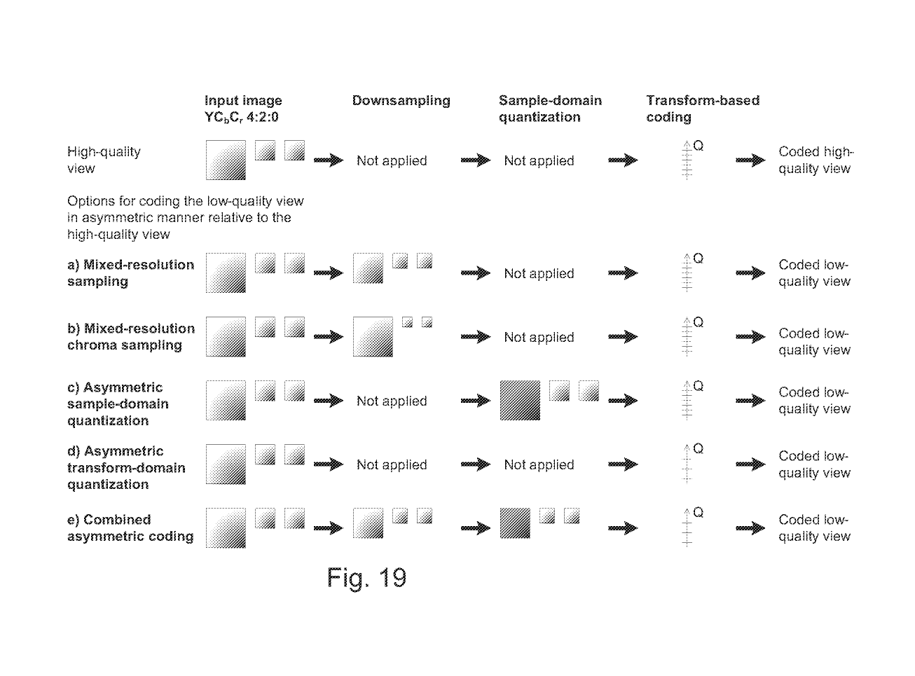

Some of the aforementioned types of asymmetric stereoscopic video coding are illustrated in FIG. 19. The first row presents the higher quality view which is only transform-coded. The remaining rows 19a)-19e) present several encoding combinations which have been investigated to create the lower quality view using different steps, namely, downsampling, sample domain quantization, and transform based coding. It can be observed from FIG. 19 that downsampling or sample-domain quantization can be applied or skipped regardless of how other steps in the processing chain are applied. Likewise, the quantization step in the transform-domain coding step can be selected independently of the other steps. Thus, practical realizations of asymmetric stereoscopic video coding may use appropriate techniques for achieving asymmetry in a combined manner as illustrated in FIG. 19e.

In addition to the aforementioned types of asymmetric stereoscopic video coding, mixed temporal resolution (i.e., different picture rate) between views has been proposed.

Spatial resolution of an image or a picture may be defined as the number of pixels or samples representing the image/picture in horizontal and vertical direction. In this document, expressions such as “images at different resolution” may be interpreted as two images have different number of pixels either in horizontal direction, or in vertical direction, or in both directions.

In signal processing, resampling of images is usually understood as changing the sampling rate of the current image in horizontal or/and vertical directions. Resampling results in a new image which is represented with different number of pixels in horizontal or/and vertical direction. In some applications, the process of image resampling is equal to image resizing. In general, resampling is classified in two processes: downsampling and upsampling.

Downsampling or subsampling process may be defined as reducing the sampling rate of a signal, and it typically results in reducing of the image sizes in horizontal and/or vertical directions. In image downsampling, the spatial resolution of the output image, i.e. the number of pixels in the output image, is reduced compared to the spatial resolution of the input image. Downsampling ratio may be defined as the horizontal or vertical resolution of the downsampled image divided by the respective resolution of the input image for downsampling. Downsampling ratio may alternatively be defined as the number of samples in the downsampled image divided by the number of samples in the input image for downsampling. As the two definitions differ, the term downsampling ratio may be further characterized by indicating whether it is indicated along one coordinate axis or both coordinate axes (and hence as a ratio of number of pixels in the images). Image downsampling may be performed for example by decimation, i.e. by selecting a specific number of pixels, based on the downsampling ratio, out of the total number of pixels in the original image. In some embodiments downsampling may include low-pass filtering or other filtering operations, which may be performed before or after image decimation. Any low-pass filtering method may be used, including but not limited to linear averaging.

Upsampling process may be defined as increasing the sampling rate of the signal, and it typically results in increasing of the image sizes in horizontal and/or vertical directions. In image upsampling, the spatial resolution of the output image, i.e. the number of pixels in the output image, is increased compared to the spatial resolution of the input image. Upsampling ratio may be defined as the horizontal or vertical resolution of the upsampled image divided by the respective resolution of the input image. Upsampling ratio may alternatively be defined as the number of samples in the upsampled image divided by the number of samples in the input image. As the two definitions differ, the term upsampling ratio may be further characterized by indicating whether it is indicated along one coordinate axis or both coordinate axes (and hence as a ratio of number of pixels in the images). Image upsampling may be performed for example by copying or interpolating pixel values such that the total number of pixels is increased. In some embodiments, upsampling may include filtering operations, such as edge enhancement filtering.

Downsampling can be utilized in image/video coding to improve coding efficiency of existing coding scheme or to reduce computation complexity of these solutions. For example, quarter-resolution (half-resolution along both coordinate axes) depth maps compared to the texture pictures may be used as input to transform-based coding such as H.264/AVC, MVC, 3DV-ATM, HEVC, combinations and/or derivations thereof, or any similar coding scheme.

Upsampling process is commonly used in state-of-the-art video coding technologies in order to improve coding efficiency and/or fidelity of those. For example, 4× resolution upsampling of coded video data may be utilized in coding loop of H.264/AVC, MVC, 3DV-ATM, HEVC, combinations and/or derivations thereof, or any similar coding scheme due to 1/4-pixel motion vector accuracy and interpolation of the sub-pixel values for the 1/4-pixel grid that can be referenced by motion vectors.

In scalable multiview coding, the same bitstream may contain coded view components of multiple views and at least some coded view components may be coded using quality and/or spatial scalability.

A texture view refers to a view that represents ordinary video content, for example has been captured using an ordinary camera, and is usually suitable for rendering on a display. A texture view typically comprises pictures having three components, one luma component and two chroma components.

In the following, a texture picture typically comprises all its component pictures or color components unless otherwise indicated for example with terms luma texture picture and chroma texture picture.

A depth view refers to a view that represents distance information of a texture sample from the camera sensor, disparity or parallax information between a texture sample and a respective texture sample in another view, or similar information. A depth view may comprise depth pictures (a.k.a. depth maps) having one component, similar to the luma component of texture views. A depth map is an image with per-pixel depth information or similar. For example, each sample in a depth map represents the distance of the respective texture sample or samples from the plane on which the camera lies. In other words, if the z axis is along the shooting axis of the cameras (and hence orthogonal to the plane on which the cameras lie), a sample in a depth map represents the value on the z axis. The semantics of depth map values may for example include the following:
1. Each luma sample value in a coded depth view component represents an inverse of real-world distance (Z) value, i.e. 1/Z, normalized in the dynamic range of the luma samples, such to the range of 0 to 255, inclusive, for 8-bit luma representation. The normalization may be done in a manner where the quantization 1/Z is uniform in terms of disparity.
2. Each luma sample value in a coded depth view component represents an inverse of real-world distance (Z) value, i.e. 1/Z, which is mapped to the dynamic range of the luma samples, such to the range of 0 to 255, inclusive, for 8-bit luma representation, using a mapping function f(1/Z) or table, such as a piece-wise linear mapping. In other words, depth map values result in applying the function f(1/Z).
3. Each luma sample value in a coded depth view component represents a real-world distance (Z) value normalized in the dynamic range of the luma samples, such to the range of 0 to 255, inclusive, for 8-bit luma representation.
4. Each luma sample value in a coded depth view component represents a disparity or parallax value from the present depth view to another indicated or derived depth view or view position.

While phrases such as depth view, depth view component, depth picture and depth map are used to describe various embodiments, it is to be understood that any semantics of depth map values may be used in various embodiments including but not limited to the ones described above. For example, embodiments of the invention may be applied for depth pictures where sample values indicate disparity values.

An encoding system or any other entity creating or modifying a bitstream including coded depth maps may create and include information on the semantics of depth samples and on the quantization scheme of depth samples into the bitstream. Such information on the semantics of depth samples and on the quantization scheme of depth samples may be for example included in a video parameter set structure, in a sequence parameter set structure, or in an SEI message.

Depth-enhanced video refers to texture video having one or more views associated with depth video having one or more depth views. A number of approaches may be used for representing of depth-enhanced video, including the use of video plus depth (V+D), multiview video plus depth (MVD), and layered depth video (LDV). In the video plus depth (V+D) representation, a single view of texture and the respective view of depth are represented as sequences of texture picture and depth pictures, respectively. The MVD representation contains a number of texture views and respective depth views. In the LDV representation, the texture and depth of the central view are represented conventionally, while the texture and depth of the other views are partially represented and cover only the dis-occluded areas required for correct view synthesis of intermediate views.

A texture view component may be defined as a coded representation of the texture of a view in a single access unit. A texture view component in depth-enhanced video bitstream may be coded in a manner that is compatible with a single-view texture bitstream or a multi-view texture bitstream so that a single-view or multi-view decoder can decode the texture views even if it has no capability to decode depth views. For example, an H.264/AVC decoder may decode a single texture view from a depth-enhanced H.264/AVC bitstream. A texture view component may alternatively be coded in a manner that a decoder capable of single-view or multi-view texture decoding, such H.264/AVC or MVC decoder, is not able to decode the texture view component for example because it uses depth-based coding tools. A depth view component may be defined as a coded representation of the depth of a view in a single access unit. A view component pair may be defined as a texture view component and a depth view component of the same view within the same access unit.

Depth-enhanced video may be coded in a manner where texture and depth are coded independently of each other. For example, texture views may be coded as one MVC bitstream and depth views may be coded as another MVC bitstream. Depth-enhanced video may also be coded in a manner where texture and depth are jointly coded. In a form a joint coding of texture and depth views, some decoded samples of a texture picture or data elements for decoding of a texture picture are predicted or derived from some decoded samples of a depth picture or data elements obtained in the decoding process of a depth picture. Alternatively or in addition, some decoded samples of a depth picture or data elements for decoding of a depth picture are predicted or derived from some decoded samples of a texture picture or data elements obtained in the decoding process of a texture picture. In another option, coded video data of texture and coded video data of depth are not predicted from each other or one is not coded/decoded on the basis of the other one, but coded texture and depth view may be multiplexed into the same bitstream in the encoding and demultiplexed from the bitstream in the decoding. In yet another option, while coded video data of texture is not predicted from coded video data of depth in e.g. below slice layer, some of the high-level coding structures of texture views and depth views may be shared or predicted from each other. For example, a slice header of coded depth slice may be predicted from a slice header of a coded texture slice. Moreover, some of the parameter sets may be used by both coded texture views and coded depth views.

It has been found that a solution for some multiview 3D video (3DV) applications is to have a limited number of input views, e.g. a mono or a stereo view plus some supplementary data, and to render (i.e. synthesize) all required views locally at the decoder side. From several available technologies for view rendering, depth image-based rendering (DIBR) has shown to be a competitive alternative.

A simplified model of a DIBR-based 3DV system is shown in FIG. 5. The input of a 3D video codec comprises a stereoscopic video and corresponding depth information with stereoscopic baseline b0. Then the 3D video codec synthesizes a number of virtual views between two input views with baseline (b1<b0). DIBR algorithms may also enable extrapolation of views that are outside the two input views and not in between them. Similarly, DIBR algorithms may enable view synthesis from a single view of texture and the respective depth view. However, in order to enable DIBR-based multiview rendering, texture data should be available at the decoder side along with the corresponding depth data.

In such 3DV system, depth information is produced at the encoder side in a form of depth pictures (also known as depth maps) for texture views.

Depth information can be obtained by various means. For example, depth of the 3D scene may be computed from the disparity registered by capturing cameras or color image sensors. A depth estimation approach, which may also be referred to as stereo matching, takes a stereoscopic view as an input and computes local disparities between the two offset images of the view. Since the two input views represent different viewpoints or perspectives, the parallax creates a disparity between the relative positions of scene points on the imaging planes depending on the distance of the points. A target of stereo matching is to extract those disparities by finding or detecting the corresponding points between the images. Several approaches for stereo matching exist. For example, in a block or template matching approach each image is processed pixel by pixel in overlapping blocks, and for each block of pixels a horizontally localized search for a matching block in the offset image is performed. Once a pixel-wise disparity is computed, the corresponding depth value z is calculated by equation (1):

$$z = \frac{f \cdot b}{d + Δ d} , \qquad ( 1 )$$

where f is the focal length of the camera and b is the baseline distance between cameras, as shown in FIG. 6. Further, d may be considered to refer to the disparity observed between the two cameras or the disparity estimated between corresponding pixels in the two cameras. The camera offset Ad may be considered to reflect a possible horizontal misplacement of the optical centers of the two cameras or a possible horizontal cropping in the camera frames due to pre-processing. However, since the algorithm is based on block matching, the quality of a depth-through-disparity estimation is content dependent and very often not accurate. For example, no straightforward solution for depth estimation is possible for image fragments that are featuring very smooth areas with no textures or large level of noise.

Alternatively or in addition to the above-described stereo view depth estimation, the depth value may be obtained using the time-of-flight (TOF) principle for example by using a camera which may be provided with a light source, for example an infrared emitter, for illuminating the scene. Such an illuminator may be arranged to produce an intensity modulated electromagnetic emission for a frequency between e.g. 10-100 MHz, which may require LEDs or laser diodes to be used. Infrared light may be used to make the illumination unobtrusive. The light reflected from objects in the scene is detected by an image sensor, which may be modulated synchronously at the same frequency as the illuminator. The image sensor may be provided with optics; a lens gathering the reflected light and an optical bandpass filter for passing only the light with the same wavelength as the illuminator, thus helping to suppress background light. The image sensor may measure for each pixel the time the light has taken to travel from the illuminator to the object and back. The distance to the object may be represented as a phase shift in the illumination modulation, which can be determined from the sampled data simultaneously for each pixel in the scene.

Alternatively or in addition to the above-described stereo view depth estimation and/or TOF-principle depth sensing, depth values may be obtained using a structured light approach which may operate for example approximately as follows. A light emitter, such as an infrared laser emitter or an infrared LED emitter, may emit light that may have a certain direction in a 3D space (e.g. follow a raster-scan or a pseudo-random scanning order) and/or position within an array of light emitters as well as a certain pattern, e.g. a certain wavelength and/or amplitude pattern. The emitted light is reflected back from objects and may be captured using a sensor, such as an infrared image sensor. The image/signals obtained by the sensor may be processed in relation to the direction of the emitted light as well as the pattern of the emitted light to detect a correspondence between the received signal and the direction/position of the emitted lighted as well as the pattern of the emitted light for example using a triangulation principle. From this correspondence a distance and a position of a pixel may be concluded.

It is to be understood that the above-described depth estimation and sensing methods are provided as non-limiting examples and embodiments may be realized with the described or any other depth estimation and sensing methods and apparatuses.

Disparity or parallax maps, such as parallax maps specified in ISO/IEC International Standard 23002-3, may be processed similarly to depth maps. Depth and disparity have a straightforward correspondence and they can be computed from each other through mathematical equation.

Texture views and depth views may be coded into a single bitstream where some of the texture views may be compatible with one or more video standards such as H.264/AVC and/or MVC. In other words, a decoder may be able to decode some of the texture views of such a bitstream and can omit the remaining texture views and depth views.

In this context an encoder that encodes one or more texture and depth views into a single H.264/AVC and/or MVC compatible bitstream is also called as a 3DV-ATM encoder. Bitstreams generated by such an encoder can be referred to as 3DV-ATM bitstreams. The 3DV-ATM bitstreams may include some of the texture views that H.264/AVC and/or MVC decoder cannot decode, and depth views. A decoder capable of decoding all views from 3DV-ATM bitstreams may also be called as a 3DV-ATM decoder.

3DV-ATM bitstreams can include a selected number of AVC/MVC compatible texture views. Furthermore, 3DV-ATM bitstream can include a selected number of depth views that are coded using the coding tools of the AVC/MVC standard only. The remaining depth views of an 3DV-ATM bitstream for the AVC/MVC compatible texture views may be predicted from the texture views and/or may use depth coding methods not included in the AVC/MVC standard presently. The remaining texture views may utilize enhanced texture coding, i.e. coding tools that are not included in the AVC/MVC standard presently.

Inter-component prediction may be defined to comprise prediction of syntax element values, sample values, variable values used in the decoding process, or anything alike from a component picture of one type to a component picture of another type. For example, inter-component prediction may comprise prediction of a texture view component from a depth view component, or vice versa.

An example of syntax and semantics of a 3DV-ATM bitstream and a decoding process for a 3DV-ATM bitstream may be found in document MPEG N12544, “Working Draft 2 of MVC extension for inclusion of depth maps”, which requires at least two texture views to be MVC compatible. Furthermore, depth views are coded using existing AVC/MVC coding tools. An example of syntax and semantics of a 3DV-ATM bitstream and a decoding process for a 3DV-ATM bitstream may be found in document MPEG N12545, “Working Draft 1 of AVC compatible video with depth information”, which requires at least one texture view to be AVC compatible and further texture views may be MVC compatible. The bitstream formats and decoding processes specified in the mentioned documents are compatible as described in the following. The 3DV-ATM configuration corresponding to the working draft of “MVC extension for inclusion of depth maps” (MPEG N12544) may be referred to as “3D High” or “MVC+D” (standing for MVC plus depth). The 3DV-ATM configuration corresponding to the working draft of “AVC compatible video with depth information” (MPEG N12545) may be referred to as “3D Extended High” or “3D Enhanced High” or “3D-AVC”. The 3D Extended High configuration is a superset of the 3D High configuration. That is, a decoder supporting 3D Extended High configuration should also be able to decode bitstreams generated for the 3D High configuration.

A later draft version of the MVC+D specification is available as MPEG document N12923 (“Text of ISO/IEC 14496-10:2012/DAM2 MVC extension for inclusion of depth maps”). A later draft version of the 3D-AVC specification is available as MPEG document N12732 (“Working Draft 2 of AVC compatible video with depth”).

FIG. 10 shows an example processing flow for depth map coding for example in 3DV-ATM.

In some depth-enhanced video coding and bitstreams, such as MVC+D, depth views may refer to a differently structured sequence parameter set, such as a subset SPS NAL unit, than the sequence parameter set for texture views. For example, a sequence parameter set for depth views may include a sequence parameter set 3D video coding (3DVC) extension. When a different SPS structure is used for depth-enhanced video coding, the SPS may be referred to as a 3D video coding (3DVC) subset SPS or a 3DVC SPS, for example. From the syntax structure point of view, a 3DVC subset SPS may be a superset of an SPS for multiview video coding such as the MVC subset SPS.

A depth-enhanced multiview video bitstream, such as an MVC+D bitstream, may contain two types of operation points: multiview video operation points (e.g. MVC operation points for MVC+D bitstreams) and depth-enhanced operation points. Multiview video operation points consisting of texture view components only may be specified by an SPS for multiview video, for example a sequence parameter set MVC extension included in an SPS referred to by one or more texture views. Depth-enhanced operation points may be specified by an SPS for depth-enhanced video, for example a sequence parameter set MVC or 3DVC extension included in an SPS referred to by one or more depth views.

A depth-enhanced multiview video bitstream may contain or be associated with multiple sequence parameter sets, e.g. one for the base texture view, another one for the non-base texture views, and a third one for the depth views. For example, an MVC+D bitstream may contain one SPS NAL unit (with an SPS identifier equal to e.g. 0), one MVC subset SPS NAL unit (with an SPS identifier equal to e.g. 1), and one 3DVC subset SPS NAL unit (with an SPS identifier equal to e.g. 2). The first one is distinguished from the other two by NAL unit type, while the latter two have different profiles, i.e., one of them indicates an MVC profile and the other one indicates an MVC+D profile.

The coding and decoding order of texture view components and depth view components may be indicated for example in a sequence parameter set. For example, the following syntax of a sequence parameter set 3DVC extension is used in the draft 3D-AVC specification (MPEG N12732):

| seq_parameter_set_3dvc_extension( ) { | | C | Descriptor |
|---|---|---|---|
| | depth_info_present_flag | 0 | u(1) |
| | if( depth_info_present_flag ) { | | |

. . .

for( i = 0; i<= num_views_minus1; i++ )

| | | |
|---|---|---|
| depth_preceding_texture_flag[ i ] | 0 | u(1) |

The semantics of depth_preceding_texture_flag[i] may be specified as follows. depth_preceding_texture_flag[i] specifies the decoding order of depth view components in relation to texture view components. depth_preceding_texture_flag[i] equal to 1 indicates that the depth view component of the view with view_idx equal to i precedes the texture view component of the same view in decoding order in each access unit that contains both the texture and depth view components. depth_preceding_texture_flag[i] equal to 0 indicates that the texture view component of the view with view_idx equal to i precedes the depth view component of the same view in decoding order in each access unit that contains both the texture and depth view components.

A coded depth-enhanced video bitstream, such as an MVC+D bitstream or an AVC-3D bitstream, may be considered to include two types of operation points: texture video operation points, such as MVC operation points, and texture-plus-depth operation points including both texture views and depth views. An MVC operation point comprises texture view components as specified by the SPS MVC extension. A coded depth-enhanced video bitstream, such as an MVC+D bitstream or an AVC-3D bitstream, contains depth views, and therefore the whole bitstream as well as sub-bitstreams can provide so-called 3DVC operation points, which in the draft MVC+D and AVC-3D specifications contain both depth and texture for each target output view. In the draft MVC+D and AVC-3D specifications, the 3DVC operation points are defined in the 3DVC subset SPS by the same syntax structure as that used in the SPS MVC extension.

The coding and/or decoding order of texture view components and depth view components may determine presence of syntax elements related to inter-component prediction and allowed values of syntax elements related to inter-component prediction.

In the following some example coding and decoding methods which may be used in or with various embodiments of the invention are described. It needs to be understood that these coding and decoding methods are given as examples and embodiments of the invention may be applied with other similar coding methods and/or other coding methods utilizing inter-component redundancies or dependencies.

Depth maps may be filtered jointly for example using in-loop Joint inter-View Depth Filtering (JVDF) described as follows or a similar filtering process. The depth map of the currently processed view V_{c} may be converted into the depth space (Z-space):

$$z = \frac{1}{\frac{{v}_{1}}{255} \cdot ( \frac{1}{Z {1}_{near}} - \frac{1}{Z {1}_{far}} ) + \frac{1}{Z {1}_{far}}} , \qquad ( 2 )$$

Following this, depth map images of other available views (Vₐ₁, Vₐ₂) may be converted to the depth space and projected to the currently processed view V_{c}. These projections create several estimates of the depth value, which may be averaged in order to produce a denoised estimate of the depth value. Filtered depth value \hat{z}_{c} of current view V_{c} may be produced through a weighted average with depth estimate values \hat{z}_{a->c} projected from an available views Vₐ to a currently processed view V_{c}.

\hat{z}_{c}=w₁·\hat{z}_{c}+w₂·\hat{z}_{a->c}

where {w₁, w₂} are weighting factors or filter coefficients for the depth values of different views or view projections.

Filtering may be applied if depth value estimates belong to a certain confidence interval, in other words, if the absolute difference between estimates is below a particular threshold (Th):

If |z_{a→c}−z_{c}|<Th,w₁=w₂=0.5
Otherwise, w₁=1, w₂=0

Parameter Th may be transmitted to the decoder for example within a sequence parameter set.

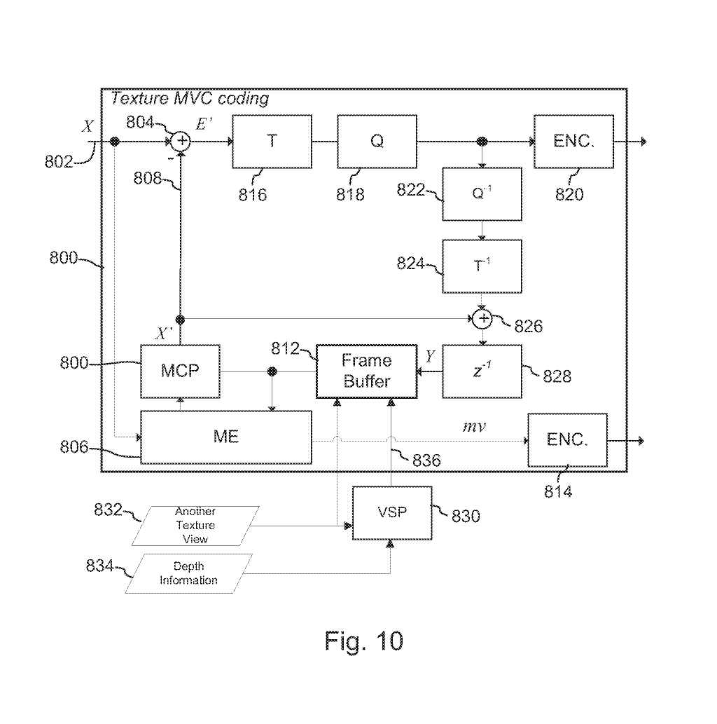

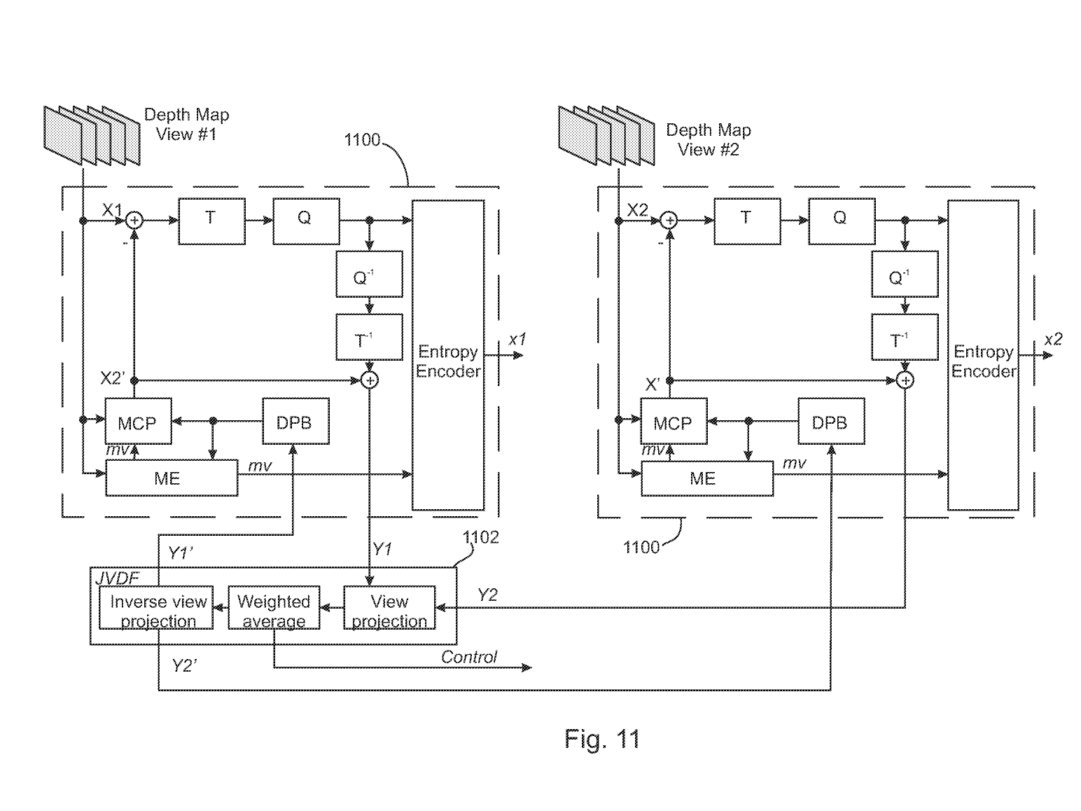

FIG. 11 shows an example of the coding of two depth map views with in-loop implementation of JVDF. A conventional video coding algorithm, such as H.264/AVC, is depicted within a dashed line box 1100, marked in black color. The JVDF is depicted in the solid-line box 1102.

In a coding tool known as joint multiview video plus depth coding (JMVDC), the correlation between the multiview texture video and the associated depth view sequences is exploited. Although the pixel values are quite different between a texture video and its depth map sequence, the silhouettes and movements of the objects in the texture video and the associated depth map sequence are typically similar. The proposed JMVDC scheme may be realized by a combination of the MVC and SVC coding schemes. Specifically, JMVDC may be realized by embedding the inter-layer motion prediction mechanism of SVC into the prediction structure in MVC. Each view may be coded and/or regarded as of a two-layer representation, where the texture resides in the base layer and the depth in the enhancement layer, which may be coded using the coarse granular scalability (CGS) of SVC with only inter-layer motion prediction allowed. In addition, inter-view prediction is enabled both in the base layer (texture) and in the enhancement layer (depth) for non-base views. While the inter-layer motion prediction of JMVDC could be applied for any inter-view prediction structure used for the base layer, an encoder and decoder may be realized in such a manner that inter-view prediction only appears at IDR and anchor access units, as it may provide a reasonable compromise between complexity and compression efficiency and ease the implementation effort of JMVDC. In the following, the JMVDC scheme is described for the IDR/anchor and non-anchor access units when inter-view prediction is allowed only in IDR/anchor access units and disallowed in non-IDR/non-anchor access units.

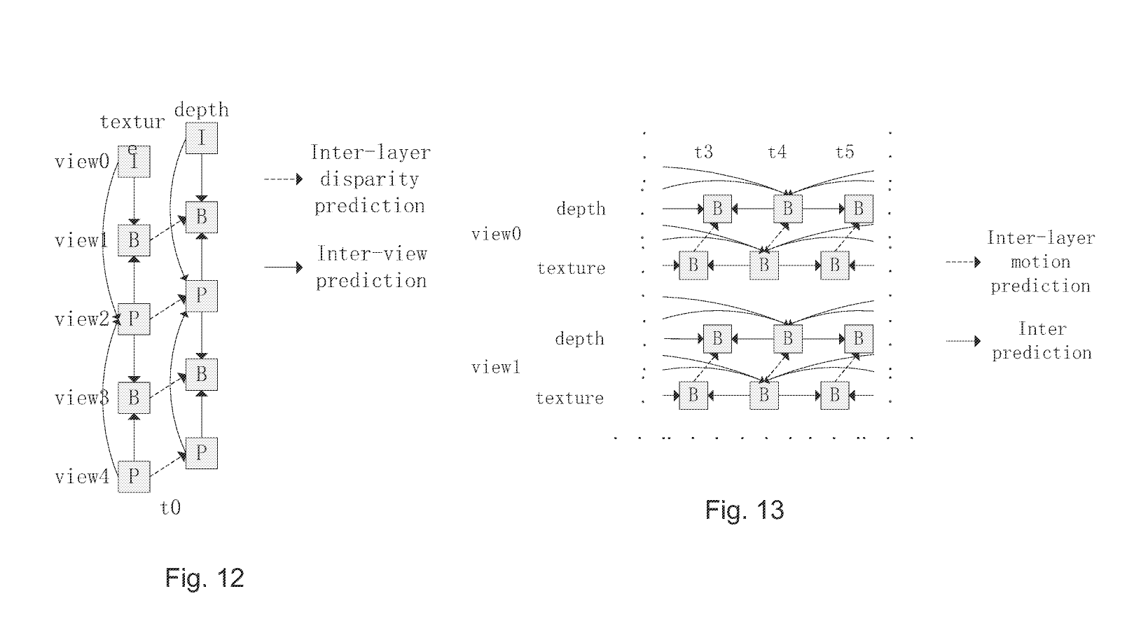

For IDR and anchor pictures, the JMVDC scheme may be applied as follows. A motion vector used in the inter-view prediction is called a disparity vector. As illustrated in FIG. 12, the disparity vectors of the multiview texture video are used as a prediction reference for derivation of the disparity vectors of multiview depth map in the inter-layer motion prediction process. In an example coding scheme, this prediction mechanism is referred as the inter-layer disparity prediction. For the coding of non-IDR/non-anchor pictures in JMVDC, the depth motion vectors for inter prediction may be predicted using the inter-layer motion prediction process from the respective texture motion vectors as depicted in FIG. 13.

The mode decision process for enhancement layer macroblocks may be identical for both anchor pictures and non-anchor pictures. The base mode may be added to the mode decision process and the motion/disparity vector of the co-located macroblock in the base layer may be chosen as a motion/disparity vector predictor for each enhancement layer macroblock.

The JMVDC tool may also be used in an arrangement where a depth view is regarded as the base layer and the respective texture view as the enhancement layer, and coding and decoding may be done otherwise as described above.

A coding tool known as inside-view motion prediction (IVMP) may operate as follows. In IVMP mode, the motion information, including mb_type, sub_mb_type, reference indices and motion vectors of the co-located macroblock in texture view component may be reused by the depth view component of the same view. A flag may be signaled in each macroblock or macroblock partition to indicate whether it uses the IVMP mode. If the spatial resolution of the depth view component differs from that of the texture view component, the motion vectors of the depth view components may be scaled proportionally to the ratio between the spatial resolutions of the texture view component and the depth view component, when they are used as the motion vectors of the co-located block or macroblock of the texture view component.

In the case of joint coding of texture and depth for depth-enhanced video, view synthesis can be utilized in the loop of the codec, thus providing view synthesis prediction (VSP). In VSP, a prediction signal, such as a VSP reference picture, is formed using a DIBR or view synthesis algorithm, utilizing texture and depth information. For example, a synthesized picture (i.e., VSP reference picture) may be introduced in the reference picture list in a similar way as it is done with interview reference pictures and inter-view only reference pictures. Alternatively or in addition, a specific VSP prediction mode for certain prediction blocks may be determined by the encoder, indicated in the bitstream by the encoder, and used as concluded from the bitstream by the decoder.

In MVC, both inter prediction and inter-view prediction use similar motion-compensated prediction process. Inter-view reference pictures and inter-view only reference pictures are essentially treated as long-term reference pictures in the different prediction processes. Similarly, view synthesis prediction may be realized in such a manner that it uses essentially the same motion-compensated prediction process as inter prediction and inter-view prediction. To differentiate from motion-compensated prediction taking place only within a single view without any VSP, motion-compensated prediction that includes and is capable of flexibly selecting mixing inter prediction, inter-prediction, and/or view synthesis prediction is herein referred to as mixed-direction motion-compensated prediction.

As reference picture lists in MVC and an envisioned coding scheme for MVD such as 3DV-ATM and in similar coding schemes may contain more than one type of reference pictures, i.e. inter reference pictures (also known as intra-view reference pictures), inter-view reference pictures, inter-view only reference pictures, and VSP reference pictures, a term prediction direction may be defined to indicate the use of intra-view reference pictures (temporal prediction), inter-view prediction, or VSP. For example, an encoder may choose for a specific block a reference index that points to an inter-view reference picture, thus the prediction direction of the block is inter-view.

To enable view synthesis prediction for the coding of the current texture view component, the previously coded texture and depth view components of the same access unit may be used for the view synthesis. Such a view synthesis that uses the previously coded texture and depth view components of the same access unit may be referred to as a forward view synthesis or forward-projected view synthesis, and similarly view synthesis prediction using such view synthesis may be referred to as forward view synthesis prediction or forward-projected view synthesis prediction.

Forward View Synthesis Prediction (VSP) may be performed as follows. View synthesis may be implemented through depth map (d) to disparity (D) conversion with following mapping pixels of source picture s(x,y) in a new pixel location in synthesised target image t(x+D,y).

$$t ( ⌊ x + D ⌋ , y ) = s ( x , y ) , \\ D ( s ( x , y ) ) = \frac{f \cdot l}{z} \\ z = {( \frac{d ( s ( x , y ) )}{255} ( \frac{1}{{Z}_{near}} - \frac{1}{{Z}_{far}} ) + \frac{1}{{Z}_{far}} )}^{- 1} , \qquad ( 3 )$$

In the case of projection of texture picture, s(x,y) is a sample of texture image, and d(s(x,y)) is the depth map value associated with s(x,y).

If a reference frame used for synthesis is 4:2:0, the chroma components may be upsampled to 4:4:4 for example by repeating the sample values as follows:

s′_{chroma}(x,y)=s_{chroma}(└x/2┘,└y/2┘)

where s′_{chroma}(•,•) is the chroma sample value in full resolution, and s_{chroma}(•,•) is the chroma sample value in half resolution.

In the case of projection of depth map values, s(x,y)=d(x,y) and this sample is projected using its own value d(s(x,y))=d(x,y).

Warping may be performed at sub-pixel accuracy by upsampling on the reference frame before warping and downsampling the synthesized frame back to the original resolution.

The view synthesis process may comprise two conceptual steps: forward warping and hole filling. In forward warping, each pixel of the reference image is mapped to a synthesized image. When multiple pixels from reference frame are mapped to the same sample location in the synthesized view, the pixel associated with a larger depth value (closer to the camera) may be selected in the mapping competition. After warping all pixels, there may be some hole pixels left with no sample values mapped from the reference frame, and these hole pixels may be filled in for example with a line-based directional hole filling, in which a “hole” is defined as consecutive hole pixels in a horizontal line between two non-hole pixels. Hole pixels may be filled by one of the two adjacent non-hole pixels which have a smaller depth sample value (farther from the camera).

Warping and hole filling may be performed in a single processing loop for example as follows. Each pixel row of the input reference image is traversed from e.g. left to right, and each pixel in the input reference image is processed as follows:

The current pixel is mapped to the target synthesis image according to the depth-to-disparity mapping/warping equation above. Pixels around depth boundaries may use splatting, in which one pixel is mapped to two neighboring locations. A boundary detection may be performed every N pixels in each line of the reference image. A pixel may be considered a depth-boundary pixel if the difference between the depth sample value of the pixel and that of a neighboring one in the same line (which is N-pixel to the right of the pixel) exceeds a threshold (corresponding to a disparity difference of M pixels in integer warping precision to the synthesized image). The depth-boundary pixel and K neighboring pixels to the right of the depth-boundary pixel may use splatting. More specifically, N=4×UpRefs, M=4, K=16×UpRefs−1, where UpRefs is the up-sampling ratio of the reference image before warping.

When the current pixel wins the z-buffering, i.e. when the current pixel is warped to a location without previously warped pixel or with a previously warped pixel having a smaller depth sample value, the iteration is defined to be effective and the following steps may be performed. Otherwise, the iteration is ineffective and the processing continues from the next pixel in the input reference image.

If there is a gap between the mapped locations of this iteration and the previous effective iteration, a hole may be identified.

If a hole was identified and the current mapped location is at the right of the previous one, the hole may be filled.

If a hole was identified and the current iteration mapped the pixel to the left of the mapped location of the previous effective iteration, consecutive pixels immediately to the left of this mapped location may be updated if they were holes.

To generate a view synthesized picture from a left reference view, the reference image may first be flipped and then the above process of warping and hole filling may be used to generate an intermediate synthesized picture. The intermediate synthesized picture may be flipped to obtain the synthesized picture. Alternatively, the process above may be altered to perform depth-to-disparity mapping, boundary-aware splatting, and other processes for view synthesis prediction basically with reverse assumptions on horizontal directions and order.

In another example embodiment the view synthesis prediction may include the following. Inputs of this example process for deriving a view synthesis picture are a decoded luma component of the texture view component srcPicY, two chroma components srcPicCb and srcPicCr up-sampled to the resolution of srcPicY, and a depth picture DisPic.

Output of an example process for deriving a view synthesis picture is a sample array of a synthetic reference component vspPic which is produced through disparity-based warping, which can be illustrated with the following pseudo code:

```
for( j = 0; j < PicHeigh ; j++ ) {
    for( i = 0; i < PicWidth; i++ ) {
    dX = Disparity(DisPic(j,i));
    outputPicY[ i+dX, j ] = srcTexturePicY[ i, j ];
    if( chroma_format_idc = = 1 ) {
        outputPicCb[ i+dX, j ] = normTexturePicCb[ i, j ]
        outputPicCr[ i+dX, j ] = normTexturePicCr[ i, j ]
    }
    }
}
```

where the function “Disparity( ) converts a depth map value at a spatial location i,j to a disparity value dX, PicHeigh is the height of the picture, PicWidth is the width of the picture, srcTexturePicY is the source texture picture, outputPicY is the Y component of the output picture, outputPicCb is the Cb component of the output picture, and outputPicCr is the Cr component of the output picture.

Disparity is computed taking into consideration camera settings, such as translation between two views b, camera's focal length f and parameters of depth map representation (Znear, Zfar) as shown below.

$$dX ( i , j ) = \frac{f \cdot b}{z ( i , j )} ; \\ z ( i , j ) = \frac{1}{\frac{DisPic ( i , j )}{255} \cdot ( \frac{1}{{Z}_{near}} - \frac{1}{{Z}_{far}} ) + \frac{1}{{Z}_{far}}} \qquad ( 4 )$$

The vspPic picture resulting from the above described process may feature various warping artifacts, such as holes and/or occlusions and to suppress those artifacts, various post-processing operations, such as hole filling, may be applied.

However, these operations may be avoided to reduce computational complexity, since a view synthesis picture vspPic is utilized for a reference pictures for prediction and may not be outputted to a display.

In a scheme referred to as a backward view synthesis or backward-projected view synthesis, the depth map co-located with the synthesized view is used in the view synthesis process. View synthesis prediction using such backward view synthesis may be referred to as backward view synthesis prediction or backward-projected view synthesis prediction or B-VSP. To enable backward view synthesis prediction for the coding of the current texture view component, the depth view component of the currently coded/decoded texture view component is required to be available. In other words, when the coding/decoding order of a depth view component precedes the coding/decoding order of the respective texture view component, backward view synthesis prediction may be used in the coding/decoding of the texture view component.

With the B-VSP, texture pixels of a dependent view can be predicted not from a synthesized VSP-frame, but directly from the texture pixels of the base or reference view. Displacement vectors required for this process may be produced from the depth map data of the dependent view, i.e. the depth view component corresponding to the texture view component currently being coded/decoded.

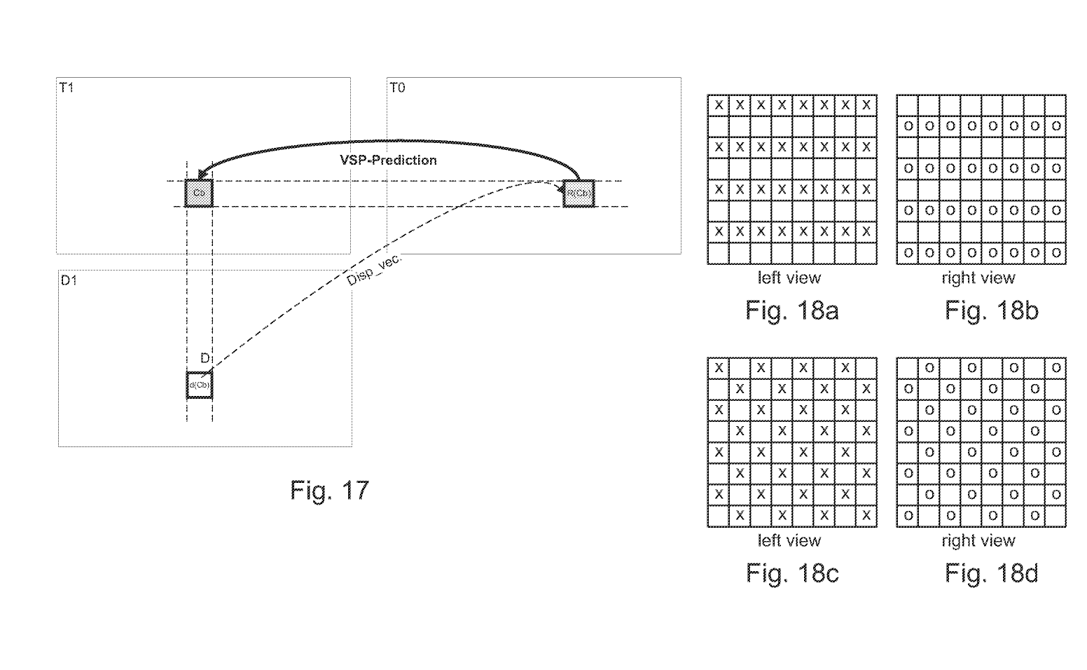

The concept of B-VSP may be explained with reference to FIG. 17 as follows. Let us assume that the following coding order is utilized: (T0, D0, D1, T1). Texture component T0 is a base view and T1 is dependent view coded/decoded using B-VSP as one prediction tool. Depth map components D0 and D1 are respective depth maps associated with T0 and T1, respectively. In dependent view T1, sample values of currently coded block Cb may be predicted from reference area R(Cb) that consists of sample values of the base view T0. The displacement vector (motion vector) between coded and reference samples may be found as a disparity between T1 and T0 from a depth map value associated with a currently coded texture sample.

The process of conversion of depth (1/Z) representation to disparity may be performed for example with following equations:

$$Z ( Cb ( j , i ) ) = \frac{1}{\frac{d ( Cb ( j , i ) )}{255} \cdot ( \frac{1}{Z near} - \frac{1}{Z far} ) + \frac{1}{Z far}} ; \\ D ( Cb ( j , i ) ) = \frac{f \cdot b}{Z ( Cb ( j , i ) )} ; \qquad ( 5 )$$

where j and i are local spatial coordinates within Cb, d(Cb(j,i)) is a depth map value in depth map image of a view #1, Z is its actual depth value, and D is a disparity to a particular view #0. The parameters f, b, Znear and Zfar are parameters specifying the camera setup; i.e. the used focal length (f), camera separation (b) between view #1 and view #0 and depth range (Znear,Zfar) representing parameters of depth map conversion.

A synthesized picture resulting from VSP may be included in the initial reference picture lists List0 and List1 for example following temporal and inter-view reference frames. However, reference picture list modification syntax (i.e., RPLR commands) may be extended to support VSP reference pictures, thus the encoder can order reference picture lists at any order, indicate the final order with RPLR commands in the bitstream, causing the decoder to reconstruct the reference picture lists having the same final order.

VSP may also be used in some encoding and decoding arrangements as a separate mode from intra, inter, inter-view and other coding modes. For example, no motion vector difference may be encoded into the bitstream for a block using VSP skip/direct mode, but the encoder and decoder may infer the motion vector difference to be equal to 0 and/or the motion vector being equal to 0. Furthermore, the VSP skip/direct mode may infer that no transform-coded residual block is encoded for the block using VSP skip/direct mode.

The disparity derived and used in a VSP process may be referred to as a disparity vector.

Depth-based motion vector prediction (D-MVP) is a coding tool which takes in use available depth map data and utilizes it for coding/decoding of the associated depth map texture data. This coding tool may require depth view component of a view to be coded/decoded prior to the texture view component of the same view. The D-MVP tool may comprise two parts, direction-separated MVP and depth-based MV competition for Skip and Direct modes, which are described next.

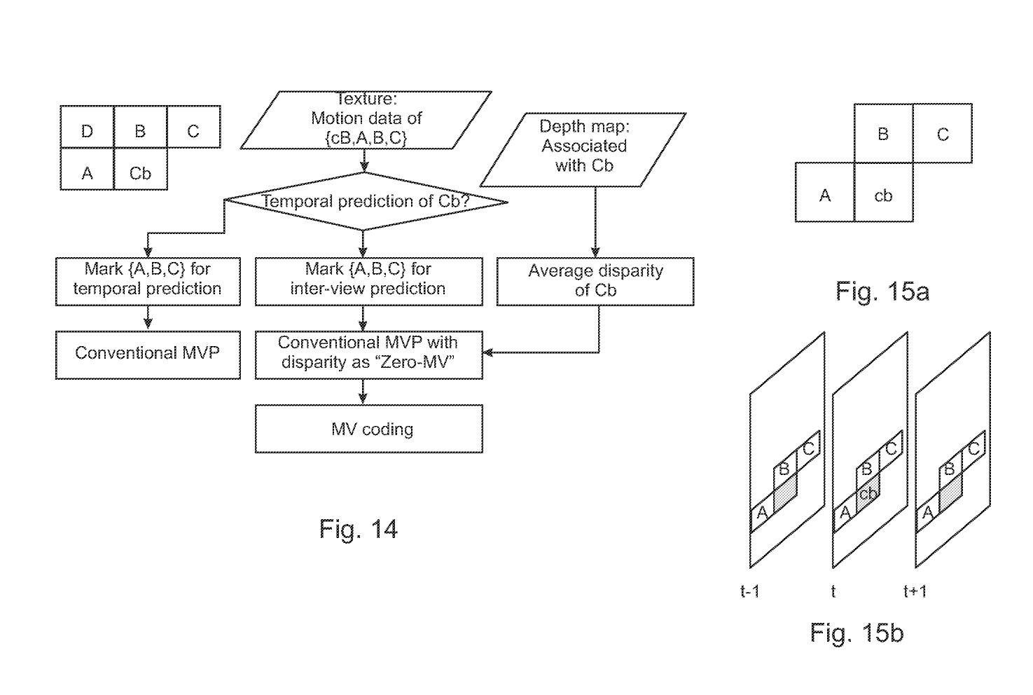

Direction-separated MVP may be described as follows. All available neighboring blocks are classified according to the direction of their prediction (e.g. temporal, inter-view, and view synthesis prediction). If the current block Cb, see FIG. 15a, uses an inter-view reference picture, all neighboring blocks which do not utilize inter-view prediction are marked as not-available for MVP and are not considered in the conventional motion vector prediction, such as the MVP of H.264/AVC. Similarly, if the current block Cb uses temporal prediction, neighboring blocks that used inter-view reference frames are marked as not-available for MVP. The flowchart of this process is depicted in FIG. 14. The flowchart and the description below considers temporal and inter-view prediction directions only, but it could be similarly extended to cover also other prediction directions, such as view synthesis prediction, or one or both of temporal and inter-view prediction directions could be similarly replaced by other prediction directions.

If no motion vector candidates are available from the neighboring blocks, the default “zero-MV” MVP (mv_{y}=0, mvₓ=0) for inter-view prediction may be replaced with mv_{y}=0 and mvᵢ= D̅ (cb where D̅(cb) is average disparity which is associated with current texture Cb and may be computed by:

D̅(cb)=(1/N)·ΣᵢD(cb(i))

where i is index of pixels within current block Cb, N is a total number of pixels in the current block Cb.

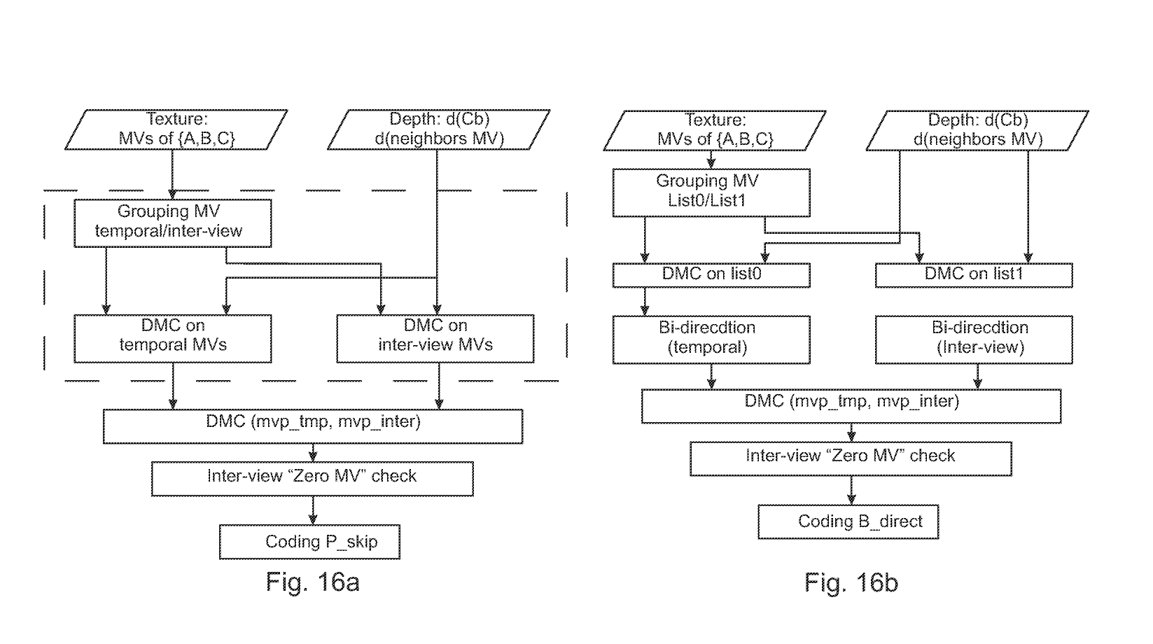

The depth-based MV competition for skip and direct modes may be described in the context of 3DV-ATM as follows. Flow charts of the process for the proposed Depth-based Motion Competition (DMC) in the Skip and Direct modes are shown in FIGS. 16a and 16b, respectively. In the Skip mode, motion vectors {mvᵢ} of texture data blocks {A, B, C} are grouped according to their prediction direction forming Group 1 and Group 2 for temporal and inter-view respectively. The DMC process, which is detailed in the grey block of FIG. 16a), may be performed for each group independently.

For each motion vector mvᵢ within a given Group, a motion-compensated depth block d(cb,mvᵢ) may be first derived, where the motion vector mvᵢ is applied relatively to the position of d(cb) to obtain the depth block from the reference depth map pointed to by mvᵢ. Then, the similarity between d(cb) and d(cb,mvᵢ) may be estimated by:

SAD(mvᵢ)=SAD(d(cb,mvᵢ),d(cb))

The mvᵢ that provides a minimal sum of absolute differences (SAD) value within a current Group may be selected as an optimal predictor for a particular direction (mvp_{dir})

$${mvp}_{dir} = arg {min}_{{mvp}_{dir}} ( SAD ( m {v}_{i } ) )$$

Following this, the predictor in the temporal direction (mvpₜₘₚ) is competed against the predictor in the inter-view direction (mvpᵢₙₜₑᵣ). The predictor which provides a minimal SAD can be gotten by:

$${mvp}_{opt} = arg {min}_{{mvp}_{dir}} ( SAD ( {mvp}_{tmp} ) , SAD ( {mvp}_{inter} ) )$$

Finally, mvpₒₚₜ which refers to another view (inter-view prediction) may undergo the following sanity check: In the case of “Zero-MV” is utilized it is replaced with a “disparity-MV” predictor mv_{y}=0 and mvₓ D̅(cb), where D̅(cb) may be derived as described above.

The MVP for the Direct mode of B slices, illustrated in FIG. 16b), may be similar to the Skip mode, but DMC (marked with grey blocks) may be performed over both reference pictures lists (List 0 and List 1) independently. Thus, for each prediction direction (temporal or inter-view) DMC produces two predictors (mvp0_{dir} and mvp1_{dir}) for List 0 and List 1, respectively. Following, the bi-direction compensated block derived from mvp0_{dir} and mvp1_{dir} may be computed as follows:

$$d ( cb , {mvp}_{dir} ) = \frac{d ( cb , mvp {0}_{dir} ) + d ( cb , mvp {1}_{dir} )}{2}$$

Then, SAD value between this bi-direction compensated block and Cb may be calculated for each direction independently and the MVP for the Direct mode may be selected from available mvpᵢₙₜₑᵣ and mvpₜₘₚ as shown above for the skip mode. Similarly to the Skip mode, “zero-MV” in each reference list may be replaced with “disparity-MV”, if mvpₒₚₜ refers to another view (inter-view prediction).

It is to be understood that while many of the coding tools have been described in the context of a particular codec, such as 3DV-ATM, they could similarly be applied to other codec structures, such as a depth-enhanced multiview video coding extension of HEVC.

For example, the motion information (motion vectors, reference indices), block partitioning information, coding/decoding modes for encoded coding units (CU), and/or entropy coding context state may be inferred and/or predicted from neighboring views of the same temporal instance, or already coded/decoded temporal instances. Such inheritance/prediction may be performed either for each CU independently, or for a group of CUs. Alternatively or in addition, inheritance/prediction may be performed for each pixel of coded CU. Alternatively or in addition, inheritance/prediction may be performed for a TU, a group of TUs, or a subset of a TU. In inheritance/prediction, disparity may be taken into account so that the source for prediction in another view is selected from a disparity-compensated position. For example, a disparity value corresponding to a selected position of the current block (e.g. top-left corner or horizontally and vertically the midmost position) or an average value may be used for disparity-compensated inference or prediction of one or more pieces of above-mentioned information. Since inherited/predicted motion information to be utilized in conventional motion-compensated prediction process, this tools can be called depth-aware motion compensated prediction (D-MCP).

Another example of a depth-aware texture coding tool is disparity compensated prediction (DCP). This tool is utilized for prediction of samples of a currently coded texture image of a current view with a disparity (spatial displacement, or spatio-temporal displacement) to a reference (already decoded) texture image in another texture view is known. This tools is very close to the motion-compensated prediction (MCP), with motion information in temporal direction are replaced by a disparity in inter-view direction.

Another example of a depth-aware texture coding tool are forms of second order predictions (D-SOP). This tool is utilized for prediction of residual information (e.g. resulted from MCP) of a currently coded texture image of a current view with a disparity (spatial displacement, or spatio-temporal displacement) from residual of a reference (already decoded) texture image in another texture view is known. The residual error in the reference view (results of prediction for a reference view) are utilized for a prediction of the residual in the currently coded view.

Inter-view residual prediction is an example of D-SOP and may be described with one or more of the following steps, which may be applied in the following order:

1. A disparity between the current texture block (being coded/decoded) and a respective block in a reference view is derived by the encoder and/or by the decoder. The derivation may be based on a depth block collocated with the current block, subject to the depth block or view component being in coding/decoding order prior to the current texture block/view component. For example, the average disparity derived from the collocated depth block or a disparity value derived from a certain sample position of the depth block may be used as the disparity. Alternatively, the derivation may be based on estimating depth for the current texture block based on another depth view component not of the same view and/or the same time instant as the current texture view component. For example, the another depth view component may be projected to the viewpoint of the current texture view using forward view synthesis. The disparity may be quantized to collocate with a coded block alignment/boundary (such as a TU boundary) in the reference view component.

2. The encoder may select a reference frame and a motion/disparity vector for the current block being coded, and encode indications of the selected reference frame and motion/disparity vector to the bitstream. The decoder may decode the indications and obtain the information on the reference frame and the motion/disparity vector. The encoder and/or the decoder may obtain a prediction block from the position pointed to by the motion/disparity vector on the reference frame.

3. A residual prediction block and related information are obtained from the reference texture view component using the derived disparity. If the disparity collocates with coded block alignment in the reference view component, the residual prediction block may be the respective coded or decoded prediction error block of the reference view component. In some embodiments, the encoder and/or the decoder derive the residual prediction block from a difference of the block pointed to by the disparity in the reference view component and a reference block associated with the block pointed to by the disparity in the reference view component. The reference block may for example by derived from the inter/inter-view/VSP reference block or blocks used to decode/reconstruct the block pointed to by the disparity. Alternatively, the reference block may for example by derived by applying the reference frame and motion/disparity vector of the current block being coded/decoded to the block pointed to by the disparity.

4. The encoder and/or the decoder may sum up the prediction block and the residual prediction block to obtain an enhanced prediction block. The encoder may derive a difference between the current texture block being coded and the enhanced prediction block. The difference block may be transform-coded, the obtained transform coefficients quantized, and the transformed and quantized difference block may be entropy-coded. The decoder may obtain the transformed, quantized, and entropy-coded difference block from a bitstream and apply entropy-decoding for it. The encoder and/or the decoder may process the transformed and quantized difference block by reconstructing of the quantization levels (i.e. dequantization), and inverse-transforming to get a decoded difference block. The encoder and/or the decoder may sum up the decoded difference block to the enhanced prediction block to obtain a decoded block.

For tools listed above, disparity information may be made available in advance as a side information, estimated as a global disparity information, decoded from a bitstream if depth/disparity data is coded before associated texture data, estimated from spatio-temporal neighborhood (region, block) of the currently coded region (block) and/or projected/synthesized from depth/disparity information available in another views or available in advance (temporal and/or spatio-temporal projection).

As described above, coded and/or decoded depth view components may be used for example for one or more of the following purposes: i) as prediction reference for other depth view components, ii) as prediction reference for texture view components for example through view synthesis prediction, iii) as input to DIBR or view synthesis process performed as post-processing for decoding or pre-processing for rendering/displaying. In many cases, a distortion in the depth map causes an impact in a view synthesis process, which may be used for view synthesis prediction and/or view synthesis done as post-processing for decoding. Thus, in many cases a depth distortion may be considered to have an indirect impact in the visual quality/fidelity of rendered views and/or in the quality/fidelity of prediction signal. Decoded depth maps themselves might not be used in applications as such, e.g. they might not be displayed for end-users. The above-mentioned properties of depth maps and their impact may be used for rate-distortion-optimized encoder control. Rate-distortion-optimized mode and parameter selection for depth pictures may be made based on the estimated or derived quality or fidelity of a synthesized view component. Moreover, the resulting rate-distortion performance of the texture view component (due to depth-based prediction and coding tools) may be taken into account in the mode and parameter selection for depth pictures. Several methods for rate-distortion optimization of depth-enhanced video coding have been presented that take into account the view synthesis fidelity. These methods may be referred to as view synthesis optimization (VSO) methods.

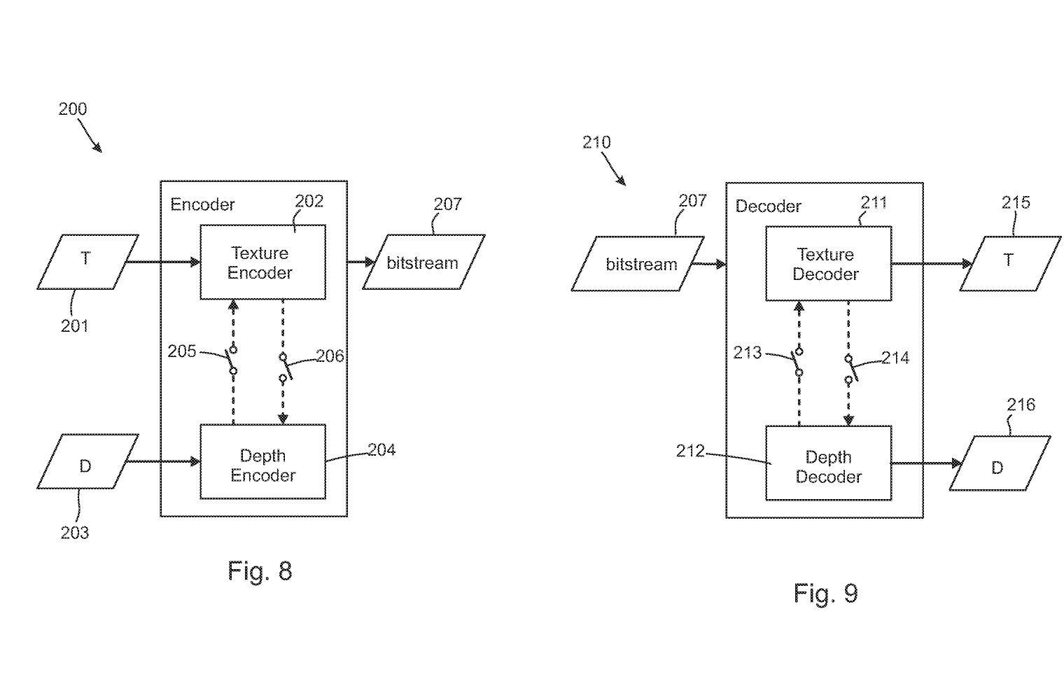

A high level flow chart of an embodiment of an encoder 200 capable of encoding texture views and depth views is presented in FIG. 8 and a decoder 210 capable of decoding texture views and depth views is presented in FIG. 9. On these figures solid lines depict general data flow and dashed lines show control information signaling. The encoder 200 may receive texture components 201 to be encoded by a texture encoder 202 and depth map components 203 to be encoded by a depth encoder 204. When the encoder 200 is encoding texture components according to AVC/MVC a first switch 205 may be switched off. When the encoder 200 is encoding enhanced texture components the first switch 205 may be switched on so that information generated by the depth encoder 204 may be provided to the texture encoder 202. The encoder of this example also comprises a second switch 206 which may be operated as follows. The second switch 206 is switched on when the encoder is encoding depth information of AVC/MVC views, and the second switch 206 is switched off when the encoder is encoding depth information of enhanced texture views. The encoder 200 may output a bitstream 207 containing encoded video information.

The decoder 210 may operate in a similar manner but at least partly in a reversed order. The decoder 210 may receive the bitstream 207 containing encoded video information. The decoder 210 comprises a texture decoder 211 for decoding texture information and a depth decoder 212 for decoding depth information. A third switch 213 may be provided to control information delivery from the depth decoder 212 to the texture decoder 211, and a fourth switch 214 may be provided to control information delivery from the texture decoder 211 to the depth decoder 212. When the decoder 210 is to decode AVC/MVC texture views the third switch 213 may be switched off and when the decoder 210 is to decode enhanced texture views the third switch 213 may be switched on. When the decoder 210 is to decode depth of AVC/MVC texture views the fourth switch 214 may be switched on and when the decoder 210 is to decode depth of enhanced texture views the fourth switch 214 may be switched off. The Decoder 210 may output reconstructed texture components 215 and reconstructed depth map components 216.

Many video encoders utilize the Lagrangian cost function to find rate-distortion optimal coding modes, for example the desired macroblock mode and associated motion vectors. This type of cost function uses a weighting factor or 2 to tie together the exact or estimated image distortion due to lossy coding methods and the exact or estimated amount of information required to represent the pixel/sample values in an image area. The Lagrangian cost function may be represented by the equation:

C=D+λR

where C is the Lagrangian cost to be minimised, D is the image distortion (for example, the mean-squared error between the pixel/sample values in original image block and in coded image block) with the mode and motion vectors currently considered, 2 is a Lagrangian coefficient and R is the number of bits needed to represent the required data to reconstruct the image block in the decoder (including the amount of data to represent the candidate motion vectors).

A coding standard may include a sub-bitstream extraction process, and such is specified for example in SVC, MVC, and HEVC. The sub-bitstream extraction process relates to converting a bitstream by removing NAL units to a sub-bitstream. The sub-bitstream still remains conforming to the standard. For example, in a draft HEVC standard, the bitstream created by excluding all VCL NAL units having a temporal_id greater than or equal to a selected value and including all other VCL NAL units remains conforming. Consequently, a picture having temporal_id equal to TID does not use any picture having a temporal_id greater than TID as inter prediction reference.

Parameter set syntax structures of other types than those presented earlier have also been proposed. In the following paragraphs, some of the proposed types of parameter sets are described.

It has been proposed that at least a subset of syntax elements that have conventionally been included in a slice header are included in a GOS (Group of Slices) parameter set by an encoder. An encoder may code a GOS parameter set as a NAL unit. GOS parameter set NAL units may be included in the bitstream together with for example coded slice NAL units, but may also be carried out-of-band as described earlier in the context of other parameter sets.

The GOS parameter set syntax structure may include an identifier, which may be used when referring to a particular GOS parameter set instance for example from a slice header or another GOS parameter set. Alternatively, the GOS parameter set syntax structure does not include an identifier but an identifier may be inferred by both the encoder and decoder for example using the bitstream order of GOS parameter set syntax structures and a pre-defined numbering scheme.

The encoder and the decoder may infer the contents or the instance of GOS parameter set from other syntax structures already encoded or decoded or present in the bitstream. For example, the slice header of the texture view component of the base view may implicitly form a GOS parameter set. The encoder and decoder may infer an identifier value for such inferred GOS parameter sets. For example, the GOS parameter set formed from the slice header of the texture view component of the base view may be inferred to have identifier value equal to 0.

A GOS parameter set may be valid within a particular access unit associated with it. For example, if a GOS parameter set syntax structure is included in the NAL unit sequence for a particular access unit, where the sequence is in decoding or bitstream order, the GOS parameter set may be valid from its appearance location until the end of the access unit. Alternatively, a GOS parameter set may be valid for many access units.

The encoder may encode many GOS parameter sets for an access unit. The encoder may determine to encode a GOS parameter set if it is known, expected, or estimated that at least a subset of syntax element values in a slice header to be coded would be the same in a subsequent slice header.

A limited numbering space may be used for the GOS parameter set identifier. For example, a fixed-length code may be used and may be interpreted as an unsigned integer value of a certain range. The encoder may use a GOS parameter set identifier value for a first GOS parameter set and subsequently for a second GOS parameter set, if the first GOS parameter set is subsequently not referred to for example by any slice header or GOS parameter set. The encoder may repeat a GOS parameter set syntax structure within the bitstream for example to achieve a better robustness against transmission errors.

Syntax elements which may be included in a GOS parameter set may be conceptually collected in sets of syntax elements. A set of syntax elements for a GOS parameter set may be formed for example on one or more of the following basis:
Syntax elements indicating a scalable layer and/or other scalability features
Syntax elements indicating a view and/or other multiview features
Syntax elements related to a particular component type, such as depth/disparity
Syntax elements related to access unit identification, decoding order and/or output order and/or other syntax elements which may stay unchanged for all slices of an access unit
Syntax elements which may stay unchanged in all slices of a view component
Syntax elements related to reference picture list modification
Syntax elements related to the reference picture set used
Syntax elements related to decoding reference picture marking
Syntax elements related to prediction weight tables for weighted prediction
Syntax elements for controlling deblocking filtering
Syntax elements for controlling adaptive loop filtering
Syntax elements for controlling sample adaptive offset
Any combination of sets above

For each syntax element set, the encoder may have one or more of the following options when coding a GOS parameter set:
The syntax element set may be coded into a GOS parameter set syntax structure, i.e. coded syntax element values of the syntax element set may be included in the GOS parameter set syntax structure.
The syntax element set may be included by reference into a GOS parameter set. The reference may be given as an identifier to another GOS parameter set. The encoder may use a different reference GOS parameter set for different syntax element sets.
The syntax element set may be indicated or inferred to be absent from the GOS parameter set.

The options from which the encoder is able to choose for a particular syntax element set when coding a GOS parameter set may depend on the type of the syntax element set. For example, a syntax element set related to scalable layers may always be present in a GOS parameter set, while the set of syntax elements which may stay unchanged in all slices of a view component may not be available for inclusion by reference but may be optionally present in the GOS parameter set and the syntax elements related to reference picture list modification may be included by reference in, included as such in, or be absent from a GOS parameter set syntax structure. The encoder may encode indications in the bitstream, for example in a GOS parameter set syntax structure, which option was used in encoding. The code table and/or entropy coding may depend on the type of the syntax element set. The decoder may use, based on the type of the syntax element set being decoded, the code table and/or entropy decoding that is matched with the code table and/or entropy encoding used by the encoder.

The encoder may have multiple means to indicate the association between a syntax element set and the GOS parameter set used as the source for the values of the syntax element set. For example, the encoder may encode a loop of syntax elements where each loop entry is encoded as syntax elements indicating a GOS parameter set identifier value used as a reference and identifying the syntax element sets copied from the reference GOP parameter set. In another example, the encoder may encode a number of syntax elements, each indicating a GOS parameter set. The last GOS parameter set in the loop containing a particular syntax element set is the reference for that syntax element set in the GOS parameter set the encoder is currently encoding into the bitstream. The decoder parses the encoded GOS parameter sets from the bitstream accordingly so as to reproduce the same GOS parameter sets as the encoder.

A header parameter set (HPS) was proposed in document JCTVC-J0109 (http://phenix.int-evry.fr/jct/doc_end_user/current_document.php?id=5972). An HPS is similar to GOS parameter set. A slice header is predicted from one or more HPSs. In other words, the values of slice header syntax elements can be selectively taken from one or more HPSs. If a picture consists of only one slice, the use of HPS is optional and a slice header can be included in the coded slice NAL unit instead. Two alternative approaches of the HPS design were proposed in JCTVC-J109: a single-AU HPS, where an HPS is applicable only to the slices within the same assess unit, and a multi-AU HPS, where an HPS may be applicable to slices in multiple access units. The two proposed approaches are similar in their syntax. The main differences between the two approaches arise from the fact that the single-AU HPS design requires transmission of an HPS for each access unit, while the multi-AU HPS design allows re-use of the same HPS across multiple AUs.

A camera parameter set (CPS) can be considered to be similar to APS, GOS parameter set, and HPS, but CPS may be intended to carry only camera parameters and view synthesis prediction parameters and potentially other parameters related to the depth views or the use of depth views.

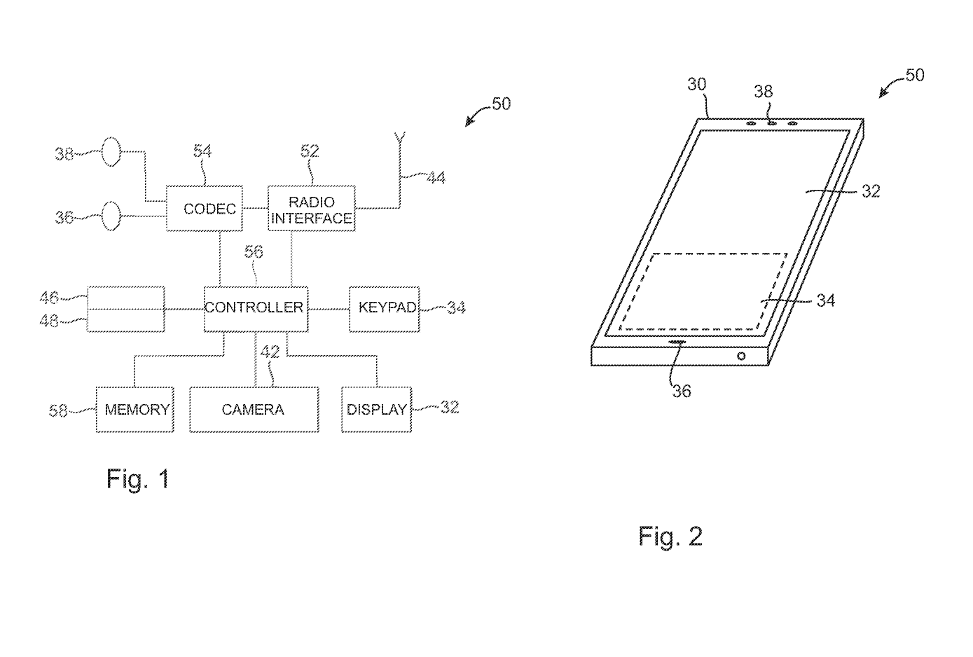

FIG. 1 shows a block diagram of a video coding system according to an example embodiment as a schematic block diagram of an exemplary apparatus or electronic device 50, which may incorporate a codec according to an embodiment of the invention. FIG. 2 shows a layout of an apparatus according to an example embodiment. The elements of FIGS. 1 and 2 will be explained next.

The electronic device 50 may for example be a mobile terminal or user equipment of a wireless communication system. However, it would be appreciated that embodiments of the invention may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise a camera 42 capable of recording or capturing images and/or video. In some embodiments the apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera capable of recording or detecting individual frames which are then passed to the codec 54 or controller for processing. In some embodiments of the invention, the apparatus may receive the video image data for processing from another device prior to transmission and/or storage. In some embodiments of the invention, the apparatus 50 may receive either wirelessly or by a wired connection the image for coding/decoding.

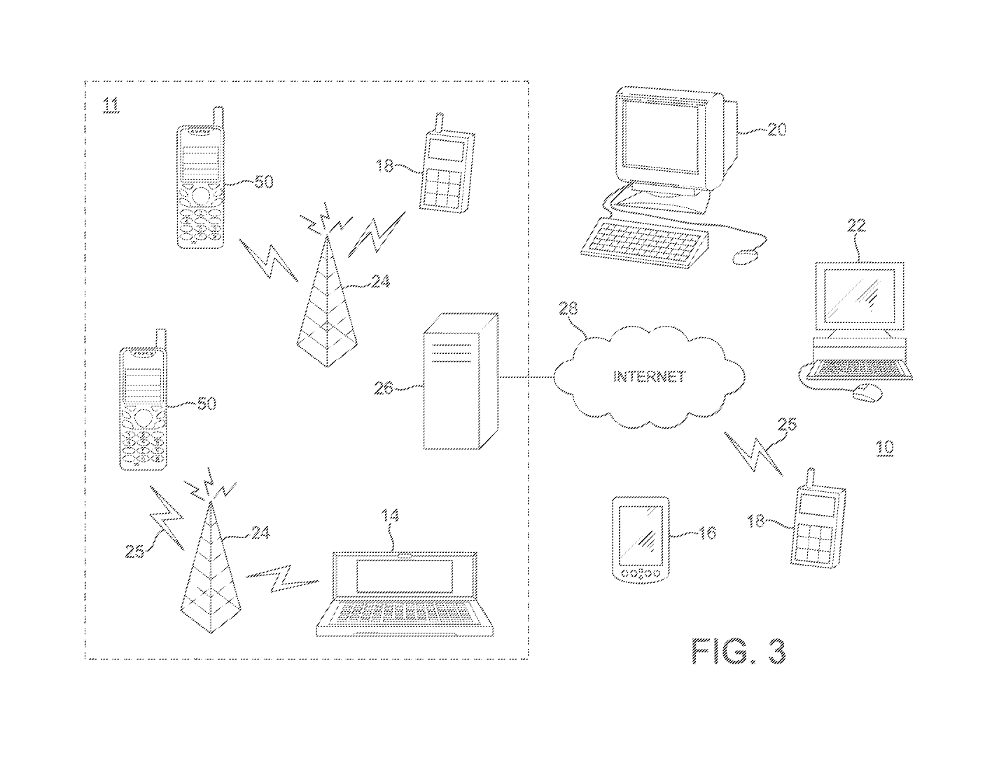

FIG. 3 shows an arrangement for video coding comprising a plurality of apparatuses, networks and network elements according to an example embodiment. With respect to FIG. 3, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention. For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatuses may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

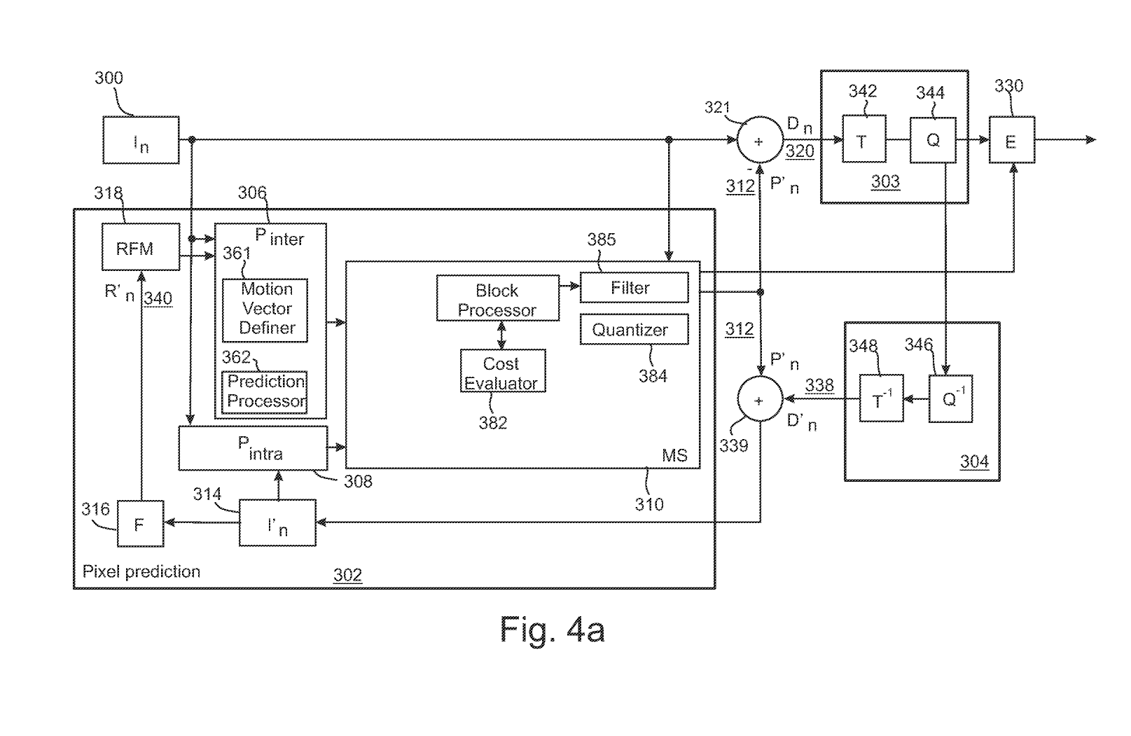

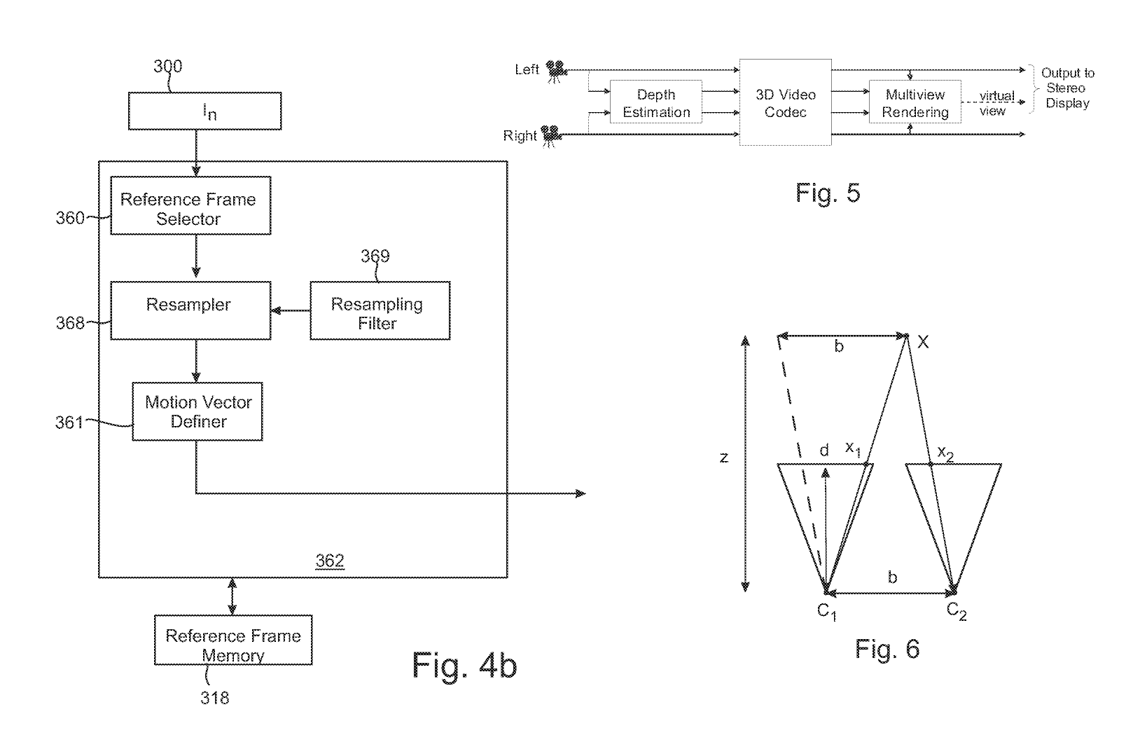

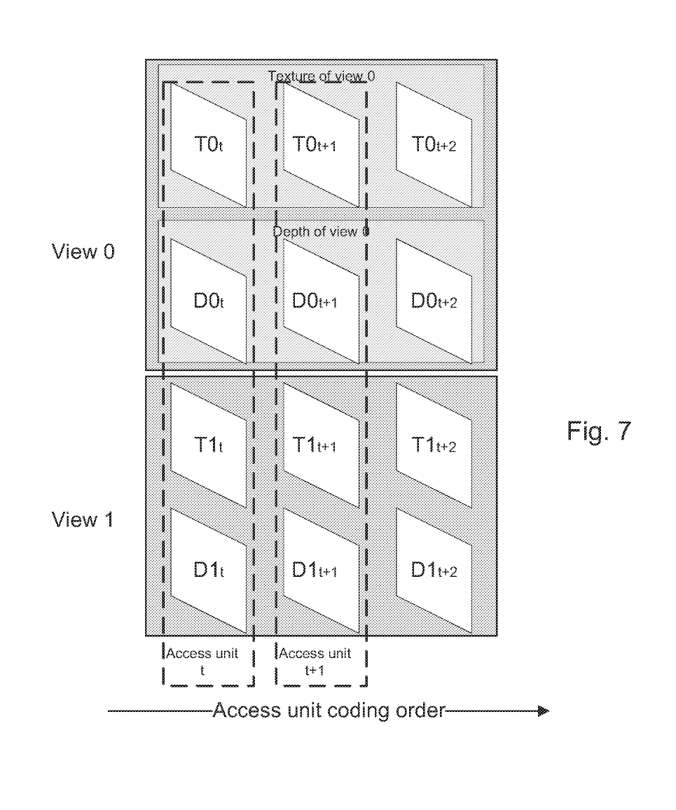

FIGS. 4a and 4b show block diagrams for video encoding and decoding according to an example embodiment.

FIG. 4a shows the encoder as comprising a pixel predictor 302, prediction error encoder 303 and prediction error decoder 304. FIG. 4a also shows an embodiment of the pixel predictor 302 as comprising an inter-predictor 306, an intra-predictor 308, a mode selector 310, a filter 316, and a reference frame memory 318. In this embodiment the mode selector 310 comprises a block processor 381 and a cost evaluator 382. The encoder may further comprise an entropy encoder 330 for entropy encoding the bit stream. A multiview encoder may be depicted by having more than one of the encoder presented in FIG. 4a, each for a different view. Inter-view prediction and/or view synthesis prediction may be enabled by having a joint reference frame memory between each encoder of FIG. 4a or having a connection between the reference frame memory 318 of the encoder presented in FIG. 4a.

FIG. 4b depicts an embodiment of the inter predictor 306. The inter predictor 306 comprises a reference frame selector 360 for selecting a reference frame or frames, and a motion vector definer 361. These elements or some of them may be part of a prediction processor 362 or they may be implemented by using other means.

When the encoder implements inter-view prediction such as predicting a non-base view from a base view (or from another reference view), the reference frame selector 360 may select a reference frame from another view than which the current block belongs, i.e. from the reference view.

The pixel predictor 302 receives the image 300 to be encoded at both the inter-predictor 306 (which determines the difference between the image and a motion compensated reference frame 318) and the intra-predictor 308 (which determines a prediction for an image block based only on the already processed parts of a current frame or picture). The output of both the inter-predictor and the intra-predictor are passed to the mode selector 310. Both the inter-predictor 306 and the intra-predictor 308 may have more than one intra-prediction modes. Hence, the inter-prediction and the intra-prediction may be performed for each mode and the predicted signal may be provided to the mode selector 310. The mode selector 310 also receives a copy of the image 300.

The mode selector 310 determines which encoding mode to use to encode the current block. If the mode selector 310 decides to use an inter-prediction mode it will pass the output of the inter-predictor 306 to the output of the mode selector 310. If the mode selector 310 decides to use an intra-prediction mode it will pass the output of one of the intra-predictor modes to the output of the mode selector 310.

The mode selector 310 may use, in the cost evaluator block 382, for example Lagrangian cost functions to choose between coding modes and their parameter values, such as motion vectors, reference indexes, and intra prediction direction, typically on block basis. This kind of cost function may use a weighting factor lambda to tie together the (exact or estimated) image distortion due to lossy coding methods and the (exact or estimated) amount of information that is required to represent the pixel values in an image area: C=D+lambda×R, where C is the Lagrangian cost to be minimized, D is the image distortion (e.g. Mean Squared Error) with the mode and their parameters, and R the number of bits needed to represent the required data to reconstruct the image block in the decoder (e.g. including the amount of data to represent the candidate motion vectors).

The output of the mode selector is passed to a first summing device 321. The first summing device may subtract the pixel predictor 302 output from the image 300 to produce a first prediction error signal 320 which is input to the prediction error encoder 303.

The pixel predictor 302 further receives from a preliminary reconstructor 339 the combination of the prediction representation of the image block 312 and the output 338 of the prediction error decoder 304. The preliminary reconstructed image 314 may be passed to the intra-predictor 308 and to a filter 316. The filter 316 receiving the preliminary representation may filter the preliminary representation and output a final reconstructed image 340 which may be saved in a reference frame memory 318. The reference frame memory 318 may be connected to the inter-predictor 306 to be used as the reference image against which the future image 300 is compared in inter-prediction operations. In many embodiments the reference frame memory 318 may be capable of storing more than one decoded picture, and one or more of them may be used by the inter-predictor 306 as reference pictures against which the future images 300 are compared in inter prediction operations. The reference frame memory 318 may in some cases be also referred to as the Decoded Picture Buffer.

The operation of the pixel predictor 302 may be configured to carry out any known pixel prediction algorithm known in the art.

The pixel predictor 302 may also comprise a filter 385 to filter the predicted values before outputting them from the pixel predictor 302.

The operation of the prediction error encoder 302 and prediction error decoder 304 will be described hereafter in further detail. In the following examples the encoder generates images in terms of 16×16 pixel macroblocks which go to form the full image or picture. However, it is noted that FIG. 4a is not limited to block size 16×16, but any block size and shape can be used generally, and likewise FIG. 4a is not limited to partitioning of a picture to macroblocks but any other picture partitioning to blocks, such as coding units, may be used. Thus, for the following examples the pixel predictor 302 outputs a series of predicted macroblocks of size 16×16 pixels and the first summing device 321 outputs a series of 16×16 pixel residual data macroblocks which may represent the difference between a first macroblock in the image 300 against a predicted macroblock (output of pixel predictor 302).

The prediction error encoder 303 comprises a transform block 342 and a quantizer 344. The transform block 342 transforms the first prediction error signal 320 to a transform domain. The transform is, for example, the DCT transform or its variant. The quantizer 344 quantizes the transform domain signal, e.g. the DCT coefficients, to form quantized coefficients.

The prediction error decoder 304 receives the output from the prediction error encoder 303 and produces a decoded prediction error signal 338 which when combined with the prediction representation of the image block 312 at the second summing device 339 produces the preliminary reconstructed image 314. The prediction error decoder may be considered to comprise a dequantizer 346, which dequantizes the quantized coefficient values, e.g. DCT coefficients, to reconstruct the transform signal approximately and an inverse transformation block 348, which performs the inverse transformation to the reconstructed transform signal wherein the output of the inverse transformation block 348 contains reconstructed block(s). The prediction error decoder may also comprise a macroblock filter (not shown) which may filter the reconstructed macroblock according to further decoded information and filter parameters.

The inter predictor 306 receives the current block for inter prediction. The inter predictor 306 may select (360) a reference frame from one or more of the following: the same view (for motion-compensated prediction a.k.a. inter prediction a.k.a. temporal prediction), a different view (for inter-view prediction), and a synthesized view (for view synthesis prediction). In the following the operation of an example embodiment of the inter predictor 306 will be described in more detail with reference to inter-view prediction.

If the resolution of the current frame is different from a reference frame of the reference view, resampling of at least a part of the reference frame may be needed. This may be performed e.g. by the resampling element 368. The resampling element 368 may implement downsampling operation, if the resolution of the current frame is smaller than the resolution of the reference frame of the reference view. The resampling element 368 may implement upsampling operation, if the resolution of the current frame is greater than the resolution of the reference frame of the reference view. The sampling element 368 may implement resampling or filtering operation, if the resolution of the current frame is equal to the resolution of the reference frame of the reference view, but the sampling grid of the current frame is different from or has a different position relative to the sampling grid of the reference frame of the reference view. The downsampling, upsampling or resampling operation may include selecting a filter 369 on the basis of the type of the sampling grid which have been used in the current (non-base) frame and the reference frame. The filter 369 produces a filtered and downsampled/upsampled/resampled representation of at least a part of the reference frame to be used in motion vector prediction by the motion vector definer 361.

The motion vector definer 361 may determine a motion vector to be coded for example on the basis of a block matching search, which may choose a motion vector pointing to a position in the downsampled/upsampled/resampled representation of at least a part of the reference frame. The block matching search may select a position which provides the smallest cost according to a cost metric, such as sum of absolute differences between luma samples of the current block and the reference block. In some embodiments, the motion vector is determined to be equal to the motion vector offset (see below) and no motion vector difference or similar is entropy-coded.

The motion vector definer 361 may further comprise motion vector prediction, which may be for example spatial motion vector prediction for which one example is given in the following. It is assumed that for the current block there already exists one or more neighboring blocks which have been encoded and motion vectors have been defined for them. For example, the block on the left side and/or the block above the current block may be such blocks. Spatial motion vector predictions for the current block can be formed e.g. by using the motion vectors of the encoded neighboring blocks and/or of non-neighbor blocks in the same slice or frame, using linear or non-linear functions of spatial motion vector predictions, using a combination of various spatial motion vector predictors with linear or non-linear operations, or by any other appropriate means that do not make use of temporal reference information. It may also be possible to obtain motion vector predictors by combining both spatial and temporal prediction information of one or more encoded blocks. These kinds of motion vector predictors may also be called as spatio-temporal motion vector predictors. As result of motion vector prediction, one motion vector predictor may be chosen for a block, such as a coding unit.

In some embodiments the motion vector definer 361 may conclude a motion vector offset, such as a vertical motion vector offset. The offset may be based on the sampling grids used in current frame and the reference frame.

In some embodiments, the motion vector definer 361 may derive a difference of the determined motion vector and the sum of the motion vector predictor and the motion vector offset. The difference may be entropy-coded (330). In some embodiments, the motion vector offset may be input to the entropy coding and used the set an initial context.

The encoder may also encode information on the one or more sampling grid to the bitstream.

Reference frames used in encoding may be stored to the reference frame memory 318. Each reference frame may be included in one or more of the reference picture lists, within a reference picture list, each entry has a reference index which identifies the reference frame. When a reference frame is no longer used as a reference frame it may be removed from the reference frame memory or marked as “unused for reference” or a non-reference frame wherein the storage location of that reference frame may be occupied for a new reference frame.

As described above, an access unit may contain slices of different component types (e.g. primary texture component, redundant texture component, auxiliary component, depth/disparity component), of different views, and of different scalable layers. A component picture may be defined as a collective term for a dependency representation, a layer representation, a texture view component, a depth view component, a depth map, or anything like. Coded component pictures may be separated from each other using a component picture delimiter NAL unit, which may also carry common syntax element values to be used for decoding of the coded slices of the component picture. An access unit can consist of a relatively large number of component pictures, such as coded texture and depth view components as well as dependency and layer representations. component picture delimiter NAL units are present in the bitstream, a component picture may be defined as a component picture delimiter NAL unit and the subsequent coded slice NAL units until the end of the access unit or until the next component picture delimiter NAL unit, exclusive, whichever is earlier in decoding order.

A term mixed spatial representation may be defined to indicate a difference in spatial resolution and/or in spatial sample grid between two or more view components. The two or more view components may be of different views and/or they may represent different time instances of a video signal or different type of video signal (e.g texture or depth).

A difference in spatial resolution may be defined in one or more of the following ways:

Dimensions (bwidth×bheight) of a sampling grid of a texture view component may be an integer multiple of dimensions (nwidth×nheight) of a sampling grid of another texture view component, i.e. bwidth=m×nwidth and bheight=n×nheight, where m and n are positive integers and either m≠1 or n≠1.

nwidth=m×bwidth and nheight=n×bheight, where m and n are positive integers and either m≠1 or n≠1.

bwidth=m×nwidth and bheight=n×nheight or alternatively nwidth=m×bwidth and nheight=n×bheight, where m and n are positive values and may be non-integer and either m≠1 or n≠1.

A difference in a spatial sample grid may be defined as follows: The vertical position of a texture view component may have an offset relative to the vertical sampling grid position of another texture view component. In other words, a sample (e.g. a luma sample) on the top sample row of a sampling grid of one texture view component may correspond to a sample row at a vertical position y in the sampling grid of another texture view component, where y is a non-negative value e.g. in a two-dimensional Cartesian coordinate system with non-negative values only and the origo in the top-left corner. In some embodiments, the values of y may be integer. In some embodiments, the sampling grid of a first texture view component may be considered to be identical to the sampling grid of a second texture view component, but the vertical sampling position of the first sampling grid may be chosen to be different than that of the second sampling grid, which in different embodiments may be handled identically or similarly to the case the vertical sampling grid position being different. For example, in the first view component odd sample lines of a sampling grid may be included and in the second view component even sample lines of the sampling grid may be included as illustrated in FIGS. 18a and 18b, which may be referred to as an interlaced sampling arrangement. FIGS. 18c and 18d illustrate another example of a sampling grid, which may be referred to as a quincunx sampling arrangement. Reducing the vertical resolution of a sampling grid may be done for example by low-pass filtering and sub-sampling or by decimation.

In some embodiments, a difference in spatial sample grid may additionally or alternatively include a different sample spacing. Sample spacing may be indicated by the encoder for example using the following syntax for example within VUI:

| | |
|---|---|
| vui_parameters( ) { | Descriptor |

| | |
|---|---|
| . . . | |
| luma_sample_spacing_present_flag | u(1) |
| if( luma_sample_spacing_present_flag ) { | |

| | |
|---|---|
| luma_sample_spacing_x | ue(v) |
| luma_sample_spacing_y | ue(v) |

}
. . .

}

The semantics of the presented syntax elements may be defined as follows: luma_sample_spacing_present_flag equal to 1 specifies that luma_sample_spacing_x and luma_sample_spacing_y are present. luma_sample_spacing_present_flag equal to 0 specifies that luma_sample_spacing_x and luma_sample_spacing_y are not present. luma_sample_spacing_×specifies the horizontal distance between samples. Let s1 be any decoded luma sample not on the border of the picture and s2 the decoded luma sample adjacent and on the right from s1. luma_sample_spacing_x is the distance from the right edge of s1 to the left edge of s2 on the luma sampling grid for two-dimensional displaying in units of 1/16^{th} of the luma sample width. If luma_sample_spacing_x is not present, it may be inferred to be equal to 0. luma_sample_spacing_y specifies the vertical distance between samples. Let s1 be any decoded luma sample not on the border of the picture and s2 the decoded luma sample adjacent and below s1. luma_sample_spacing_y is the distance from the bottom edge of s1 to the top edge of s2 on the luma sampling grid for two-dimensional displaying in units of 1/16^{th} of the luma sample height. If luma_sample_spacing_y is not present, it may be inferred to be equal to 0.

In some embodiments, an indicated sample aspect ratio may be equivalent to sample spacing and may be used instead of or in addition to the sample spacing in various embodiments. The sample aspect ratio may be indicated by the encoder for example within VUI.

In some embodiments, sample spacing can vary within a single image of view components (e.g. non-uniform sampling).

In some embodiments, a resolution of a predicted texture image is not equal to a resolution of a reference image, thus a current and/or a reference image undergo resolution modification in order to enable current image prediction, joint processing and/or coding.

In some embodiments, a spatial sample grid of a predicted texture image is not identical to a sample resolution of a reference image, thus a current and/or a reference image undergo sample grid modification in order to enable current image prediction, joint processing and/or coding.

In some embodiments, a sample grid need not be rectangular, but for example quincunx sampling as illustrated in FIG. 18c and/or FIG. 18d may be used. The reference image or block may be resampled to have a rectangular sample grid. If the current image being coded/decoded is also represented with a non-rectangular grid, the interpolation filter applied for motion/disparity compensated prediction from the resampled reference image/block may be modified to obtain interpolated samples according to the non-rectangular grid of the current image being coded/decoded or the resampled reference image/block may be decimated according to the non-rectangular grid of the current image being coded/decoded. For example, if both the reference view component for inter-view prediction and the current view component being coded/decoded are quincunx-sampled, the reference view component may first be resampled so that the resampled reference view component has a sample value for each position on a rectangular grid. Then, the encoder may estimate a disparity motion vector for a block in the current view component by including samples according to the quincunx-sampling pattern of the current view component in the candidate prediction blocks extracted from the resampled reference view component. Similarly, as response to a decoding a motion/disparity vector, the decoder may select samples pointed to by a motion/disparity vector according to the quincunx-sampling pattern of the current view component from the resampled reference view component.

In some embodiments, the encoder and/or the decoder may modify the spatial representation of a reconstructed/decoded reference view component in multiview or a multiview-plus-depth coding/decoding system processing a multiview bitstream or signal with mixed spatial resolution for example to align (vertically) and/or normalize the spatial resolution of a reference view component and a view component being coded/decoded. Vertical alignment and/or spatial resolution normalization (e.g. to be equal between the two view components or an integer multiple between the two view component) may be done for example for inter prediction, inter-view prediction, view synthesis prediction, and/or depth-based texture coding methods, such as depth/disparity aware Motion Compensated Prediction (D-MCP), Disparity Compensated Prediction (DCP), depth/disparity ware Motion Vector Prediction (D-MVP) and depth-aware second-order prediction (D-SOP)

The encoder and/or the decoder may include one or more of the following steps to modify the spatial representation of a reconstructed/decoded reference view component, which may be performed in the following order. In the following, the reconstructed/decoded reference view component is assumed to have sampling at integer-pixel positions.
1. Interpolation at the reference resolution. An interpolation filter (such as the interpolation filter for inter prediction) may be applied to obtain an interpolated reference view component. Encoder implementations may produce interpolated reference view component as a part of a conventional operation, as motion estimation may be implemented using interpolated reference view components. The interpolated reference view component may be sampled for example at quarter-pixel positions, i.e. have a vertical and horizontal sample counts that is four times greater than those of the reconstructed/decoded reference view component. In some implementations, the interpolated reference view component may be stored as multiple sample arrays, for example one sample array per each sampling grid offset, while e.g. full-pixel sample separation/spacing may be used in each sample array.
2. Resampling to a target resolution. The reconstructed/decoded reference view component or the interpolated reference view component may be resampled to a selected resolution. The resampled picture may be referred to as the resampled reference view component. If this step is omitted, the resampled reference view component may be considered to the same as the interpolated reference view component or the reference view component in subsequent processing steps.
3. Interpolation at the target resolution. When a motion vector for inter prediction, and/or a motion/disparity vector for inter-view prediction and/or a disparity vector for VSP points to a sample location that is not represented by the resampled reference view component, an interpolation filter may be applied to obtain these sample locations.

In some embodiments, the encoder indicates in the bitstream, for example using one or more syntax elements in a video parameter set or a sequence parameter set, whether one or more of the above-mentioned steps have been used in encoding. In some embodiments, the decoder receives and decodes the indications, such as one or more syntax elements in a video parameter set or a sequence parameter set, from the bitstream whether one or more of the above-mentioned steps have been used in encoding and/or shall be used in decoding.

In some embodiments, the encoder and/or the decoder may perform two or more of the above-mentioned steps as one operation, i.e. combine different filtering and/or interpolation and/or resampling steps as one.

With reference to step 1 above, in some embodiments, an interpolation filter that is used may be the interpolation filter used for the inter prediction process.

Some embodiments related to step 2 above are described next.

The encoder and/or the decoder may select a vertical and horizontal resolution for a resampled reference view component on the basis of the vertical and horizontal resolution of the current view component.

In some embodiments, the encoder and/or the decoder may resample the reference view component or the interpolated reference view component to have an equal resolution in the resampled reference view component compared to the resolution of the current view component. In some embodiments, the encoder and/or the decoder may resample the reference view component or the interpolated reference view component to have a vertical and horizontal resolution in the resampled reference view component that are an equal multiple compared to the vertical and horizontal resolutions of the current view component. In some embodiments, resampling may include a low-pass filtering operation.

In some embodiments, the decoder receives and decodes from the bitstream information about a vertical sampling grid position of a reference view component and a vertical sampling grid position of a view being decoded.

In some embodiments, the encoder/decoder selects a resampling filter on the basis of a vertical sampling grid position of a reference view component and a vertical sampling grid position of a current view component (which is being encoded/decoded and uses the reference view component for inter-view prediction and/or view synthesis prediction). In some embodiments, the encoder/decoder selects a resampling filter on the basis of a vertical sampling grid position of an interpolated reference view component and a vertical sampling grid position of a current view component.

Filter with special phase design can be used to reflect a difference in spatial representation between a currently coded image and a reference, e.g. in an interlaced sampling arrangement, for example considering one or more of the following:
Filter with special pulse response design that takes into consideration specified frequency response properties such as cut-off frequency (e.g. 0.8 or 0.9 of normalized frequency), attenuation level on the specified lobe or can have a special form of pulse response—Dirac's delta function, which followed by a resampling procedure effectively produces a decimation.
Filter with adaptive pulse response can be used to reflect difference in spatial representation between a currently coded image and a reference. Parameters of adaptive filters can be signaled as a side information and/or derived by a processing system (e.g. a decoder) as well as parameters of the filter can be known in advance at the decoder, and filter identification can be signed as a side information.
Filters can be designed to match the filter utilized for production of the reference image
Filters can be designed to match the filter utilized for production of the currently coded image.
Filter can be designed to minimize errors resulting of D-MCP, DCP, D-MVP, VSP of the current image from the reference image or other depth-aware texture coding tools.
Filters can be designed to take into consideration parameters of D-MCP, DCP, D-MVP, VSP or other depth-aware texture coding tools through a dedicated control scheme, an example of such control is a variant of View Synthesis Optimization widely utilized in 3DV coding systems.
Filters designed to take into consideration statistical properties of depth/disparity images associated with current and/or reference texture images.
Filters designed to take into consideration properties of spectrums in Fourier and/or sine/cosine transforms of current and/or reference texture images and/or depth/disparity images associated with current and/or reference texture images.

In some embodiments, lookup tables can be utilized to perform representation modification between a currently coded image and a reference image. The design of lookup tables can take into consideration one or more of the following:
parameters of spatial representation of the current and/or the reference image, such as the resolution and/or sample grid;
spatial (inter-view prediction) and/or temporal distance between the currently coded and/or the reference image;
the reference index identifying the reference image.

The encoder/decoder may use the selected resampling filter to derive one or more prediction blocks for inter-view prediction and/or view synthesis prediction.

For inter-view prediction of non-base-view pictures from the base-view pictures, the inter-view reference pictures of the currently coded/decoded non-base view pictures may be resampled to a selected resolution. In some embodiments, the resampling may also match the sampling grid position of the resampled image to that of the non-base view.

With reference to step 3 above, if the resampled reference view component has the same resolution as the current view component, a conventional motion interpolation filter may be used. If the resampled reference view component has a different resolution than the current view component, then a modified motion interpolation filter may be used. For example, if the resampled reference view component has twice the sample count both horizontally and vertically compared to the respective sample counts of the current view component and quarter-pixel precision is used in motion/disparity vectors, the reference view component may be for example bilinearly upsampled.

With reference to step 3 above, in some embodiments, if the vertical or horizontal resolution of the resampled reference view component is an integer multiple (e.g. twice or four times) of the vertical or horizontal (respectively) resolution of the current view component, the encoder and/or the decoder may omit interpolation of the resampled reference view component vertically or horizontally, respectively. If the inverse of the motion/disparity vector precision is an integer multiple of the ratio of horizontal or vertical resolution between the current view component and the resampled reference view component, interpolation filtering may be omitted or simplified. For example, if motion/disparity vectors are coded or derived at a quarter-pixel precision and the resolution of a resampled reference view component is twice the resolution of the current view component, the interpolation of the resampled reference view component may be omitted. The resampled reference view component may be regarded to be presented in an interpolated form and prediction blocks may be obtained by decimation. Continuing the same example, the resampled reference view component may be considered to provide all sample values for motion/disparity vectors that point either to full-pixel or half-pixel positions already, and hence interpolation is needed only in case motion/disparity vectors point to a quarter-pixel position.

In some embodiments, current image prediction, joint processing and/or coding can be performed without a representation modification to a current and/or reference image. Instead, a spatial representation modification can be performed locally at the block level or at the pixel level.

In some embodiments, inter-view motion vectors and/or view synthesis prediction may be constrained and one or more of the above-mentioned interpolation and resampling steps can be done in a sliding window manner, e.g. one resampled macroblock row can be added into the bottom of the sliding window when the top-most macroblock row of the sliding window is removed.

In some embodiments, one or more of the above-mentioned interpolation and/or resampling steps may be done on block basis instead of or in addition to performing them on view component basis. In other words, one or more of the interpolation and resampling steps may be done for example only to derive an inter-view prediction block or a view synthesis prediction block.

In some embodiments, one or more of the above-mentioned interpolation and/or resampling steps may be performed by the encoder and/or the decoder for a reference view component or a reference block that is a synthesized reference view component or block, derived for example using a view synthesis prediction process. In some embodiments, one or more of the above-mentioned interpolation and/or resampling steps may be performed by the encoder and/or the decoder for a reference view component or a reference block that is provided as input to a view synthesis prediction process.

In some embodiments, one or more of the above-mentioned interpolation and/or resampling steps may be performed by the encoder and/or the decoder to modify the spatial representation of a reconstructed/decoded reference depth view component. In some embodiments, the current block or view component being coded/decoded is a depth block or a depth view component. In some embodiments, one or more of the above-mentioned interpolation and/or resampling steps may be performed to respond to a difference in spatial representation, such as a different sampling grid, of the current depth view component and the reference depth view component. In some embodiments, a resampled depth view component may be used as input for a depth coding or filtering process, such as JVDF or anything alike. A filtered depth view component may be resampled according to the sampling grid of the depth view component given as input to the filtering process and may be then stored or marked as used for reference for other depth view component.

In some embodiments, one or more of the above-mentioned interpolation and/or resampling steps may be performed for a residual of a predicted view component or a residual block for a predicted block or a residual prediction block for inter-view residual prediction instead of or in addition to a reconstructed/decoded reference view component or a reconstructed/decoded block. It may be considered that the sample array of a residual image or block is interpolated and/or resampled in order to use the interpolated and/or resampled residual information for prediction of the residual information of the current view component or block being encoded/decoded.

If resampling is used only for inter-view prediction, a resampled inter-view reference picture can be removed (e.g. from the DPB) when it is no longer needed for inter-view reference. Similarly, if resampling is used only for view synthesis prediction, a resampled view synthesis reference picture can be removed (e.g. from the DPB) when it is no longer needed for view synthesis reference. Similarly, if resampling may be used for both inter-view prediction and view synthesis prediction but is not used for other types of prediction, the resampled reference view component may be removed (e.g. from the DPB) when it is no longer needed for either inter-view prediction reference or view synthesis prediction reference.

In some embodiments, the encoder and/or the decoder may conclude that a depth view component is not aligned or rectified with the texture view component of the same view or that a different sampling grid has been used for the depth view component than for the texture view component of the same view. The encoder and/or the decoder may apply an alignment or rectification process to both or either of the view components and/or to resample one or both of the depth view component and the texture view component. As result, the encoder and/or the decoder may obtain an aligned depth view component and/or an aligned texture view component of the same view, in which the same sampling grid has been used. The encoder and/or the decoder may subsequently use the aligned depth view component and/or the aligned texture view component in inter-component coding/decoding/prediction methods, which may be depth-based texture coding/decoding/prediction methods and/or texture-based depth coding/decoding/prediction methods. For example, the encoder and/or the decoder may use depth-based texture coding/decoding tools, in which a decoded/reconstructed depth view component is aligned to have the same sampling grid as a texture view component. Sample values of and/or variable derived from the aligned depth view component may then be used in inter-component coding/decoding/prediction. For example, the aligned depth view component may be used as input into a forward VSP process and/or a backward VSP process and/or any other type of VSP process, and/or a depth-based motion vector prediction process, and/or an inter-view residual prediction process, and/or anything alike.

In some embodiments, the encoder/decoder concludes that a vertical sampling grid position of a reference view component differs from that of the current view component but that the vertical sample count of the two view components is the same. The encoder may apply the inter coding and motion vector coding process for a motion vector from which the vertical offset corresponding to the difference of the vertical sampling grid positions has been compensated/removed. The decoder may modify the motion vector prediction scheme in such a manner that a constant vertical offset corresponding to the difference of the vertical sampling grid positions is added to a predicted motion vector or to a derived motion vector prior to its use in motion compensation. The encoder may indicate the vertical sampling grid position of a view component for example in a picture parameter set or a sequence parameter set that is active for a particular view, and the vertical sampling grid position may be indicated for example relative to the vertical sampling grid position of the base view. The decoder may conclude the constant vertical offset for motion vector prediction from the vertical sampling grid position(s) decoded from the bitstream. Alternatively or in addition, the encoder may indicate the vertical motion offset in the bitstream, for example in a picture parameter set or a sequence parameter set, and the decoder may decode the vertical motion offset from the bitstream and use it in the inter prediction process to derive a vertical motion vector component.

In some embodiments, the encoder/decoder concludes that a vertical sampling grid position of a reference view component differs from that of the current view component but that the vertical sample count of the two view components is the same as mentioned in the previous paragraph. The encoder/decoder may select an initial context for motion vector difference coding in such a manner that the initial context matches the difference in vertical sampling grid position.

In some embodiments, the encoder omits the vertical motion vector difference coding in inter-view prediction and/or view synthesis prediction and/or inter-component motion prediction, i.e. syntax elements related to the vertical motion vector difference are not coded into the bitstream. Instead the encoder/decoder derive a vertical motion vector component to be equal to a vertical offset derived from the difference of the vertical sampling grid position between the current and reference view components or the vertical motion offset indicated by the encoder in the bitstream as described above.

In some embodiments, the encoder and/or the decoder may use the vertical motion offset when accessing a residual of a predicted view component or a residual block for a predicted block. The vertical motion offset, when having a non-integer value in full sample units, may be used for example to interpolate the residual prior to using the residual for prediction of the residual information of the current view component or block being encoded/decoded.

In some embodiments, both the reconstructed/decoded base-view pictures and the reconstructed/decoded non-base-view pictures may be resampled to a common resolution, for example to a so-called full resolution. The resampled pictures may be used both as inter prediction references and inter-view prediction references. The prediction error may be coded using the images at a different resolution than that the common resolution, such as downsampled input images. The reconstructed or decoded prediction error is first resampled to the common resolution used for reference pictures and then added to the prediction signal, such as inter prediction block, inter-view prediction block or intra prediction block. In some embodiments, the resampling operations may also take the sampling grid position into account. In a general case, the common resolution may be either smaller or greater than the resolution of the left-view image or the right-view image.

In some embodiments, the depth image associated with the currently coded/decoded texture image can be represented with a spatial representation which is not equal to the spatial representation of an associated texture image. Thus, the depth/disparity image of a current and/or reference image may undergo representation modification in order to enable current image prediction, joint processing and/or coding.

In some embodiments of coding systems with mixed spatial representation, a decision making process of the encoder and the decoder can be implemented as follows: Motion information (motion block partitioning, coding modes, motion vectors) of reference image that is utilized for coding/decoding of the current image data can undergo transformation in the case if spatial representation of a reference image is different from spatial representation of the current image. Non-limiting examples of such transformation may include:
Scaling of block partitioning information (block_width_resulting=block_width/alpha, block_height_resulting=block_height/beta), where is alpha=width_reference/width_current, height_reference/height_current,
Scaling of motion vector information (mvx_resulting=mvx/alpha, mvy_resulting==mvy/beta)
Introducing global multiplication factor and additive offset to either of motion vector components to reflect differences in spatial representation, such as the sampling grids, if such scaling and offset are able to compensate the differences in the sample grid.
Non-linear modification of motion vector components that takes into consideration differences in spatial representation and/or motion information of spatial/temporal/inter-view collocated or neighboring blocks. Non-limiting examples of such modification can include changing the number of motion candidates in a motion candidate list, participating in finding median/minimal/maximal/average values among available motion information candidates.

In some embodiments, the encoder can perform selection of a motion vector for example in a rate distortion optimization manner or view synthesis based optimization manner among a candidate list that may be derived as described above. The encoder may apply the selected motion vector for coding of samples of the current image and transmit the index of the selected motion candidate to the decoder side as a side information.

In some embodiments, a decision making process for selection of a motion vector among a candidate list can take into consideration depth/disparity information associated with reference and/or currently coded texture image. In the case of mixed spatial representation of texture information, depth/disparity information can undergo geometrical transformation (scaling, resizing, decimation, subsampling, warping, incrementing an offset value computed globally over the current and/reference image or locally for a currently coded/processing block.

In some embodiments, a decision making process can utilize non-linear modification of available depth/disparity information. Non-limiting examples of such modification can include changing the number of depth/disparity samples utilizing in a decision making process at the encoder and/or the decoder side, participating in finding median/minimal/maximal/average values among available depth/disparity samples.

In some embodiments, the encoder indicates properties of depth views and/or texture views in the bitstream, such as properties related to used sensor, optical arrangement, capturing conditions, camera settings, and used representation format such as resolution. The indicated properties may be specific for an indicated depth view or a texture view or may be shared among many indicated depth views and/or texture views. For example, the properties may include but are not limited to one or more of the following:
spatial resolution e.g. in terms of horizontal and vertical sample counts in the view components;
bit-depth and/or dynamic range of the samples;
focal length which may be separated to a horizontal and vertical component;
principal point which may be separated to a horizontal and vertical component;
extrinsic camera/sensor parameters such as a translation matrix of the camera/sensor position;
a relative vertical position of a sampling grid of a texture view with respect to that of another texture view;
a relative position of a sampling grid of a depth view component with respect to a texture view component, e.g. the horizontal and vertical coordinate within a luma picture corresponding to the top-left sample in the sampling grid of a depth view component, or vice versa;
a relative horizontal and/or vertical sample aspect ratio of a depth sample with respect to a luma or a chroma sample of a texture view component;
a horizontal and/or vertical sample spacing for texture view component and/or depth view component, which may be used to indicate a sub-sampling scheme (potentially without preceding low-pass filtering).

It should be understood that many embodiments of the invention are also applicable to coding and decoding scenarios where frame packing is applied. Different types of frame packing may be applied, such as packing of two or more texture view components into a single frame, and/or packing of two or more depth view components into a single frame, and/or packing of one or more texture view components and one or more depth view components into a single frame. The encoder may code and include different indications as described above and additionally indicate the views or view components to which the indications apply for example by using appropriate nesting SEI messages or by associating a component type (e.g. texture or depth) and/or a view identifier to constituent frames by other means, such as including an identifier of a constituent frame into syntax structures that are used for indicating properties of texture and depth views. A nesting SEI message may for example indicate whether the nested SEI messages apply to texture views or depth views or both, and/or indicate which views (e.g. view identifiers or view order indexes) the nested SEI messages, and/or indicate which constituent frames the nested SEI messages apply to.

In the above, embodiments have been described through terms sample grid and sampling grid, which are equivalent terms in the description of the embodiments.

In the above, some embodiments have been described in relation to one or more sampling grids. It needs to be understood that many embodiments have been described with an assumption that the sampling grid contains only such sampling positions (e.g. intersection in the sampling grid) for which there is a sample corresponding to each sampling position. However, it should be clear for a skilled person that embodiments can be applied similarly when one or more sampling grids are used in a manner that some sampling positions are omitted, i.e. there is at least one sampling position for which there is no corresponding sample. For example, a sampling grid of a first view component may be applied in a manner that only even lines of sampling positions are used for samples (and odd lines are omitted), while the same or similar sampling grid may be applied in a manner that only odd lines of sampling positions are used for samples (and even lines are omitted). In this example, the vertical sampling grid position of the first view component may be considered to differ from the vertical sampling grid position of the second view component.

In the above, some embodiments have been described in relation to one or more sampling grids. It needs to be understood that many embodiments could similarly be described by referring to e.g. a spatial representation instead of a sampling grid. The term spatial representation may be understood more generally than the term sampling grid. Spatial representation of a picture may be considered to include for example the phase of the filter that was used to downsample the picture from a larger-resolution picture. Consequently, for example when a difference in sampling grids is referred to in some embodiments, embodiments could likewise be described by referring to a difference in spatial representation, such as a differing phase of a downsampling filter used in deriving the respective picture(s).

In the above, some embodiments have been described in relation to particular types of parameter sets. It needs to be understood, however, that embodiments could be realized with any type of parameter set or other syntax structure in the bitstream.

In the above, some embodiments have been described in relation to encoding indications, syntax elements, and/or syntax structures into a bitstream or into a coded video sequence and/or decoding indications, syntax elements, and/or syntax structures from a bitstream or from a coded video sequence. It needs to be understood, however, that embodiments could be realized when encoding indications, syntax elements, and/or syntax structures into a syntax structure or a data unit that is external from a bitstream or a coded video sequence comprising video coding layer data, such as coded slices, and/or decoding indications, syntax elements, and/or syntax structures from a syntax structure or a data unit that is external from a bitstream or a coded video sequence comprising video coding layer data, such as coded slices. For example, in some embodiments, an indication according to any embodiment above may be coded into a video parameter set or a sequence parameter set, which is conveyed externally from a coded video sequence for example using a control protocol, such as SDP. Continuing the same example, a receiver may obtain the video parameter set or the sequence parameter set, for example using the control protocol, and provide the video parameter set or the sequence parameter set for decoding.

In the above, some embodiments have been described in relation to coding/decoding methods or tools for inter prediction, inter-view prediction, view synthesis prediction, and/or depth-based texture coding. It needs to be understood that embodiments may not be specific to the described coding/decoding and/or prediction methods but could be realized with any similar coding/decoding and/or prediction methods or tools.

In the above, the example embodiments have been described with the help of syntax of the bitstream. It needs to be understood, however, that the corresponding structure and/or computer program may reside at the encoder for generating the bitstream and/or at the decoder for decoding the bitstream. Likewise, where the example embodiments have been described with reference to an encoder, it needs to be understood that the resulting bitstream and the decoder have corresponding elements in them. Likewise, where the example embodiments have been described with reference to a decoder, it needs to be understood that the encoder has structure and/or computer program for generating the bitstream to be decoded by the decoder.

Although the above examples describe embodiments of the invention operating within a codec within an electronic device, it would be appreciated that the invention as described below may be implemented as part of any video codec. Thus, for example, embodiments of the invention may be implemented in a video codec which may implement video coding over fixed or wired communication paths.

Thus, user equipment may comprise a video codec such as those described in embodiments of the invention above. It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatuses, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The various embodiments of the invention can be implemented with the help of computer program code that resides in a memory and causes the relevant apparatuses to carry out the invention. For example, a terminal device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys Inc., of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

In the following some examples will be provided.

According to a first example there is provided a method comprising:

obtaining information on a sampling grid of a current view component;

obtaining information on a sampling grid of a reference view component;

using the obtained information to select one or more resampling filter parameters for filtering at least a part of the reference view component to be used in one or more of inter-view prediction and view synthesis prediction of the current view component.

In some embodiments the method comprises:

obtaining information on a vertical sampling grid position of the reference view component;

obtaining information on a vertical sampling grid position of the current view component;

using the obtained information to select one or more resampling filter parameters for filtering the reference view component to be used in one or more of inter-view prediction and view synthesis prediction of the current view component.

In some embodiments the method comprises:

providing an indication of the vertical sampling grid position of the reference view component in a bitstream.

In some embodiments the method comprises:

providing an indication of the vertical sampling grid position of the current view component in a bitstream.

According to a second example there is provided a method comprising:

obtaining information on a vertical sampling grid position of a reference view component;

obtaining information on a vertical sampling grid position of the current view component;

determining the difference between the vertical sampling grid position of the reference view component and the vertical sampling grid position of the current view component;

using the difference to compensate a motion vector offset to be used in one or more of inter-view prediction and view synthesis prediction of the current view component.

In some embodiments the method comprises:

providing an indication of the motion vector offset in a bitstream.

In some embodiments the method comprises:

providing the indication indicative of the vertical sampling grid position of the current view component relative to the vertical sampling grid position of the reference view.

In some embodiments the method comprises:

providing the indication indicative of the vertical sampling grid position in a picture parameter set, or in a sequence parameter set.

In some embodiments the method comprises:

concluding that the vertical sampling grid position of the reference view component differs from the vertical sampling grid position of the current view component;

wherein the method further comprises selecting an initial context for adaptive entropy coding of motion vector difference in such a manner that the initial context matches the difference in vertical sampling grid position.

In some embodiments the method comprises:

omitting the vertical motion vector difference coding in inter-view prediction and/or view synthesis prediction and/or inter-component motion prediction; and

deriving a vertical motion vector component to be equal to a vertical offset derived from the difference of the vertical sampling grid position between the current view component and the reference view component.

In some embodiments the method comprises:

using the vertical motion offset when accessing a residual of a predicted view component or a residual block for a predicted block.

In some embodiments the method comprises:

using the vertical motion offset, when the vertical motion offset has a non-integer value in full sample units, to interpolate a residual prior to using the residual for prediction of the residual information of the current view component or a block being encoded.

In some embodiments the method comprises:

resampling both the reference view component and the current view component to obtain a common resolution for both the reference view component and the current view component.

According to a third example there is provided an apparatus comprising at least one processor and at least one memory including computer program code, the at least one memory and the computer program code configured to, with the at least one processor, cause the apparatus to:

obtain information on a sampling grid of a current view component;

obtain information on a sampling grid of a reference view component;

use the obtained information to select one or more resampling filter parameters for filtering at least a part of the reference view component to be used in one or more of inter-view prediction and view synthesis prediction of the current view component.

In some embodiments of the apparatus said at least one memory stored with code thereon, which when executed by said at least one processor, further causes the apparatus to:

obtain information on a vertical sampling grid position of the reference view component;

obtain information on a vertical sampling grid position of the current view component;

use the obtained information to select one or more resampling filter parameters for filtering the reference view component to be used in one or more of inter-view prediction and view synthesis prediction of the current view component.

In some embodiments of the apparatus said at least one memory stored with code thereon, which when executed by said at least one processor, further causes the apparatus to:

provide an indication of the vertical sampling grid position of the reference view component in a bitstream.

In some embodiments of the apparatus said at least one memory stored with code thereon, which when executed by said at least one processor, further causes the apparatus to:

provide an indication of the vertical sampling grid position of the current view component in a bitstream.

According to a fourth example there is provided an apparatus comprising at least one processor and at least one memory including computer program code, the at least one memory and the computer program code configured to, with the at least one processor, cause the apparatus to:

obtain information on a vertical sampling grid position of a reference view component;

obtain information on a vertical sampling grid position of the current view component;

determine the difference between the vertical sampling grid position of the reference view component and the vertical sampling grid position of the current view component;

use the difference to compensate a motion vector offset to be used in one or more of inter-view prediction and view synthesis prediction of the current view component.

In some embodiments of the apparatus said at least one memory stored with code thereon, which when executed by said at least one processor, further causes the apparatus to:

provide an indication of the motion vector offset in a bitstream.

In some embodiments of the apparatus said at least one memory stored with code thereon, which when executed by said at least one processor, further causes the apparatus to:

provide the indication indicative of the vertical sampling grid position of the current view component relative to the vertical sampling grid position of the reference view.

In some embodiments of the apparatus said at least one memory stored with code thereon, which when executed by said at least one processor, further causes the apparatus to:

provide the indication indicative of the vertical sampling grid position in a picture parameter set, or in a sequence parameter set.

In some embodiments of the apparatus said at least one memory stored with code thereon, which when executed by said at least one processor, further causes the apparatus to:

conclude that the vertical sampling grid position of the reference view component differs from the vertical sampling grid position of the current view component;

wherein said at least one memory stored with code thereon, which when executed by said at least one processor, further causes the apparatus to select an initial context for adaptive entropy coding of motion vector difference in such a manner that the initial context matches the difference in vertical sampling grid position.

In some embodiments of the apparatus said at least one memory stored with code thereon, which when executed by said at least one processor, further causes the apparatus to:

omit the vertical motion vector difference coding in inter-view prediction and/or view synthesis prediction and/or inter-component motion prediction; and

derive a vertical motion vector component to be equal to a vertical offset derived from the difference of the vertical sampling grid position between the current view component and the reference view component.

In some embodiments of the apparatus said at least one memory stored with code thereon, which when executed by said at least one processor, further causes the apparatus to:

use the vertical motion offset when accessing a residual of a predicted view component or a residual block for a predicted block.

In some embodiments of the apparatus said at least one memory stored with code thereon, which when executed by said at least one processor, further causes the apparatus to:

use the vertical motion offset, when the vertical motion offset has a non-integer value in full sample units, to interpolate a residual prior to using the residual for prediction of the residual information of the current view component or a block being encoded.

In some embodiments of the apparatus said at least one memory stored with code thereon, which when executed by said at least one processor, further causes the apparatus to:

resample both the reference view component and the current view component to obtain a common resolution for both the reference view component and the current view component.

In some embodiments the apparatus comprises a communication device comprising:

a user interface circuitry and user interface software configured to facilitate a user to control at least one function of the communication device through use of a display and further configured to respond to user inputs; and

a display circuitry configured to display at least a portion of a user interface of the communication device, the display and display circuitry configured to facilitate the user to control at least one function of the communication device.

In some embodiments of the apparatus the communication device comprises a mobile phone.

According to a fifth example there is provided a computer program product including one or more sequences of one or more instructions which, when executed by one or more processors, cause an apparatus to at least perform the following:

obtain information on a sampling grid of a current view component;

obtain information on a sampling grid of a reference view component;

use the obtained information to select one or more resampling filter parameters for filtering at least a part of the reference view component to be used in one or more of inter-view prediction and view synthesis prediction of the current view component.

In some embodiments the computer program product further comprises one or more sequences of one or more instructions which, when executed by one or more processors, cause the apparatus to:

obtain information on a vertical sampling grid position of the reference view component;

obtain information on a vertical sampling grid position of the current view component;

use the obtained information to select one or more resampling filter parameters for filtering the reference view component to be used in one or more of inter-view prediction and view synthesis prediction of the current view component.

In some embodiments the computer program product further comprises one or more sequences of one or more instructions which, when executed by one or more processors, cause the apparatus to:

provide an indication of the vertical sampling grid position of the reference view component in a bitstream.

In some embodiments the computer program product further comprises one or more sequences of one or more instructions which, when executed by one or more processors, cause the apparatus to:

provide an indication of the vertical sampling grid position of the current view component in a bitstream.

According to a sixth example there is provided a computer program product including one or more sequences of one or more instructions which, when executed by one or more processors, cause an apparatus to at least perform the following:

obtain information on a vertical sampling grid position of a reference view component;

obtain information on a vertical sampling grid position of the current view component;

determine the difference between the vertical sampling grid position of the reference view component and the vertical sampling grid position of the current view component;

use the difference to compensate a motion vector offset to be used in one or more of inter-view prediction and view synthesis prediction of the current view component.

In some embodiments the computer program product further comprises one or more sequences of one or more instructions which, when executed by one or more processors, cause the apparatus to:

provide an indication of the motion vector offset in a bitstream.

In some embodiments the computer program product further comprises one or more sequences of one or more instructions which, when executed by one or more processors, cause the apparatus to:

provide the indication indicative of the vertical sampling grid position of the current view component relative to the vertical sampling grid position of the reference view.

In some embodiments the computer program product further comprises one or more sequences of one or more instructions which, when executed by one or more processors, cause the apparatus to:

provide the indication indicative of the vertical sampling grid position in a picture parameter set, or in a sequence parameter set.

In some embodiments the computer program product further comprises one or more sequences of one or more instructions which, when executed by one or more processors, cause the apparatus to:

conclude that the vertical sampling grid position of the reference view component differs from the vertical sampling grid position of the current view component;

wherein said one or more sequences of one or more instructions which, when executed by one or more processors, further causes the apparatus to select an initial context for adaptive entropy coding of motion vector difference in such a manner that the initial context matches the difference in vertical sampling grid position.

In some embodiments the computer program product further comprises one or more sequences of one or more instructions which, when executed by one or more processors, cause the apparatus to:

omit the vertical motion vector difference coding in inter-view prediction and/or view synthesis prediction and/or inter-component motion prediction; and

derive a vertical motion vector component to be equal to a vertical offset derived from the difference of the vertical sampling grid position between the current view component and the reference view component.

In some embodiments the computer program product further comprises one or more sequences of one or more instructions which, when executed by one or more processors, cause the apparatus to:

use the vertical motion offset when accessing a residual of a predicted view component or a residual block for a predicted block.

In some embodiments the computer program product further comprises one or more sequences of one or more instructions which, when executed by one or more processors, cause the apparatus to:

use the vertical motion offset, when the vertical motion offset has a non-integer value in full sample units, to interpolate a residual prior to using the residual for prediction of the residual information of the current view component or a block being encoded.

In some embodiments the computer program product further comprises one or more sequences of one or more instructions which, when executed by one or more processors, cause the apparatus to:

resample both the reference view component and the current view component to obtain a common resolution for both the reference view component and the current view component.

In some embodiments the computer program is comprised in a computer readable memory.

In some embodiments the computer readable memory comprises a non-transient computer readable storage medium.

According to a seventh example there is provided an apparatus comprising:

means for obtaining information on a sampling grid of a current view component;

means for obtaining information on a sampling grid of a reference view component;

means for using the obtained information to select one or more resampling filter parameters for filtering at least a part of the reference view component to be used in one or more of inter-view prediction and view synthesis prediction of the current view component.

In some embodiments the apparatus comprises:

means for obtaining information on a vertical sampling grid position of the reference view component;

means for obtaining information on a vertical sampling grid position of the current view component;

means for using the obtained information to select one or more resampling filter parameters for filtering the reference view component to be used in one or more of inter-view prediction and view synthesis prediction of the current view component.

In some embodiments the apparatus comprises:

means for providing an indication of the vertical sampling grid position of the reference view component in a bitstream.

In some embodiments the apparatus comprises:

means for providing an indication of the vertical sampling grid position of the current view component in a bitstream.

According to an eighth example there is provided an apparatus comprising:

means for obtaining information on a vertical sampling grid position of a reference view component;

means for obtaining information on a vertical sampling grid position of the current view component;

means for determining the difference between the vertical sampling grid position of the reference view component and the vertical sampling grid position of the current view component;

means for using the difference to compensate a motion vector offset to be used in one or more of inter-view prediction and view synthesis prediction of the current view component.

In some embodiments the apparatus comprises:

means for providing an indication of the motion vector offset in a bitstream.

In some embodiments the apparatus comprises:

means for providing the indication indicative of the vertical sampling grid position of the current view component relative to the vertical sampling grid position of the reference view.

In some embodiments the apparatus comprises:

means for providing the indication indicative of the vertical sampling grid position in a picture parameter set, or in a sequence parameter set.

In some embodiments the apparatus comprises:

means for concluding that the vertical sampling grid position of the reference view component differs from the vertical sampling grid position of the current view component;

wherein the apparatus further comprises means for selecting an initial context for adaptive entropy coding of motion vector difference in such a manner that the initial context matches the difference in vertical sampling grid position.

In some embodiments the apparatus comprises:

means for omitting the vertical motion vector difference coding in inter-view prediction and/or view synthesis prediction and/or inter-component motion prediction; and

means for deriving a vertical motion vector component to be equal to a vertical offset derived from the difference of the vertical sampling grid position between the current view component and the reference view component.

In some embodiments the apparatus comprises:

means for using the vertical motion offset when accessing a residual of a predicted view component or a residual block for a predicted block.

In some embodiments the apparatus comprises:

means for using the vertical motion offset, when the vertical motion offset has a non-integer value in full sample units, to interpolate a residual prior to using the residual for prediction of the residual information of the current view component or a block being encoded.

In some embodiments the apparatus comprises:

means for resampling both the reference view component and the current view component to obtain a common resolution for both the reference view component and the current view component.

According to a ninth example there is provided a method comprising:

obtaining information on a sampling grid of a current view component;

obtaining information on a sampling grid of a reference view component;

using the obtained information to select one or more resampling filter parameters for filtering at least a part of the reference view component to be used in one or more of inter-view prediction and view synthesis prediction of the current view component.

In some embodiments the method comprises:

obtaining information on a vertical sampling grid position of the reference view component;

obtaining information on a vertical sampling grid position of the current view component;

using the obtained information to select one or more resampling filter parameters for filtering the reference view component to be used in one or more of inter-view prediction and view synthesis prediction of the current view component.

In some embodiments the method comprises:

obtaining an indication of the vertical sampling grid position of the reference view component from a bitstream.

In some embodiments the method comprises:

obtaining an indication of the vertical sampling grid position of the current view component from a bitstream.

According to a tenth example there is provided a method comprising:

obtaining information on a difference between the vertical sampling grid position of a reference view component and the vertical sampling grid position of the current view component; and

using the difference to compensate a motion vector offset to be used in one or more of inter-view prediction and view synthesis prediction of the current view component.

In some embodiments the method comprises:

obtaining an indication of the motion vector offset from a bitstream.

In some embodiments the method comprises:

obtaining the indication indicative of the vertical sampling grid position of the current view component relative to the vertical sampling grid position of the reference view.

In some embodiments the method comprises:

obtaining the indication indicative of the vertical sampling grid position from a picture parameter set, or from a sequence parameter set.

In some embodiments the method comprises:

concluding that the vertical sampling grid position of the reference view component differs from the vertical sampling grid position of the current view component;

wherein the method further comprises selecting an initial context for adaptive entropy decoding of motion vector difference in such a manner that the initial context matches the difference in vertical sampling grid position.

In some embodiments the method comprises:

omitting the vertical motion vector difference decoding in inter-view prediction and/or view synthesis prediction and/or inter-component motion prediction; and

deriving a vertical motion vector component to be equal to a vertical offset derived from the difference of the vertical sampling grid position between the current view component and the reference view component.

In some embodiments the method comprises:

using the vertical motion offset when accessing a residual of a predicted view component or a residual block for a predicted block.

In some embodiments the method comprises:

using the vertical motion offset, when the vertical motion offset has a non-integer value in full sample units, to interpolate a residual prior to using the residual for prediction of the residual information of the current view component or a block being decoded.

In some embodiments the method comprises:

resampling both the reference view component and the current view component to obtain a common resolution for both the reference view component and the current view component.

According to an eleventh example there is provided an apparatus comprising at least one processor and at least one memory including computer program code, the at least one memory and the computer program code configured to, with the at least one processor, cause the apparatus to:

obtain information on a sampling grid of a current view component;

obtain information on a sampling grid of a reference view component;

use the obtained information to select one or more resampling filter parameters for filtering at least a part of the reference view component to be used in one or more of inter-view prediction and view synthesis prediction of the current view component.

In some embodiments of the apparatus said at least one memory stored with code thereon, which when executed by said at least one processor, further causes the apparatus to:

obtain an indication of the vertical sampling grid position of the reference view component from a bitstream.

In some embodiments of the apparatus said at least one memory stored with code thereon, which when executed by said at least one processor, further causes the apparatus to:

obtain an indication of the vertical sampling grid position of the current view component from a bitstream.

According to a twelfth example there is provided an apparatus comprising at least one processor and at least one memory including computer program code, the at least one memory and the computer program code configured to, with the at least one processor, cause the apparatus to:

obtain information on a difference between the vertical sampling grid position of a reference view component and the vertical sampling grid position of the current view component;

use the difference to compensate a motion vector offset to be used in one or more of inter-view prediction and view synthesis prediction of the current view component.

In some embodiments of the apparatus said at least one memory stored with code thereon, which when executed by said at least one processor, further causes the apparatus to:

obtain an indication of the motion vector offset from a bitstream.

In some embodiments of the apparatus said at least one memory stored with code thereon, which when executed by said at least one processor, further causes the apparatus to:

obtain the indication indicative of the vertical sampling grid position of the current view component relative to the vertical sampling grid position of the reference view.

In some embodiments of the apparatus said at least one memory stored with code thereon, which when executed by said at least one processor, further causes the apparatus to:

obtain the indication indicative of the vertical sampling grid position from a picture parameter set, or from a sequence parameter set.

In some embodiments of the apparatus said at least one memory stored with code thereon, which when executed by said at least one processor, further causes the apparatus to:

conclude that the vertical sampling grid position of the reference view component differs from the vertical sampling grid position of the current view component;

wherein of the apparatus said at least one memory stored with code thereon, which when executed by said at least one processor, further causes the apparatus to select an initial context for adaptive entropy decoding of motion vector difference in such a manner that the initial context matches the difference in vertical sampling grid position.

In some embodiments of the apparatus said at least one memory stored with code thereon, which when executed by said at least one processor, further causes the apparatus to:

omit the vertical motion vector difference decoding in inter-view prediction and/or view synthesis prediction and/or inter-component motion prediction; and

derive a vertical motion vector component to be equal to a vertical offset derived from the difference of the vertical sampling grid position between the current view component and the reference view component.

In some embodiments of the apparatus said at least one memory stored with code thereon, which when executed by said at least one processor, further causes the apparatus to:

use the vertical motion offset when accessing a residual of a predicted view component or a residual block for a predicted block.

In some embodiments of the apparatus said at least one memory stored with code thereon, which when executed by said at least one processor, further causes the apparatus to:

use the vertical motion offset, when the vertical motion offset has a non-integer value in full sample units, to interpolate a residual prior to using the residual for prediction of the residual information of the current view component or a block being decoded.

In some embodiments of the apparatus said at least one memory stored with code thereon, which when executed by said at least one processor, further causes the apparatus to:

resample both the reference view component and the current view component to obtain a common resolution for both the reference view component and the current view component.

In some embodiments the apparatus comprises a communication device comprising:

a user interface circuitry and user interface software configured to facilitate a user to control at least one function of the communication device through use of a display and further configured to respond to user inputs; and

a display circuitry configured to display at least a portion of a user interface of the communication device, the display and display circuitry configured to facilitate the user to control at least one function of the communication device.

In some embodiments of the apparatus the communication device comprises a mobile phone.

According to a thirteenth example there is provided a computer program product including one or more sequences of one or more instructions which, when executed by one or more processors, cause an apparatus to at least perform the following:

obtain information on a sampling grid of a current view component;

obtain information on a sampling grid of a reference view component;

use the obtained information to select one or more resampling filter parameters for filtering at least a part of the reference view component to be used in one or more of inter-view prediction and view synthesis prediction of the current view component.

In some embodiments the computer program product further comprises one or more sequences of one or more instructions which, when executed by one or more processors, cause the apparatus to:

obtain an indication of the vertical sampling grid position of the reference view component from a bitstream.

In some embodiments the computer program product further comprises one or more sequences of one or more instructions which, when executed by one or more processors, cause the apparatus to:

obtain an indication of the vertical sampling grid position of the current view component from a bitstream.

According to a fourteenth example there is provided a computer program product including one or more sequences of one or more instructions which, when executed by one or more processors, cause an apparatus to at least perform the following:

obtain information on a difference between the vertical sampling grid position of a reference view component and the vertical sampling grid position of the current view component;

use the difference to compensate a motion vector offset to be used in one or more of inter-view prediction and view synthesis prediction of the current view component.

In some embodiments the computer program product further comprises one or more sequences of one or more instructions which, when executed by one or more processors, cause the apparatus to:

obtain an indication of the motion vector offset from a bitstream.

In some embodiments the computer program product further comprises one or more sequences of one or more instructions which, when executed by one or more processors, cause the apparatus to:

obtain the indication indicative of the vertical sampling grid position of the current view component relative to the vertical sampling grid position of the reference view.

In some embodiments the computer program product further comprises one or more sequences of one or more instructions which, when executed by one or more processors, cause the apparatus to:

obtain the indication indicative of the vertical sampling grid position from a picture parameter set, or from a sequence parameter set.

In some embodiments the computer program product further comprises one or more sequences of one or more instructions which, when executed by one or more processors, cause the apparatus to:

conclude that the vertical sampling grid position of the reference view component differs from the vertical sampling grid position of the current view component;

wherein one or more sequences of one or more instructions which, when executed by one or more processors, further causes the apparatus to select an initial context for adaptive entropy decoding of motion vector difference in such a manner that the initial context matches the difference in vertical sampling grid position.

In some embodiments the computer program product further comprises one or more sequences of one or more instructions which, when executed by one or more processors, cause the apparatus to:

omit the vertical motion vector difference decoding in inter-view prediction and/or view synthesis prediction and/or inter-component motion prediction; and

derive a vertical motion vector component to be equal to a vertical offset derived from the difference of the vertical sampling grid position between the current view component and the reference view component.

In some embodiments the computer program product further comprises one or more sequences of one or more instructions which, when executed by one or more processors, cause the apparatus to:

use the vertical motion offset when accessing a residual of a predicted view component or a residual block for a predicted block.

In some embodiments the computer program product further comprises one or more sequences of one or more instructions which, when executed by one or more processors, cause the apparatus to:

use the vertical motion offset, when the vertical motion offset has a non-integer value in full sample units, to interpolate a residual prior to using the residual for prediction of the residual information of the current view component or a block being decoded.

In some embodiments the computer program product further comprises one or more sequences of one or more instructions which, when executed by one or more processors, cause the apparatus to:

resample both the reference view component and the current view component to obtain a common resolution for both the reference view component and the current view component.

In some embodiments the computer program is comprised in a computer readable memory.

In some embodiments the computer readable memory comprises a non-transient computer readable storage medium.

According to a fifteenth example there is provided an apparatus comprising:

means for obtaining information on a sampling grid of a current view component;

means for obtaining information on a sampling grid of a reference view component;

means for using the obtained information to select one or more resampling filter parameters for filtering at least a part of the reference view component to be used in one or more of inter-view prediction and view synthesis prediction of the current view component.

In some embodiments the apparatus comprises:

means for obtaining an indication of the vertical sampling grid position of the reference view component from a bitstream.

In some embodiments the apparatus comprises:

means for obtaining an indication of the vertical sampling grid position of the current view component from a bitstream.

According to a sixteenth example there is provided an apparatus comprising:

means for obtaining information on a difference between the vertical sampling grid position of a reference view component and the vertical sampling grid position of the current view component;

means for using the difference to compensate a motion vector offset to be used in one or more of inter-view prediction and view synthesis prediction of the current view component.

In some embodiments the apparatus comprises:

means for obtaining an indication of the motion vector offset from a bitstream.

In some embodiments the apparatus comprises:

means for obtaining the indication indicative of the vertical sampling grid position of the current view component relative to the vertical sampling grid position of the reference view.

In some embodiments the apparatus comprises:

means for obtaining the indication indicative of the vertical sampling grid position from a picture parameter set, or from a sequence parameter set.

In some embodiments the apparatus comprises:

means for concluding that the vertical sampling grid position of the reference view component differs from the vertical sampling grid position of the current view component;

wherein the apparatus further comprises means for selecting an initial context for adaptive entropy decoding of motion vector difference in such a manner that the initial context matches the difference in vertical sampling grid position.

In some embodiments the apparatus comprises:

means for omitting the vertical motion vector difference decoding in inter-view prediction and/or view synthesis prediction and/or inter-component motion prediction; and

means for deriving a vertical motion vector component to be equal to a vertical offset derived from the difference of the vertical sampling grid position between the current view component and the reference view component.

In some embodiments the apparatus comprises:

means for using the vertical motion offset when accessing a residual of a predicted view component or a residual block for a predicted block.

In some embodiments the apparatus comprises:

means for using the vertical motion offset, when the vertical motion offset has a non-integer value in full sample units, to interpolate a residual prior to using the residual for prediction of the residual information of the current view component or a block being decoded.

In some embodiments the apparatus comprises:

means for resampling both the reference view component and the current view component to obtain a common resolution for both the reference view component and the current view component.

We claim:

1. A method comprising:
obtaining information on a sampling grid of a current view component;
obtaining information on a sampling grid of a reference view component; and
performing one or more of the following:
using the obtained information to select one or more resampling filter parameters for filtering at least a part of the reference view component to be used in one or more of inter-view prediction and view synthesis prediction of the current view component.

2. The method according to claim 1 further comprising:
obtaining information on a vertical sampling grid position of the reference view component;
obtaining information on a vertical sampling grid position of the current view component;
using the obtained information to select one or more resampling filter parameters for filtering the reference view component to be used in one or more of inter-view prediction and view synthesis prediction of the current view component.

3. The method according to claim 2 further comprising:
providing an indication of the vertical sampling grid position of one or more of the reference view component and the current view component in a bitstream.

4. A method comprising:
obtaining information on a vertical sampling grid position of a reference view component;
obtaining information on a vertical sampling grid position of the current view component;
determining the difference between the vertical sampling grid position of the reference view component and the vertical sampling grid position of the current view component;
using the difference to compensate a motion vector offset to be used in one or more of inter-view prediction and view synthesis prediction of the current view component.

5. The method according to claim 4 further comprising one or more of the following:
providing an indication of the motion vector offset in a bitstream;
providing an indication indicative of the vertical sampling grid position of the current view component relative to the vertical sampling grid position of the reference view.

6. The method according to claim 4 further comprising:
concluding that the vertical sampling grid position of the reference view component differs from the vertical sampling grid position of the current view component;
wherein the method further comprises selecting an initial context for adaptive entropy coding of motion vector difference in such a manner that the initial context matches the difference in vertical sampling grid position.

7. The method according to claim 4 further comprising:
omitting the vertical motion vector difference coding in inter-view prediction and/or view synthesis prediction and/or inter-component motion prediction; and
deriving a vertical motion vector component to be equal to a vertical offset derived from the difference of the vertical sampling grid position between the current view component and the reference view component.

8. The method according to claim 7 further comprising:
using the vertical motion offset when accessing a residual of a predicted view component or a residual block for a predicted block.

9. The method according to claim 7 further comprising:
using the vertical motion offset, when the vertical motion offset has a non-integer value in full sample units, to interpolate a residual prior to using the residual for prediction of the residual information of the current view component or a block being encoded.

10. An apparatus comprising at least one processor and at least one memory including computer program code, the at least one memory and the computer program code configured to, with the at least one processor, cause the apparatus to:
obtain information on a sampling grid of a current view component;
obtain information on a sampling grid of a reference view component;
use the obtained information to select one or more resampling filter parameters for filtering at least a part of the reference view component to be used in one or more of inter-view prediction and view synthesis prediction of the current view component.

11. The apparatus according to claim 10, said at least one memory stored with code thereon, which when executed by said at least one processor, further causes the apparatus to:
obtain information on a vertical sampling grid position of the reference view component;
obtain information on a vertical sampling grid position of the current view component;
use the obtained information to select one or more resampling filter parameters for filtering the reference view component to be used in one or more of inter-view prediction and view synthesis prediction of the current view component.

12. The apparatus according to claim 11, said at least one memory stored with code thereon, which when executed by said at least one processor, further causes the apparatus to:
provide an indication of the vertical sampling grid position of one or more of the reference view component and the current view component in a bitstream.

13. An apparatus comprising at least one processor and at least one memory including computer program code, the at least one memory and the computer program code configured to, with the at least one processor, cause the apparatus to:
obtain information on a vertical sampling grid position of a reference view component;
obtain information on a vertical sampling grid position of the current view component;
determine the difference between the vertical sampling grid position of the reference view component and the vertical sampling grid position of the current view component;
use the difference to compensate a motion vector offset to be used in one or more of inter-view prediction and view synthesis prediction of the current view component.

14. The apparatus according to claim 13, said at least one memory stored with code thereon, which when executed by said at least one processor, further causes the apparatus to perform one or more of the following:
provide an indication of the motion vector offset in a bitstream.
provide the indication indicative of the vertical sampling grid position of the current view component relative to the vertical sampling grid position of the reference view.

15. The apparatus according to claim 13, said at least one memory stored with code thereon, which when executed by said at least one processor, further causes the apparatus to:
conclude that the vertical sampling grid position of the reference view component differs from the vertical sampling grid position of the current view component;
wherein said at least one memory stored with code thereon, which when executed by said at least one processor, further causes the apparatus to select an initial context for adaptive entropy coding of motion vector difference in such a manner that the initial context matches the difference in vertical sampling grid position.

16. The apparatus according to claim 13, said at least one memory stored with code thereon, which when executed by said at least one processor, further causes the apparatus to:
omit the vertical motion vector difference coding in inter-view prediction and/or view synthesis prediction and/or inter-component motion prediction; and
derive a vertical motion vector component to be equal to a vertical offset derived from the difference of the vertical sampling grid position between the current view component and the reference view component.

17. The apparatus according to claim 16, said at least one memory stored with code thereon, which when executed by said at least one processor, further causes the apparatus to:
use the vertical motion offset when accessing a residual of a predicted view component or a residual block for a predicted block.

18. The apparatus according to claim 16, said at least one memory stored with code thereon, which when executed by said at least one processor, further causes the apparatus to:
use the vertical motion offset, when the vertical motion offset has a non-integer value in full sample units, to interpolate a residual prior to using the residual for prediction of the residual information of the current view component or a block being encoded.

19. The apparatus according to claim 13 comprising a communication device comprising:
a user interface circuitry and user interface software configured to facilitate a user to control at least one function of the communication device through use of a display and further configured to respond to user inputs; and
a display circuitry configured to display at least a portion of a user interface of the communication device, the display and display circuitry configured to facilitate the user to control at least one function of the communication device.

20. The apparatus according to claim 19, said communication device comprising a mobile phone.

21. A computer program product including one or more sequences of one or more instructions which, when executed by one or more processors, cause an apparatus to at least perform the method of claim 1.

22. A computer program product including one or more sequences of one or more instructions which, when executed by one or more processors, cause an apparatus to at least perform the method of claim 4.

23. An apparatus comprising:
means for obtaining information on a sampling grid of a current view component;
means for obtaining information on a sampling grid of a reference view component;
means for using the obtained information to select one or more resampling filter parameters for filtering at least a part of the reference view component to be used in one or more of inter-view prediction and view synthesis prediction of the current view component.

24. An apparatus comprising:
means for obtaining information on a vertical sampling grid position of a reference view component;
means for obtaining information on a vertical sampling grid position of the current view component;
means for determining the difference between the vertical sampling grid position of the reference view component and the vertical sampling grid position of the current view component;
means for using the difference to compensate a motion vector offset to be used in one or more of inter-view prediction and view synthesis prediction of the current view component.
